(19) United States
(12) Patent Application Publication
(10) Pub. No.: US 2026/0313296 A1
(43) Pub. Date: Oct. 8, 2026

(54) DEVICES, SYSTEMS AND METHODS RELATING TO AUDIO TRANSDUCERS AND AUDIO DEVICES

(71) Applicant: Wing Acoustics Limited, Auckland (NZ)

(72) Inventors: Alec Finlay Handyside, Auckland (NZ); David John Palmer, Auckland (NZ); Maximilian Emanuel Sutherland Wilson, Auckland (NZ); Michael Ian Palmer, Auckland (NZ); Paul Tupolo, Auckland (NZ)

(21) Appl. No.: 19/482,033

(22) PCT Filed: May 10, 2024
(86) PCT No.: PCT/IB2024/054567

§ 371 Date: Nov. 6, 2025

(30) Foreign Application Priority Data
May 10, 2023 (NZ) 799796
Sep. 13, 2023 (NZ) 803665

(51) Int. Cl. H04R 7/16; H04R 7/06; H04R 9/06

(52) U.S. Cl. CPC H04R 7/16; H04R 7/06; H04R 9/06

(57) ABSTRACT

An audio transducer comprises a diaphragm, a transducer base structure and a diaphragm suspension system. The diaphragm suspension system has at least one contact hinge joint coupling the diaphragm to the transducer base structure to enable rotational motion of the diaphragm relative to the transducer base structure about an axis of rotation. A transducing mechanism operatively couples the diaphragm to transduce between electrical audio signals and sound pressure. In an embodiment, each contact hinge joint comprises up to four contact interfaces, with each contact interface having a pair of contacting surfaces moveable relative to one another. Other embodiments of diaphragm suspension systems, diaphragm structures, transducing mechanisms and audio devices incorporating the same are disclosed.

### FIELD OF THE INVENTION

The present invention relates to audio transducers, such as those used in loudspeakers, microphones and the like, and associated systems, devices or methods of manufacture.

### BACKGROUND TO THE INVENTION

Audio transducers are devices that convert electrical signals into sound waves, or vice versa. They are a core component of any audio system, including speakers, headphones, and microphones. The quality of sound produced by an audio system is largely dependent on the performance of its audio transducers.

One type of audio transducer is the rotational-action driver, which comprises a diaphragm configured to rotatably oscillate to generate or transduce sound waves. The diaphragm is typically coupled to a base structure of the transducer via a diaphragm suspension system. This system allows the diaphragm to rotate relative to a base structure of the driver, while also providing resistance to motion in other directions. The transducing mechanism can be of various types, including for instance an electromagnetic mechanism, which includes a conductive coil and a magnet. Various rotational action audio transducers are disclosed in PCT patent publication WO2017/046716A1, for instance.

In an audio system, one or more audio transducer may be mounted within a baffle or enclosure, and the baffle or enclosure may be designed to optimise directionality and frequency response of the audio output.

The design and construction of the diaphragm, the transducing mechanism, the diaphragm suspension system and the enclosure all play a role in the performance of the audio transducer or audio system. These components can be optimised to achieve a balance between audio quality, efficiency, and manufacturability. Many audio systems strive to strike a balance between the above aspects, but there is a continuing need for improvement in relation to one or more of these aspects, without significantly affecting others.

It is an object of the present invention to provide alternative audio transducers, systems or related devices that work in some way towards addressing some of the shortcomings of existing technologies, or to at least provide the public with a useful choice.

### SUMMARY OF THE INVENTION

In an aspect, the invention may broadly be said to consist of an audio transducer comprising: a transducer base structure; a diaphragm; a diaphragm suspension system coupling the diaphragm to the transducer base structure to enable rotational motion of the diaphragm about an axis of rotation; and a transducing mechanism operatively coupled to the diaphragm to transduce between electrical audio signals and sound pressure.

In another aspect, the invention may broadly be said to consist of an audio transducer comprising: a diaphragm; a transducer base structure; a diaphragm suspension system movably coupling the diaphragm to the transducer base structure; and a transducing mechanism operatively coupled to the diaphragm and the transducer base structure, configured to transduce between electrical audio signals and sound pressure, wherein the transducing mechanism comprises a magnetic-flux-generating body rigidly fixed to the diaphragm, wherein the magnetic-flux-generating body comprises a permanent magnet with a direction of magnetization that is substantially perpendicular to a major face of the diaphragm.

In another aspect, the invention may broadly be said to consist of an audio transducer comprising: a diaphragm; a transducer base structure; a diaphragm suspension system coupling the diaphragm to the transducer base structure to enable rotational motion of the diaphragm about an axis of rotation; and a transducing mechanism operatively coupled to the diaphragm and the transducer base structure, configured to transduce between electrical audio signals and sound pressure, wherein the transducing mechanism comprises a magnetic-flux-generating body rigidly fixed to the diaphragm, wherein the magnetic-flux-generating body comprises a permanent magnet with a direction of magnetization that is substantially perpendicular to an imaginary plane containing a radial axis of the diaphragm and the axis of rotation.

In another aspect, the invention may broadly be said to consist of an audio transducer comprising: a transducer base structure; a diaphragm; a diaphragm suspension system coupling the diaphragm to the transducer base structure to enable rotational motion of the diaphragm about an axis of rotation; and a transducing mechanism operatively coupled to the diaphragm to transduce between electrical audio signals and sound pressure, wherein the transducing mechanism comprises a coil winding and a magnetic body, the magnetic body being rigidly fixed to the diaphragm and having a north pole and a south pole, and wherein the coil winding includes a first primary length extending adjacent to the north pole of the magnetic body and being substantially aligned with the magnetic body along a direct south to north axis of a magnetic field generated by the magnetic body.

In another aspect, the invention may broadly be said to consist of an audio transducer comprising: a diaphragm; a transducer base structure; a diaphragm suspension system coupling the diaphragm to the transducer base structure to enable rotational motion of the diaphragm about an axis of rotation; and a transducing mechanism configured to transduce between electrical audio signals and motion of the diaphragm, wherein the transducing mechanism includes a magnetic body rigidly coupled to or integral with the diaphragm and a coil winding rigidly coupled to or integral with the transducer base structure, the magnetic body being magnetized in a direction substantially perpendicular to a major face of the diaphragm, and wherein the transducer base structure comprises a first ferromagnetic body coupled proximal to the first primary length of the coil winding and a second ferromagnetic body coupled proximal to the second primary length of the coil winding.

In another aspect, the invention may broadly be said to consist of an audio transducer comprising: a diaphragm; a transducer base structure; a diaphragm suspension system coupling the diaphragm to the transducer base structure to enable rotational motion of the diaphragm about an axis of rotation; and a transducing mechanism configured to transduce between electrical audio signals and motion of the diaphragm, wherein the transducing mechanism includes a magnetic body rigidly coupled to or integral with the diaphragm and a coil winding rigidly coupled to or integral with the transducer base structure, wherein the magnetic body comprises a first convexly curved surface adjacent to and opposing the first primary length of the coil winding and a second convexly curved surface adjacent to and opposing the second primary length of the coil winding, and wherein the first convexly curved surface or the second convexly curved surface, or both, has or have a substantially lower radius than a third convexly curved or substantially planar surface on a side of the magnetic body opposing and facing away from the diaphragm. This configuration can lead to reduced rotational inertia as well as concentrating magnetic field proximal to coil windings, potentially leading to improved performance of the transducer.

In another aspect, the invention may broadly be said to consist of an audio transducer comprising: a diaphragm; a transducer base structure; a diaphragm suspension system coupling the diaphragm to the transducer base structure to enable rotational motion of the diaphragm about an axis of rotation; and a transducing mechanism configured to transduce between electrical audio signals and motion of the diaphragm, wherein the transducing mechanism includes a magnetic body rigidly coupled to or integral with the diaphragm and a coil winding rigidly coupled to or integral with the transducer base structure, wherein a centre of mass of the magnetic body is offset away from a radial line extending from the axis of rotation through the diaphragm. This offset can contribute to improved diaphragm balance, reducing excitation of one or more unwanted resonance modes associated with a suspension system.

In another aspect, the invention may broadly be said to consist of an audio transducer comprising: a diaphragm; a transducer base structure; a diaphragm suspension system coupling the diaphragm to the transducer base structure to enable rotational motion of the diaphragm about an axis of rotation; and a transducing mechanism operatively coupled to the diaphragm to transduce between electrical audio signals and sound pressure; wherein the diaphragm suspension system includes flexible hinge joints configured to enable the rotational motion of the diaphragm about the axis of rotation, and a restoring or biasing mechanism acting on the flexible hinge joints and configured to restore or bias the diaphragm toward a neutral rotational position. A separate restoring or biasing mechanism may be more effective in terms of maintaining correct rotational positioning of the diaphragm despite unwanted or intrinsic forces generated by the transducing mechanism and acting on the diaphragm, facilitating flexible hinge joints that may be more high-performing and/or simpler to produce. Additionally, the inclusion of a restoring or biasing mechanism enhances the durability of the transducer by mitigating stress on the flexible hinge elements, thereby extending the device's operational lifespan.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm about an axis of rotation; and a transducing mechanism operatively coupled to the diaphragm to transduce between electrical audio signals and sound pressure, wherein each contact hinge joint comprises a first contact interface having a first pair of contacting surfaces moveable relative to one another and a second contact interface having a second pair of contacting surfaces moveable relative to one another, and wherein an axis of a first net reaction force applied to the diaphragm at the first contact interface is angled relative to an axis of a second net reaction force applied to the diaphragm at the second contact interface. The angled configuration of the contact interfaces may provide enhanced stability and precision in the diaphragm's movement, potentially improving the audio transducer's sound quality and reducing distortion.

In another aspect, the invention may broadly be said to consist an audio transducer comprising: a diaphragm; a transducer base structure; a diaphragm suspension system comprising at least one contact hinge joint coupling the diaphragm to the transducer base structure to enable rotational motion of the diaphragm about an axis of rotation; and a transducing mechanism operatively coupled to the diaphragm to transduce between electrical audio signals and sound pressure, and comprising ferromagnetic and/or magnetic bodies; each contact hinge joint having a first contact interface comprising a first pair of contacting surfaces moveable relative to one another and a second contact interface comprising a second pair of contacting surfaces moveable relative to one another; and the audio transducer further comprising a biasing mechanism comprising the ferromagnetic and/or magnetic bodies of the transducing mechanism and configured to bias each pair of contacting surfaces toward one another as a result of intrinsic forces generated on the diaphragm due to magnetic interaction between the ferromagnetic and/or magnetic bodies of the transducing mechanism, the intrinsic forces comprising forces other than operational forces of the transducing mechanism corresponding to electrical audio signals being transduced, during operation.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm about an axis of rotation; and a transducing mechanism operatively coupled to the diaphragm to transduce between electrical audio signals and sound pressure, wherein each contact hinge joint comprises at least one contact interface having a pair of contacting surfaces moveable relative to one another, and the diaphragm suspension system further comprising at least one compliant connection between the diaphragm and the transducer base structure that facilitates translation of the diaphragm along the axis of rotation during operation. The compliant connection reduces a possibility of different suspension system elements acting in subtly opposed directions, facilitating reduced distortion and/or reduced manufacturing tolerances.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm about an axis of rotation; and a transducing mechanism operatively coupled to the diaphragm to transduce between electrical audio signals and sound pressure, wherein each contact hinge joint comprises at least one contact interface having a pair of contacting surfaces moveable relative to one another, and the diaphragm suspension system comprising at least one compliant connection between the diaphragm and at least one corresponding contact element of each hinge joint that facilitates independent translation of the contacting surfaces of each contact interface along the axis of rotation.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm about an axis of rotation; and a transducing mechanism operatively coupled to the diaphragm to transduce between electrical audio signals and sound pressure, wherein each hinge joint comprises multiple contact interfaces, each having a pair of contacting surfaces moveable relative to one another, the hinge joint further comprising at least one contact element locating between corresponding inner and outer contact surfaces of the hinge joint, and wherein each contact element contacts each of the corresponding inner and outer contact surfaces at a single location. The single-point contact between the elements and races is a simple design that effectively reduces a possibility of different suspension system elements acting in subtly opposed directions.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm about an axis of rotation; and a transducing mechanism operatively coupled to the diaphragm to transduce between electrical audio signals and sound pressure, wherein each hinge joint comprises multiple contact interfaces, each having a pair of contacting surfaces moveable relative to one another, the hinge joint further comprising at least one contact element locating between corresponding inner and outer contact surfaces, and wherein each hinge joint further comprises limiters to substantially confine the range of motion of the contact elements to a predefined angular range around the axis of rotation to substantially restrict displacements of the contact element within the hinge joint. The inclusion of limiters is a simple design that maintains suitable support angles to improve hinge stability, thereby delivering consistent performance and durability of the audio transducer.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm about an axis of rotation; and a transducing mechanism operatively coupled to the diaphragm to transduce between electrical audio signals and sound pressure, wherein each contact hinge joint comprises at least one contact interface having a pair of contacting surfaces moveable relative to one another, and wherein the hinge joint exhibits or is closely associated with a degree of translational compliance along one or more axes perpendicular to the axis of rotation for damping vibrations between the diaphragm and transducer base structure at the hinge joint. enabling a degree of translational movement of the diaphragm relative to the transducer base structure. This translational compliance may modify the frequency and/or facilitate damping of one or more unwanted resonance modes, particularly involving suspension compliance. This in turn may improve waterfall plot performance and/or reduce harmonic distortion at certain frequencies and/or may facilitate reduction in manufacturing tolerances, all else being equal.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm about an axis of rotation; and a transducing mechanism operatively coupled to the diaphragm to transduce between electrical audio signals and sound pressure, wherein each contact hinge joint comprises at least one contact interface having a pair of contacting surfaces moveable relative to one another, and wherein each hinge joint comprises substantially rigid rolling or flexing elements to facilitate diaphragm rotation in-use, and also separate connections closely associated with the hinge joint that comparatively increase translational compliance of the hinge joint along one or more axes perpendicular to the axis of rotation.

In another aspect, the invention may broadly be said to consist of an audio transducer comprising: a diaphragm; a transducer base structure; a diaphragm suspension system having at least one hinge joint configured to rotatably mount the diaphragm to the transducer base structure such that the diaphragm rotatably oscillates about an axis of rotation during operation; and a transducing mechanism operatively coupled to the diaphragm to transduce between electrical audio signals and sound pressure, wherein each hinge joint comprises substantially rigid rolling or flexing elements to facilitate diaphragm rotation in-use, and also separate connections closely associated with the hinge joint that comparatively increase translational compliance of the hinge joint along one or more axes perpendicular to the axis of rotation.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm about an axis of rotation; and a transducing mechanism comprising magnetic and/or ferromagnetic bodies operatively coupled to the diaphragm to transduce between electrical audio signals and sound pressure, wherein each contact hinge joint comprises at least one contact interface having a pair of contacting surfaces moveable relative to one another, and wherein the audio transducer further comprises a restoring mechanism for biasing the diaphragm toward a neutral, rotational position.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm about an axis of rotation; and a transducing mechanism operatively coupled to the diaphragm to transduce between electrical audio signals and sound pressure, wherein each contact hinge joint comprises multiple contact interfaces, each having a pair of contacting surfaces moveable relative to one another, wherein each hinge joint comprises at least two substantially elongate contact elements, each contact element having a longitudinal axis extending at a distinct angle relative to the other contact element, and wherein the transducing mechanism exerts intrinsic magnetic forces on the diaphragm along an axis that is distinct from the longitudinal axes of the contact elements' elongate bodies; the transducer further comprising a restoring mechanism configured to provide a restoring force to counteract intrinsic forces generated by the magnetic and/or ferromagnetic components of the transducing mechanism. This is a simple, yet effective diaphragm suspension design based on an innovative hinge concept. The hinge system may provide high stability and reduced part count while the torsion bar may enhance the angular range and reliability of the diaphragm's action.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm about an axis of rotation; and a transducing mechanism operatively coupled to the diaphragm to transduce between electrical audio signals and sound pressure, wherein each contact hinge joint comprises less than three contact interfaces, each having a pair of contacting surfaces moveable relative to one another, This hinge structure facilitates a simplified hinge mechanism that may reduce manufacturing complexity and enhance the reliability of the audio transducer.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm about an axis of rotation; a transducing mechanism operatively coupled to the diaphragm to transduce between electrical audio signals and sound pressure; and a biasing mechanism operatively coupled to each hinge joint to exert a force biasing the hinge joint towards a neutral rotational position, wherein each hinge joint comprises a first contact interface having a pair of rigid contacting surfaces, a second contact interface having a pair of rigid contacting surfaces, the first and second contact interfaces being positioned in close proximity to one another along the axis of rotation, and wherein an axis of a first net reaction force applied to the diaphragm at the first contact interface is angled relative to an axis of a second net reaction force applied to the diaphragm at the second contact interface. The combination of angled support elements with compliant biasing leads to a stable, high-performing and reliable suspension system with reduced manufacturing tolerances.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm about an axis of rotation; and a transducing mechanism operatively coupled to the diaphragm to transduce between electrical audio signals and sound pressure, wherein each hinge joint comprises a first contact interface having a pair of rigid contacting surfaces, a second contact interface having a pair of rigid contacting surfaces, the first and second contact interfaces being positioned in close proximity to one another along the axis of rotation, and wherein an axis of a first net reaction force applied to the diaphragm at the first contact interface is angled relative to an axis of a second net reaction force applied to the diaphragm at the second contact interface, wherein a smallest angle between the first and second net reaction force axes is less than 180 degrees.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm about an axis of rotation; and a transducing mechanism operatively coupled to the diaphragm to transduce between electrical audio signals and sound pressure, wherein each hinge joint comprises at least one contact interface having a pair of rigid contacting surfaces, and wherein each connection that couples a contact interface of each hinge joint to the diaphragm is substantially rigid along an axis of a net reaction force applied to the diaphragm at the first contact interface.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm about an axis of rotation; and a transducing mechanism operatively coupled to the diaphragm to transduce between electrical audio signals and sound pressure, wherein each hinge joint comprises at least one contact interface having a pair of rigid contacting surfaces, and wherein each connection that couples a contact interface of each hinge joint to the transducer base structure is substantially rigid along an axis of a net reaction force applied to the transducer base structure at the first contact interface.

In another aspect, the invention may broadly be said to consist of an audio transducer comprising: a diaphragm rotatably coupled to a transducer base structure via a diaphragm suspension system, and a transducing mechanism operatively coupled to the diaphragm to transduce between electrical audio signals and sound pressure, the diaphragm having: a main diaphragm body, a diaphragm base structure coupled to the diaphragm body, and a mounting mechanism for rigidly mounting the diaphragm body to the diaphragm base structure, comprising a pair of outer base reinforcing members coupled to opposing major faces of the diaphragm body, and at least one inner base reinforcing member located between the outer base reinforcing members and being aligned and connected to one of the outer base reinforcing members along an axis substantially parallel to a rotational axis about which the diaphragm assembly is configured to rotate during operation. In an embodiment, the diaphragm base structure comprises a magnetic body. Preferably the magnetic body is a permanent magnet. This provides a high-performing transducer with simplified diaphragm construction. The diaphragm body coupling members may enhance rigidity of the diaphragm base structure and may extend this further to the diaphragm,

In another aspect, the invention may broadly be said to consist of an audio transducer comprising: a diaphragm rotatably coupled to a transducer base structure via a diaphragm suspension system, and a transducing mechanism operatively coupled to the diaphragm to transduce between electrical audio signals and sound pressure, the diaphragm having: a main diaphragm body, a diaphragm base structure coupled to the diaphragm body, and a mounting mechanism for rigidly mounting the diaphragm body to the diaphragm base structure, comprising at least one outer base reinforcing member coupled to a major face of the diaphragm body, and at least one inner base reinforcing member connected at one end to the outer base reinforcing member along the major face of the diaphragm body, and at an opposing end to the diaphragm base structure at a distance from the outer base reinforcing member. In an embodiment, the diaphragm base structure comprises a magnetic body. Preferably the magnetic body is a permanent magnet.

In another aspect, the invention may broadly be said to consist of an audio transducer comprising: a diaphragm rotatably coupled to a transducer base structure via a diaphragm suspension system, and a transducing mechanism operatively coupled to the diaphragm to transduce between electrical audio signals and sound pressure the diaphragm having: a main diaphragm body, a diaphragm base structure coupled to the diaphragm body, and a mounting mechanism for rigidly mounting the diaphragm body to the diaphragm base structure, comprising first and second outer base reinforcing members coupled to opposing major faces of the diaphragm body, and first and second inner base reinforcing members located internally of the outer base reinforcing members, wherein the first inner base reinforcing member couples the first outer base reinforcing member at a first location, the second inner base reinforcing member couples the second outer base reinforcing member at a second location, and the first and second locations are substantially distal from the axis of rotation, or from the longitudinal axis of the diaphragm base structure, or both. In an embodiment, the diaphragm base structure comprises a magnetic body. Preferably the magnetic body is a permanent magnet. In an embodiment, the first and second inner base reinforcing members couple to the diaphragm base structure at a distance from the outer base reinforcing member. In an embodiment, the first and second inner base reinforcing members couple to the diaphragm base structure at a distance from the outer base reinforcing member

In another aspect the invention may broadly be said to consist of an audio transducer comprising: a diaphragm rotatably coupled to a transducer base structure via a diaphragm suspension system, and a transducing mechanism operatively coupled to the diaphragm to transduce between electrical audio signals and sound pressure the diaphragm having: a main diaphragm body, a diaphragm base structure coupled to the diaphragm body, and a mounting mechanism for rigidly mounting the diaphragm body to the diaphragm base structure, comprising at least one outer base reinforcing member and at least one inner base reinforcing member, and wherein the outer base reinforcing member and the inner base reinforcing member intersect an angle of less than approximately 60 degrees. In an embodiment, the diaphragm base structure comprises a magnetic body. Preferably the magnetic body is a permanent magnet.

In another aspect the invention may broadly be said to consist of an audio transducer comprising: a diaphragm rotatably coupled to a transducer base structure via a diaphragm suspension system, and a transducing mechanism operatively coupled to the diaphragm to transduce between electrical audio signals and sound pressure the diaphragm having: a main diaphragm body, a diaphragm base structure coupled to the diaphragm body, at least one outer base reinforcing member and at least one inner base reinforcing member, and wherein an air cavity extends parallel to the axis of rotation between the diaphragm base structure, the outer base reinforcing member and the inner base reinforcing member. In an embodiment, the diaphragm base structure comprises a magnetic body. Preferably the magnetic body is a permanent magnet.

In another aspect the invention may broadly be said to consist of an audio transducer comprising: a diaphragm rotatably coupled to a transducer base structure via a diaphragm suspension system, and a transducing mechanism operatively coupled to the diaphragm to transduce between electrical audio signals and sound pressure the diaphragm having: a main diaphragm body, a diaphragm base structure coupled to the diaphragm body, and a mounting mechanism for rigidly mounting the diaphragm body to the diaphragm base structure, comprising at least one outer base reinforcing member and at least one inner base reinforcing member, and wherein the diaphragm base structure has at least two connection surfaces, one being aligned substantially parallel to or tangentially to and contacting the outer base reinforcing member, and one being aligned substantially parallel to or tangentially to and contacting the inner base reinforcing member. In an embodiment, the diaphragm base structure comprises a magnetic body. Preferably the magnetic body is a permanent magnet. This design simplifies manufacturing while reducing a chance of peeling failure at connection points.

In another aspect the invention may broadly be said to consist of an audio transducer diaphragm comprising a diaphragm body having a diaphragm body of a material having a varying density along a length of the body. Preferably density reduces with increasing radius from the diaphragm axis of rotation. This design reduces the shear-mode limitation of diaphragm breakup performance and is suitable for scale manufacturing.

In another aspect the invention may broadly be said to consist of an audio transducer diaphragm comprising a substantially rectangular cross-sectional shape and diaphragm body of a material having a varying density along a length of the body.

In another aspect the invention may broadly be said to consist of an audio transducer comprising: diaphragm having a diaphragm body having a diaphragm body of a material having a varying density along a length of the body; a transducer base structure; a diaphragm suspension system coupling the diaphragm to the transducer base structure to enable rotational motion of the diaphragm about an axis of rotation; and a transducing mechanism operatively coupled to the diaphragm to transduce between electrical audio signals and sound pressure.

In another aspect the invention may broadly be said to consist of an audio transducer comprising: diaphragm having a substantially rectangular cross-sectional shape and diaphragm body of a material having a varying density along a length of the body; a transducer base structure; a diaphragm suspension system coupling the diaphragm to the transducer base structure to enable rotational motion of the diaphragm about an axis of rotation; and a transducing mechanism operatively coupled to the diaphragm to transduce between electrical audio signals and sound pressure.

In another aspect, the invention may broadly be said to consist of an audio transducer comprising: a diaphragm; a transducer base structure; a diaphragm suspension system rotatably mounting the diaphragm to the transducer base structure; and a transducing mechanism operatively coupled to the diaphragm to transduce between electrical audio signals and sound pressure, wherein the audio transducer further comprises a magnetic restoring mechanism for biasing the diaphragm toward a neutral, rotational position.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm relative to the transducer base structure about an axis of rotation; and a transducing mechanism operatively coupled to the diaphragm to transduce between electrical audio signals and sound pressure, wherein each contact hinge joint comprises up to four contact interfaces, each having a pair of contacting surfaces moveable relative to one another. The hinge system is a simple yet stable and moves freely.

In an embodiment, the diaphragm suspension system comprises a single contact hinge joint mounted on either side of the diaphragm.

In an embodiment, each contact hinge joint comprises a first contact interface having a first pair of contacting surfaces moveable relative to one another and a second contact interface having a second pair of contacting surfaces moveable relative to one another, and wherein an axis of a first net reaction force applied to the diaphragm at the first contact interface is angled relative to an axis of a second net reaction force applied to the diaphragm at the second contact interface.

In an embodiment, for each hinge joint, a contact surface of each contact interface is connected to the diaphragm.

In an embodiment, the axes of the first and second net reaction forces are angled relative to one another about the axis of rotation.

In an embodiment, the first and second contact interfaces operatively define the translational location of at least a part of the diaphragm relative to the transducer base structure in all directions perpendicular to the diaphragm axis of rotation.

In an embodiment, one or more contact interfaces of each contact hinge joint comprise a substantially round contact surface of a rolling element associated with the interface.

In an embodiment, each contact hinge joint comprises exactly two rolling elements, each associated with a respective contact interface within the hinge joint.

In an embodiment, each rolling element is substantially spherical.

In an embodiment, a compliant biasing mechanism is associated with each contact hinge joint, the compliant biasing mechanism being configured to bias the pair of contacting surfaces of each contact interface toward one another to remain in contact during operation.

In another aspect, the invention may broadly be said to consist of an audio transducer comprising a diaphragm; a transducer base structure; a diaphragm suspension system comprising at least one contact hinge joint coupling the diaphragm to the transducer base structure to enable rotational motion of the diaphragm relative to the transducer base structure about an axis of rotation; and a transducing mechanism operatively coupled to the diaphragm to transduce between electrical audio signals and sound pressure, wherein each contact hinge joint comprises at least one contact interface having a pair of contacting surfaces moveable relative to one another, and wherein a first contact surface of one or more of the contact interface(s) forms a periphery of a first, generally non-round body of the audio transducer, and a corresponding contact surface of a second contact element forms a periphery of another second generally non-round body of the audio transducer. Such a design may provide high performance in applications involving reciprocating rotational action and requiring high precision.

In an embodiment, each contact hinge joint comprises two contact interfaces, each contact interface having a pair of contacting surfaces moveable relative to one another, and wherein for each contact interface, a first contact surface forms a periphery of the first body and contacts a corresponding contact surface that forms a periphery of the second body, and wherein the first and second non-round bodies are coupled or integral with the diaphragm or the transducer base structure respectively.

In an embodiment, the substantially non-rounded first contact element of each contact interface is substantially elongate.

In an embodiment, the substantially elongate first contact element of each contact interface extends radially inward, with respect to the axis of rotation, towards the corresponding contact surface of the second contact element.

In an embodiment, the longitudinal axes of the two elongate first contact elements are substantially angled relative to one another about the axis of rotation.

In an embodiment, the audio transducer further comprises a compliant biasing mechanism associated with each contact hinge joint, the compliant biasing mechanism being configured to bias the pair of contacting surfaces of each contact interface toward one another to remain in contact during operation.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm relative to the transducer base structure about an axis of rotation; and a transducing mechanism operatively coupled to the diaphragm to transduce between electrical audio signals and sound pressure, wherein each contact hinge joint comprises at least one contact interface having a pair of contacting surfaces moveable relative to one another, and wherein each contact interface comprises first and second contact elements, with the first contact element being flexibly connected to either the diaphragm or the transducer base structure.

In an embodiment, the at least one contact hinge joint comprises a first contact interface and a second contact interface, each contact interface having a first contact element and a second contact element, and wherein the first contact element of the first contact interface and the first contact element of the second contact interface are each flexibly connected to either the diaphragm or the transducer base structure.

In an embodiment, the audio transducer further comprises a compliant biasing mechanism associated with the diaphragm suspension, the compliant biasing mechanism being configured to bias the pair of contacting surfaces of each contact interface toward one another to remain in contact during operation.

In an embodiment, the audio transducer includes a first contact element of each contact interface that is substantially compliant to allow for resilient deformation in response to applied forces during operation.

In an embodiment, the audio transducer includes a second contact element of each contact interface that is substantially compliant to allow for resilient deformation in response to applied forces during operation.

In an embodiment, the audio transducer includes a first contact element of each contact interface that is substantially damped to at least partially alleviate transmission of mechanical vibration through the element during operation.

In an embodiment, the audio transducer includes a second contact element of each contact interface that is substantially damped to at least partially alleviate transmission of mechanical vibration through the element during operation.

In an embodiment, each contact hinge joint of the audio transducer is associated with a compliance mechanism, the compliance mechanism being configured to provide compliance to the hinge joint, thereby enabling the diaphragm to move relative to the transducer base structure with reduced resistance in the vicinity of the hinge joint.

In an embodiment, the at least one contact hinge joint of the audio transducer is associated with a damping mechanism, the damping mechanism being configured to provide damping to the hinge joint, thereby enabling the attenuation of vibrations between the diaphragm and the transducer base structure during operation in the vicinity of the hinge joint.

In an embodiment, the audio transducer further comprises a restoring mechanism associated with the at least one contact hinge joint, the restoring mechanism being configured to exert a force that biases the diaphragm toward a neutral rotational position relative to the transducer base structure.

In an embodiment, the restoring mechanism of the audio transducer comprises a torsion bar configured to exert the force that biases the diaphragm toward the neutral rotational position. In an embodiment, for each hinge joint of the audio transducer, each contact surface of each contact interface is substantially non-planar.

In an embodiment, for each hinge joint of the audio transducer, each contact surface of each contact interface is substantially rigid.

In an embodiment, each hinge joint of the audio transducer comprises stoppers or limiters configured to restrict the range of motion of one or more of the first contact elements.

In embodiment the transducing mechanism comprises magnetic and/or ferromagnetic bodies configured to impart operational forces associated with a received electrical audio signal on the diaphragm to transduce the signal into sound pressure, and further configured to impart unwanted or intrinsic forces on the diaphragm due to magnetic interaction between the ferromagnetic and magnetic bodies.

In an embodiment, the audio transducer further comprises a restoring or biasing mechanism configured to substantially restore or bias the angular position of the diaphragm toward a neutral, angular position to counter the intrinsic forces experienced between the ferromagnetic and magnetic bodies of the transducing mechanism.

In another aspect, the invention may broadly be said to consist of an audio transducer comprising a diaphragm; a transducer base structure; a diaphragm suspension system comprising at least one contact hinge joint coupling the diaphragm to the transducer base structure to enable rotational motion of the diaphragm relative to the transducer base structure about an axis of rotation; and a transducing mechanism operatively coupled to the diaphragm to transduce between electrical audio signals and sound pressure, wherein each contact hinge joint comprises a first contact interface having a first pair of contacting surfaces moveable relative to one another and a second contact interface having a second pair of contacting surfaces moveable relative to one another, and wherein an axis of a first net reaction force applied to the diaphragm at the first contact interface is angled relative to an axis of a second net reaction force applied to the diaphragm at the second contact interface; the audio transducer further comprising a compliant biasing mechanism associated with each contact hinge joint, the compliant biasing mechanism being configured to bias the pair of contacting surfaces of each contact interface toward one another to remain in contact during operation. Effective transducer based on a simple, stable and reliable hinge system providing high performance and low sensitivity to manufacturing variance.

In an embodiment, the angle between the axis of the first net reaction force applied to the diaphragm at the first contact interface and the axis of the second net reaction force applied to the diaphragm at the second contact interface, relative to the axis of rotation, is less than 155 degrees.

In an embodiment, the angle between the axis of the first net reaction force applied to the diaphragm at the first contact interface and the axis of the second net reaction force applied to the diaphragm at the second contact interface, relative to the axis of rotation, is less than 25 degrees.

In an embodiment, each contact hinge joint comprises less than four contact interfaces.

In an embodiment, each contact hinge joint comprises exactly two contact interfaces.

In an embodiment, one or more contact interfaces of each contact hinge joint comprise a substantially round contact surface of a rolling element associated with the interface, and each contact hinge joint comprises exactly two rolling elements, each associated with a respective contact interface within the hinge joint.

In an embodiment, the contact surfaces associated with the first and second net reaction forces are in close proximity to one another along the axis of rotation.

In an embodiment, a connection between at least one contact surface of each hinge joint and the transducer base structure or diaphragm is substantially rigid, at least in translation, along an axis of a net reaction force applied to the transducer base structure or diaphragm at the contact interface.

In an embodiment, the first and second contact interfaces operatively define the translational location of at least a part of the diaphragm relative to the transducer base structure in all directions perpendicular to the diaphragm axis of rotation.

In an embodiment, the axis of rotation of the diaphragm is substantially contained in a first imaginary plane that is substantially perpendicular to a second imaginary plane of the diaphragm containing the radial axis of the diaphragm, and that contains/intersects the node axis of the diaphragm, the node axis being a second axis of rotation about which the diaphragm would rotate relative to the transducer base structure if: the diaphragm is effectively substantially unsupported by the diaphragm suspension system, and the diaphragm is subjected to the mechanical force(s) associated with the transducing mechanism, in-use.

In another aspect, the invention may broadly be said to consist of an audio transducer comprising a diaphragm; a transducer base structure; a diaphragm suspension system comprising at least one contact hinge joint coupling the diaphragm to the transducer base structure to enable rotational motion of the diaphragm relative to the transducer base structure about an axis of rotation; and a transducing mechanism operatively coupled to the diaphragm to transduce between electrical audio signals and sound pressure, wherein each contact hinge joint comprises a first contact interface having a first pair of contacting surfaces moveable relative to one another and a second contact interface having a second pair of contacting surfaces moveable relative to one another, and wherein an axis of a first net reaction force applied to the diaphragm at the first contact interface is angled relative to an axis of a second net reaction force applied to the diaphragm at the second contact interface, wherein each of the contacting surfaces is substantially rigid.

In an embodiment, each contact hinge joint of the audio transducer comprises less than four contact interfaces.

In an embodiment, each contact hinge joint of the audio transducer comprises exactly two contact interfaces.

In an embodiment, one or more contact interfaces of each contact hinge joint of the audio transducer comprise a substantially round contact surface of a rolling element associated with the interface, and each contact hinge joint comprises exactly two rolling elements, each associated with a respective contact interface within the hinge joint.

In an embodiment, the contact surfaces associated with the first and second net reaction forces of the audio transducer are in close proximity to one another along the axis of rotation.

In an embodiment, a connection between at least one contact surface of each hinge joint of the audio transducer and the transducer base structure or diaphragm is substantially rigid, at least in translation, along an axis of a net reaction force applied to the transducer base structure or diaphragm at the contact interface.

In an embodiment, the first and second contact interfaces of the audio transducer operatively define the translational location of at least a part of the diaphragm relative to the transducer base structure in all directions perpendicular to the diaphragm axis of rotation.

In an embodiment, the angle between the axis of the first net reaction force applied to the diaphragm at the first contact interface and the axis of the second net reaction force applied to the diaphragm at the second contact interface, relative to the axis of rotation, of the audio transducer is less than 155 degrees.

In an embodiment, the angle between the axis of the first net reaction force applied to the diaphragm at the first contact interface and the axis of the second net reaction force applied to the diaphragm at the second contact interface, relative to the axis of rotation, of the audio transducer is greater than 25 degrees.

In an embodiment, the transducing mechanism of the audio transducer comprises a magnetic-flux-generating body (herein: “magnetic body”) rigidly fixed to the diaphragm.

In an embodiment, the magnetic body of the audio transducer is a permanent magnet.

In an embodiment, a direction of magnetization of the permanent magnet of the audio transducer is substantially perpendicular to a major face of the diaphragm.

In an embodiment, the transducing mechanism of the audio transducer comprises one or more ferromagnetic bodies coupled to the transducer base structure and extending in close proximity to the magnetic body fixed to the diaphragm.

In an embodiment, the transducing mechanism of the audio transducer comprises one or more ferromagnetic bodies coupled to the transducer base structure and extending directly adjacent each of the poles of the magnetic body fixed to the diaphragm.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm relative to the transducer base structure about an axis of rotation; and a transducing mechanism operatively coupled to the diaphragm to transduce between electrical audio signals and sound pressure, wherein each contact hinge joint comprises a first contact interface having a first pair of contacting surfaces moveable relative to one another and a second contact interface having a second pair of contacting surfaces moveable relative to one another, and wherein an axis of a first net reaction force applied to the diaphragm at the first contact interface is angled relative to an axis of a second net reaction force applied to the diaphragm at the second contact interface, and wherein the first and second contact interfaces operatively define the translational location of at least a part of the diaphragm relative to the transducer base structure in all directions perpendicular to the diaphragm axis of rotation. This transducer features a simple, stable hinge system, based on a reduced number of components.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm relative to the transducer base structure about an axis of rotation; and a transducing mechanism operatively coupled to the diaphragm to transduce between electrical audio signals and sound pressure, wherein each contact hinge joint comprises a first contact interface having a first pair of contacting surfaces moveable relative to one another and a second contact interface having a second pair of contacting surfaces moveable relative to one another, wherein an axis of a first net reaction force applied to the diaphragm at the first contact interface is angled relative to an axis of a second net reaction force applied to the diaphragm at the second contact interface, and wherein the audio transducer further comprises a biasing mechanism comprising ferromagnetic and/or magnetic bodies of the transducing mechanism and configured to bias each pair of contacting surfaces of each hinge joint toward one another. This simple and effective hinge features a compliant biasing system that promotes free action even with reduced manufacturing tolerances.

In an embodiment, each connection that couples a contact surface of each hinge joint to the transducer base structure is substantially rigid, at least in translation, along an axis of a net reaction force applied to the transducer base structure at the contact interface.

In an embodiment, each connection that couples a contact surface of each hinge joint to the diaphragm is substantially rigid, at least in translation, along an axis of a net reaction force applied to the diaphragm at the contact interface.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm relative to the transducer base structure about an axis of rotation; and a transducing mechanism operatively coupled to the diaphragm to transduce between electrical audio signals and sound pressure, wherein each contact hinge joint comprises a first contact interface having a first pair of contacting surfaces moveable relative to one another and a second contact interface having a second pair of contacting surfaces moveable relative to one another, wherein the transducing mechanism comprises a magnetic-flux-generating body (herein: “magnetic body”) rigidly fixed to the diaphragm, and wherein the transducing mechanism further comprises one or more ferromagnetic bodies coupled to the transducer base structure and extending in close proximity to the magnetic body fixed to the diaphragm. Use of ferromagnetic structures improves efficiency while a simple and stable hinge system promotes reliability.

In an embodiment, in one or more regions, the ferromagnetic bodies coupled to the transducer base structure are directly adjacent but separated from the magnetic body coupled to the diaphragm by a substantially small air gap, with no intermediate transducing mechanism components extending within the air gap in such region(s).

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm relative to the transducer base structure about an axis of rotation; and a transducing mechanism operatively coupled to the diaphragm to transduce between electrical audio signals and sound pressure, wherein each contact hinge joint comprises at least one contact interface having a first pair of contacting surfaces moveable relative to one another and at least one contact element locating between corresponding inner and outer contact surfaces of the hinge joint, and wherein the hinge joint further comprises stoppers or limiters configured to restrict the location of the contact element between the inner and outer surfaces to within a particular angular range, about the axis of rotation. In this design a simple stopper system promotes stability and reliability of a simple and effective hinge system.

In another aspect, the invention may broadly be said to consist of an audio transducer comprising: a diaphragm; a transducer base structure; a diaphragm suspension system comprising a contact hinge joint located on each side of the diaphragm coupling the diaphragm to the transducer base structure to enable rotational motion of the diaphragm relative to the transducer base structure about an axis of rotation; and a transducing mechanism operatively coupled to the diaphragm to transduce between electrical audio signals and sound pressure, wherein each contact hinge joint comprises at least one contact interface having a pair of contacting surfaces moveable relative to one another, the diaphragm suspension system further comprising a compliant biasing mechanism associated with each contact hinge joint, the compliant biasing mechanism being configured to bias the pair of contacting surfaces of each contact interface toward one another to remain in contact during operation, and a restoring mechanism configured to provide a rotational restoring force to rotate the diaphragm toward a neutral rotational position and restrain the hinge joints in terms of translational displacement along the axis of rotation. The simple and effective hinge features a compliant biasing system that promotes free action, and separated diaphragm restoring force mechanism promotes reliability.

In an embodiment, each contact hinge joint or a mounting of the contact hinge joint is substantially compliant in translation along the axis of rotation.

In an embodiment, each contact hinge joint comprises up to four contact interfaces, each having a pair of contacting surfaces moveable relative to one another.

In an embodiment, the contact surfaces of each hinge joint are substantially rigid.

In an embodiment, a connection between at least one contact surface of each hinge joint and the transducer base structure or diaphragm is substantially rigid, at least in translation, along an axis of a net reaction force applied to the transducer base structure or diaphragm at the corresponding contact interface.

In an embodiment, each hinge joint comprises a pair of first and second contact elements, each with substantially rounded outer peripheries configured to contact against one another at the peripheries to enable rotational motion of the diaphragm relative to the transducer base structure.

In an embodiment, in-use, the two pairs of contact surfaces associated with the first and second contact elements together perfectly constrain a diaphragm location proximal to the suspension system of which they are a part, in terms of directions perpendicular to the diaphragm axis of rotation.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm about an axis of rotation; and a transducing mechanism operatively coupled to the diaphragm to transduce between electrical audio signals and sound pressure, wherein each contact hinge joint comprises at least one contact interface having a pair of contacting surfaces moveable relative to one another, and wherein each hinge joint further comprises a rolling element moveable between inner and outer contact surfaces, and contacting each of the inner and outer contacting surfaces at a single location.

In an embodiment, each rolling element is substantially spherical.

In an embodiment, an axis normal to a point of contact for each of the inner and outer contact surfaces of each hinge joint is substantially perpendicular to the axis of rotation.

In an embodiment, for each hinge joint, the outer contact surface has a radius of curvature greater than the outer radius of the rolling element about the axis of rotation.

In an embodiment, each contact hinge joint comprises first and second rolling elements between corresponding inner and outer contact surfaces, and wherein an axis of a first net reaction force applied to the diaphragm at the first contact interface is angled relative to an axis of a second net reaction force applied to the diaphragm at the second contact interface.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm relative to the transducer base structure about an axis of rotation; and a transducing mechanism operatively coupled to the diaphragm to transduce between electrical audio signals and sound pressure, wherein each contact hinge joint comprises at least one contact interface having a pair of contacting surfaces moveable relative to one another, wherein each hinge joint further comprises a rolling element moveable between inner and outer contact surfaces, at least one of which is concavely curved, and wherein the hinge joint further comprises stoppers or limiters with a reduced radius in the respective curved inner or outer contact surface to restrict the location of the rolling element on the curved inner or outer contact surface to within a particular angular range, about the axis of rotation.

In an embodiment, each contact hinge joint comprises two rolling elements associated with a respective contact interface within the hinge joint.

In an embodiment, the diaphragm suspension system comprises a contact hinge joint located on each side of the diaphragm.

In an embodiment, each contact hinge joint comprises a first contact interface having a first pair of contacting surfaces moveable relative to one another and a second contact interface having a second pair of contacting surfaces moveable relative to one another, and wherein an axis of a first net reaction force applied to the diaphragm at the first contact interface is angled relative to an axis of a second net reaction force applied to the diaphragm at the second contact interface.

In an embodiment, the angle between the axis of the first net reaction force and the axis of the second net reaction force, about the axis of rotation, substantially less than 155 degrees.

In an embodiment, the angle between the axis of the first net reaction force and the axis of the second net reaction force, about the axis of rotation, substantially greater than 25 degrees.

In an embodiment, the audio transducer further comprises a compliant biasing mechanism associated with each contact hinge joint, the compliant biasing mechanism being configured to bias the pair of contacting surfaces of each contact interface toward one another to remain in contact during operation.

In an embodiment, the transducing mechanism comprises a magnetic-flux-generating body (herein: “magnetic body”) rigidly fixed to the diaphragm, and wherein the transducing mechanism further comprises one or more ferromagnetic bodies coupled to the transducer base structure and extending directly adjacent each of the poles of the magnetic body fixed to the diaphragm.

In an embodiment, each rolling element contacts each of the corresponding inner and outer contact surfaces at a single location.

In an embodiment, the reduced radius of the curved contact surface maintains a radius larger than that of an outer contact surface of the rolling element relative to the axis of rotation, to prevent contact between the stopper and the rolling element during normal operation unless the rolling element slips from an intended position on the curved contact surface.

In an embodiment, the axis of rotation of the diaphragm is substantially contained in a first imaginary plane that is substantially perpendicular to a second imaginary plane of the diaphragm containing the radial axis of the diaphragm, and that contains/intersects the node axis of the diaphragm, the node axis being a second axis of rotation about which the diaphragm would rotate relative to the transducer base structure if: the diaphragm is effectively substantially unsupported by the diaphragm suspension system, and the diaphragm is subjected to the mechanical force(s) associated with the transducing mechanism, in-use.

In an embodiment, each connection that couples a contact surface of each hinge joint to the transducer base structure is substantially rigid, at least in translation, along an axis of a net reaction force applied to the transducer base structure at the contact interface.

In an embodiment, each connection that couples a contact surface of each hinge joint to the diaphragm is substantially rigid, at least in translation, along an axis of a net reaction force applied to the diaphragm at the contact interface.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm relative to the transducer base structure about an axis of rotation; and a transducing mechanism operatively coupled to the diaphragm to transduce between electrical audio signals and sound pressure and comprising ferromagnetic and/or magnetic bodies, each contact hinge joint comprises at least one contact interface having a pair of contacting surfaces moveable relative to one another, the transducing mechanism having a magnetic-flux-generating body (herein: “magnetic body”) rigidly fixed to the diaphragm, and wherein the transducing mechanism is further configured to impart intrinsic forces on the diaphragm separate from the operational forces associated with the transduction of electrical audio signals, said forces resulting from magnetic interaction between the ferromagnetic and/or magnetic bodies of the transducing mechanism, and wherein the audio transducer further comprises a restoring or biasing mechanism configured to counter the intrinsic forces experienced between the ferromagnetic and magnetic bodies of the transducing mechanism. Ferromagnetic elements improve efficiency, a simple hinge maintains stability and free action, and intrinsic ferromagnetic forces may be managed via a dedicated restoring mechanism, leading to high performance across several aspects.

In an embodiment, the restoring or biasing mechanism comprising a flexing element with a Young's Modulus greater than 2 Gigapascals (GPa).

In an embodiment, the restoring or biasing mechanism comprising a flexing element with a Young's Modulus greater than 4 GPa.

In an embodiment, the restoring or biasing mechanism comprising a flexing element with a Young's Modulus greater than 8 GPa.

In an embodiment, the flexing element is formed from a metal material.

In an embodiment, the flexing element comprises a torsion bar.

In an embodiment, the flexing element is incorporated in at least one hinge joint.

In an embodiment, the intrinsic forces comprise a negative rotational stiffness about the diaphragm's axis of rotation. In an embodiment, the intrinsic forces act to bias the diaphragm away from a desired neutral or rest angle.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm relative to the transducer base structure about an axis of rotation, each contact hinge joint having at least one contact interface having a first pair of contacting surfaces moveable relative to one another; and a transducing mechanism having a magnetic-flux-generating body (herein: “magnetic body”) rigidly fixed to the diaphragm and other magnetic and ferromagnetic bodies operative to impart operational forces on the diaphragm based on a received electrical audio signal to transduce the signal into sound pressure, wherein the magnetic and/or ferromagnetic bodies of the transducing mechanism are further configured to impart non-transducing intrinsic forces on the diaphragm due to magnetic interaction between the ferromagnetic and magnetic bodies, and wherein, the diaphragm suspension system or at least one hinge joint of the diaphragm suspension system is configured to counter the non-transducing intrinsic forces of the transducing mechanism to offset the effects of such forces on a rotational position of the diaphragm during operation.

In an embodiment, the diaphragm suspension system is configured to apply a biasing force to counter the non-transducing intrinsic forces of the transducing mechanism.

In an embodiment, the diaphragm suspension system comprises other magnetic and/or ferromagnetic bodies separate to the transducing mechanism configured to apply the biasing force.

In an embodiment, a biasing force is applied due to geometries of the at least one hinge joint.

In an embodiment, the diaphragm suspension further comprises a flexing element contributing to rotational biasing towards a desired diaphragm rest angle.

In another aspect, the invention may broadly be said to consist of an audio transducer comprising: a diaphragm; a transducer base structure; a diaphragm suspension system comprising at least one contact hinge joint coupling the diaphragm to the transducer base structure to enable rotational motion of the diaphragm relative to the transducer base structure about an axis of rotation, each contact hinge joint having at least one contact interface having a first pair of contacting surfaces moveable relative to one another; and a transducing mechanism having a magnetic-flux-generating body (herein: “magnetic body”) rigidly fixed to the diaphragm and other magnetic and ferromagnetic bodies operative to impart operational forces on the diaphragm based on a received electrical audio signal to transduce the signal into sound pressure, wherein the magnetic and/or ferromagnetic bodies of the transducing mechanism are further configured to impart non-transducing intrinsic forces on the diaphragm due to magnetic interaction between the ferromagnetic and magnetic bodies, and wherein the diaphragm suspension system comprises other magnetic and/or ferromagnetic bodies separate to the transducing mechanism configured to counter the non-transducing intrinsic forces of the transducing mechanism to offset the effects of such forces on a rotational position of the diaphragm during operation.

In another aspect, the invention may broadly be said to consist of an audio transducer comprising: a diaphragm; a transducer base structure; a diaphragm suspension system coupling the diaphragm to the transducer base structure to enable rotational motion of the diaphragm about an axis of rotation; and a transducing mechanism having magnetic and ferromagnetic bodies coupled to the diaphragm and the transducer base structure and operative to impart operational forces on the diaphragm based on a received electrical audio signal to transduce the signal into sound pressure, wherein the magnetic and/or ferromagnetic bodies of the transducing mechanism are further configured to impart non-transducing intrinsic forces on the diaphragm due to magnetic interaction between the ferromagnetic and magnetic bodies; wherein the diaphragm suspension system includes at least one flexible hinge joint configured to enable the rotational motion of the diaphragm about the axis of rotation, each flexible hinge joint having at least two elongate and substantially thin flexing elements oriented at different angles relative to one another.

In an embodiment, the transducing mechanism comprises a permanent magnet rigidly coupled to the diaphragm, and a ferromagnetic structure rigidly coupled to the transducer base structure and wraps over the magnetic poles of the permanent magnet.

In another aspect, the invention may broadly be said to consist of an audio transducer comprising: a diaphragm; a transducer base structure; a diaphragm suspension system coupling the diaphragm to the transducer base structure to enable rotational motion of the diaphragm about an axis of rotation; and a transducing mechanism operatively coupled to the diaphragm to transduce between electrical audio signals and sound pressure; wherein the diaphragm suspension system comprises at least one flexible hinge joints configured to enable the rotational motion of the diaphragm about the axis of rotation, and a restoring or biasing mechanism acting on the flexible hinge joints and configured to restore or bias the diaphragm toward a neutral rotational position.

In an embodiment, the restoring or biasing mechanism comprises a torsion bar.

In an embodiment, the transducing mechanism comprises magnetic and ferromagnetic bodies coupled to the diaphragm and the transducer base structure and operative to impart operational forces on the diaphragm based on a received electrical audio signal to transduce the signal into sound pressure, wherein the magnetic and/or ferromagnetic bodies of the transducing mechanism are further configured to impart non-transducing intrinsic forces on the diaphragm due to magnetic interaction between the ferromagnetic and magnetic bodies.

In an embodiment, the diaphragm suspension system includes at least one flexible hinge joint configured to enable the rotational motion of the diaphragm about the axis of rotation, each flexible hinge joint having at least two elongate and substantially thin flexing elements oriented at different angles relative to one another.

In an embodiment, the transducing mechanism comprises a permanent magnet rigidly coupled to the diaphragm, and a ferromagnetic structure rigidly coupled to the transducer base structure and wraps over the magnetic poles of the permanent magnet.

In an embodiment, the intrinsic forces comprise a negative rotational stiffness about the diaphragm's axis of rotation.

In an embodiment, the intrinsic forces act to bias the diaphragm away from a desired neutral or rest angle.

In an aspect, the invention may broadly be said to consist of an audio transducer comprising: a diaphragm; a transducer base structure; a diaphragm suspension system coupling the diaphragm to the transducer base structure to enable rotational motion of the diaphragm about an axis of rotation; and a transducing mechanism operatively coupled to the diaphragm and configured to transduce between electrical audio signals and sound pressure, wherein the transducing mechanism comprises a permanent magnet rigidly coupled to the diaphragm, and wherein the permanent magnet comprises one or more formations for connecting to a corresponding connection plate of the diaphragm and wherein a surface of the formations faces inwardly toward an imaginary plane symmetrically bisecting the diaphragm and substantially parallel to the axis of rotation.

In an embodiment, the diaphragm comprises more than one connection plate connecting the diaphragm to the permanent magnet.

In an embodiment, the diaphragm comprises more than two connection plates connecting the diaphragm to the permanent magnet.

In an embodiment, the diaphragm comprises more than three connection plates connecting the diaphragm to the permanent magnet.

In another aspect, the invention may broadly be said to consist of an audio transducer comprising: a diaphragm; a transducer base structure; a diaphragm suspension system coupling the diaphragm to the transducer base structure to enable rotational motion of the diaphragm about an axis of rotation; and a transducing mechanism operatively coupled to the diaphragm and configured to transduce between electrical audio signals and sound pressure, wherein the transducing mechanism comprises a permanent magnet rigidly coupled to the diaphragm, and wherein the diaphragm comprises a first diaphragm body extending radially from the permanent magnet and the permanent magnet comprises one or more formations for connecting to more than two connection plates coupled to the first diaphragm body.

In an embodiment, a surface of each formation is substantially parallel to the axis of rotation.

In another aspect, the invention may broadly be said to consist of an audio transducer comprising: a diaphragm; a transducer base structure; a diaphragm suspension system coupling the diaphragm to the transducer base structure to enable rotational motion of the diaphragm about an axis of rotation; and a transducing mechanism operatively coupled to the diaphragm and configured to transduce between electrical audio signals and sound pressure, wherein the transducing mechanism comprises a permanent magnet rigidly coupled to the diaphragm, and wherein the permanent magnet comprises one or more formations for connecting to one or more connection plates coupled to the diaphragm, and the diaphragm increases in thickness from the permanent magnet toward an intermediate region, and reduces in thickness following the intermediate region towards an end of the diaphragm distal from the permanent magnet.

In an embodiment, the diaphragm comprises more than one connection plate connecting the diaphragm to the permanent magnet wherein each connection plate is oriented substantially parallel to the axis of rotation.

In an embodiment, the diaphragm comprises more than two connection plates connecting the diaphragm to the permanent magnet.

In an embodiment, the diaphragm comprises more than three connection plates connecting the diaphragm to the permanent magnet.

In an embodiment, one or more of the formations for connecting to one or more connection plates is oriented in a manner so that, as it is traversed in a direction maximally away from the diaphragm axis of rotation, the distance to an imaginary plane symmetrically bisecting the diaphragm increases.

In an embodiment, the one or more of the formations connects to an outer reinforcement plate of the diaphragm.

In an embodiment, the one or more of the formations is oriented substantially parallel to the proximal part of an adjoining major diaphragm face.

In another aspect, the invention may broadly be said to consist of an audio transducer comprising: a diaphragm; a transducer base structure; a diaphragm suspension system coupling the diaphragm to the transducer base structure to enable rotational motion of the diaphragm about an axis of rotation; and a transducing mechanism operatively coupled to the diaphragm and the transducer base structure, configured to transduce between electrical audio signals and sound pressure, wherein the transducing mechanism comprises: a magnetic-flux-generating body (herein: “magnetic body”) rigidly fixed to the diaphragm, a coil winding having multiple sides rigidly coupled to the transducer base structure and having at least one primary side extending adjacent a corresponding magnetic pole of the magnetic body, and one or more ferromagnetic components extending over and wrapping around more than one side of the coil winding.

In an embodiment, the coil winding comprises two primary sides extending adjacent respective north and south poles of the magnetic body.

In an embodiment, a first ferromagnetic component extends over and wraps around a first primary side of the coil and one or both adjacent sides of the coil, and a second ferromagnetic component extends over and wraps around a second primary side of the coil and one or both adjacent sides of the coil.

In an embodiment, each ferromagnetic component wraps around a corresponding primary side of the coil winding along a substantial length of the coil winding.

In an embodiment, each ferromagnetic component extends over the coil winding and terminates directly adjacent a respective magnetic pole of the permanent magnet.

In an embodiment, the diaphragm suspension system comprises at least one hinge joint, and each hinge joint comprises at least one contact interface having a pair of contacting surfaces moveable relative to one another.

In an embodiment, the audio transducer further comprises a compliant biasing mechanism associated with each contact hinge joint, the compliant biasing mechanism being configured to bias the pair of contacting surfaces of each contact interface toward one another to remain in contact during operation.

In another aspect, the invention may broadly be said to consist of an audio transducer comprising: a diaphragm; a transducer base structure; a diaphragm suspension system coupling the diaphragm to the transducer base structure to enable rotational motion of the diaphragm about an axis of rotation; and a transducing mechanism operatively coupled to the diaphragm and the transducer base structure, configured to transduce between electrical audio signals and sound pressure, wherein the transducing mechanism comprises: a magnetic-flux-generating body (herein: “magnetic body”) rigidly fixed to the diaphragm, a coil winding rigidly coupled to the transducer base structure and having at least one primary side extending adjacent a corresponding magnetic pole of the magnetic body, and one or more ferromagnetic components each extending to a greater extent in the direction of the radial axis of the diaphragm than the proximal pole region of the magnetic body.

In an embodiment, the magnetic body comprises a direction of magnetization that is substantially perpendicular to an imaginary plane containing a radial axis of the diaphragm and the axis of rotation.

In another aspect, the invention may broadly be said to consist of an audio transducer comprising: a diaphragm; a transducer base structure; a diaphragm suspension system coupling the diaphragm to the transducer base structure to enable rotational motion of the diaphragm about an axis of rotation; and a transducing mechanism operatively coupled to the diaphragm and the transducer base structure, configured to transduce between electrical audio signals and sound pressure, wherein the transducing mechanism comprises: a magnetic-flux-generating body (herein: “magnetic body”) rigidly fixed to the diaphragm, a coil winding rigidly coupled to the transducer base structure and having at least one primary side extending adjacent a corresponding magnetic pole of the magnetic body, and one or more ferromagnetic components each extend to a greater extent in the direction of the radial axis of the diaphragm than the coil. In an embodiment, the one or more ferromagnetic components each extend from one side of the magnetic body, over the coil, and toward the other side of the magnetic body.

In an embodiment, the one or more ferromagnetic claim components each terminate in a region that is in closer proximity to an end of the diaphragm distal from the axis of rotation than the coil.

In an embodiment, the one or more ferromagnetic components each extend to a greater extent in the direction of the radial axis of the diaphragm than the magnetic body.

In an embodiment, the magnetic body comprises a direction of magnetization that is substantially perpendicular to an imaginary plane containing a radial axis of the diaphragm and the axis of rotation.

In another aspect, the invention may broadly be said to consist of an audio transducer comprising: a diaphragm; a transducer base structure; a diaphragm suspension system coupling the diaphragm to the transducer base structure to enable rotational motion of the diaphragm about an axis of rotation; and a transducing mechanism operatively coupled to the diaphragm and the transducer base structure, configured to transduce between electrical audio signals and sound pressure, wherein the transducing mechanism comprises: a magnetic-flux-generating body (herein: “magnetic body”) rigidly fixed to the diaphragm, a coil winding rigidly coupled to the transducer base structure and having at least one primary side extending adjacent a corresponding magnetic pole of the magnetic body, and one or more ferromagnetic components each extending beyond a side of the magnet distal from the diaphragm, around and over the coil, and further comprising an air cavity having substantial depth along the radial axis of the diaphragm between the ferromagnetic component(s) and the side of the magnet distal from the diaphragm.

In another aspect, the invention may broadly be said to consist of an audio transducer comprising: a diaphragm; a transducer base structure; a diaphragm suspension system coupling the diaphragm to the transducer base structure to enable rotational motion of the diaphragm about an axis of rotation; and a transducing mechanism operatively coupled to the diaphragm and the transducer base structure, configured to transduce between electrical audio signals and sound pressure, wherein the transducing mechanism comprises: a magnetic-flux-generating body (herein: “magnetic body”) rigidly fixed to the diaphragm, a coil winding rigidly coupled to the transducer base structure and having at least one primary side extending adjacent a corresponding magnetic pole of the magnetic body, and one or more ferromagnetic components each extending beyond? a side of the magnet distal from the diaphragm, around and over the coil, and wherein an inner surface of each ferromagnetic component facing the magnetic body is most distal at a region opposing a central region of the magnetic body compared to a region opposing a respective magnetic pole of the body.

In an embodiment, the magnetic body comprises a direction of magnetization that is substantially perpendicular to an imaginary plane containing a radial axis of the diaphragm and the axis of rotation.

In an embodiment, the coil winding comprises two primary sides extending adjacent respective north and south poles of the magnetic body.

In an embodiment, the diaphragm suspension system comprises at least one hinge joint, and each hinge joint comprises at least one contact interface having a pair of contacting surfaces moveable relative to one another.

In an embodiment, the audio transducer further comprises a compliant biasing mechanism associated with each contact hinge joint, the compliant biasing mechanism being configured to bias the pair of contacting surfaces of each contact interface toward one another to remain in contact during operation.

The following statements relate to various embodiments or implementations applicable to any of the aforementioned aspects. The features described may be implemented separately or in any suitable sub-combination with other features from the same or other embodiments, unless specifically stated otherwise or unless it is clear from the context that such combinations would not be feasible or would contradict the intended operation of the audio transducer.

In an embodiment the diaphragm is substantially rigid and remains substantially rigid during operation.

In an embodiment, the transducer base structure is substantially rigid, and remains substantially rigid during operation.

### Embodiments of the Transducing Mechanism of any of the Aforementioned Aspects

In an embodiment, the transducing mechanism comprises a magnetic-flux-generating body (herein: “magnetic body”) rigidly fixed to the diaphragm. The magnetic body may comprise a permanent magnet. In an embodiment, a direction of magnetisation of the magnetic body is substantially perpendicular to a major face of the diaphragm.

In an embodiment, a direction of magnetisation of the magnetic body is substantially perpendicular to an imaginary plane comprising a radial axis of the diaphragm and the axis of rotation. In an embodiment, a north face of the magnetic body is at or proximal to a magnetic body extremity facing substantially the same direction as a major face of the diaphragm.

In an embodiment, a coil winding of the transducing mechanism is rigidly fixed to the transducer base structure.

In an embodiment, the coil winding comprises a first primary longitudinal length located substantially adjacent to a north pole of the magnetic body and extending along a first coil axis that is substantially parallel to the axis of rotation of the diaphragm. Preferably, the coil winding comprises a second primary longitudinal length located substantially adjacent to a south pole of the magnetic body and extending along a second coil axis that is substantially parallel to the axis of rotation of the diaphragm. Preferably the first and second primary lengths of coil winding are substantially linear. Preferably the first and second primary lengths are substantially parallel. Preferably the first and second primary lengths are connected at either end.

In an embodiment, the first primary length of the coil extends adjacent to the north pole and is substantially aligned with the magnetic body along a direct south to north axis of a magnetic field generated by the magnetic body (herein referred to as: the direction of magnetism of the magnetic body).

In an embodiment, the second primary length of the coil extends adjacent to the south pole and is substantially aligned with the magnetic body along the direction of magnetism of the magnetic body.

In an embodiment, the transducer base structure comprises a first ferromagnetic body coupled proximal to the first primary length of the coil winding.

In an embodiment, the transducer base structure comprises a second ferromagnetic body coupled proximal to the second primary length of the coil winding.

In an embodiment, one or more ferromagnetic bodies coupled or integral to the transducer base structure extend over and in close proximity to the magnetic poles of the magnetic body.

In an embodiment, the one or more ferromagnetic bodies extend along a side of the magnetic connecting between the magnetic poles of the magnetic body.

In an embodiment, a spacing between the one or more ferromagnetic bodies and the side of the magnetic body connecting the magnetic poles is substantially greater than a spacing between the one or more ferromagnetic bodies and each magnetic pole of the magnetic body.

In an embodiment, one or more ferromagnetic bodies coupled or integral to the transducer base structure extend over and in close proximity to at least one, but preferably both primary lengths of the coil winding. Preferably the recess extends over one at least two sides of the first primary length, but more preferably over three sides of the first primary length.

In an embodiment, a first ferromagnetic body comprises a recess at an end of the body configured to closely accommodate a corresponding first primary length of the coil. Preferably an inner wall of the recess is spaced from the primary length of the coil. Preferably the recess extends over one at least two sides of the second primary length, but more preferably over three sides of the second primary length.

In an embodiment, an outer wall of the coil recess of the first ferromagnetic body is chamfered on a side of the outer wall facing the diaphragm.

In an embodiment, a second ferromagnetic body comprises a recess at an end of the body configured to closely accommodate a corresponding second primary length of the coil. Preferably an inner wall of the recess is spaced from the primary length of the coil.

In an embodiment, an outer wall of the coil recess of the second ferromagnetic body is chamfered on a side of the wall facing the diaphragm.

In an embodiment, a width of the spacing between the ferromagnetic bodies and the side of the magnetic body connecting the magnetic poles is substantially greater than a width of spacing between the ferromagnetic bodies and the primary length(s) of the coil at the respective recess(es).

In an embodiment, the first ferromagnetic body [e.g. A110a of FIG. 1F, region A131a] extends over and adjacent to a majority of a surface area of a first side of the first primary length [e.g. A106a of FIG. 1F] of the coil winding that is most distal from the magnetic body [e.g. A105 of FIG. 1F]. Preferably the first ferromagnetic body extends over and adjacent to substantially an entire surface area of the first side. Preferably the first ferromagnetic body opposes the surface area of the first side [e.g., pole piece region A131a of FIG. 1F].

In an embodiment, the first ferromagnetic body [e.g. A110a of FIG. 1F, region A134a or A135a] extends over and adjacent to a majority of a surface area of a second side of the first primary length [e.g. A106a of FIG. 1F] extending laterally from the first side of the first primary length. Preferably the first ferromagnetic body extends over and directly adjacent to substantially an entire surface area of the second side. Preferably the first ferromagnetic body opposes the surface area of the second side [e.g., pole piece region A135a of FIG. 1F]

In an embodiment, the first ferromagnetic body extends over and adjacent to a majority of a surface area of a third side of the first primary length extending laterally from the first side of the first primary length. Preferably the first ferromagnetic body extends over and directly adjacent to substantially an entire surface area of the third side. The third side preferably opposes the second side. Preferably the first ferromagnetic body opposes the surface area of the third side [e.g., pole piece region A137a of FIG. 1F]

In an embodiment, the first ferromagnetic body comprises a recessed end region configured to extend over and accommodate the first primary length of the coil. Preferably the recessed region extends over at least a majority of a surface area of at least one side of the first primary length, more preferably at least a majority of a surface area of two sides of the first primary length, and most preferably at least a majority of a surface area of three sides of the first primary length. Preferably the recessed area opposes the first, second and/or third sides of the first primary length [e.g., the recess formed by regions A131a, A135a, A134a and A137a around A106a of FIG. 1F).

In an embodiment, a longitudinal edge of the first ferromagnetic body most proximal to the magnetic body is substantially rounded. Preferably opposing longitudinal edges of the first ferromagnetic body most proximal to the magnetic body are substantially rounded.

In an embodiment, the first ferromagnetic body comprises a lipped edge extending laterally from an end of the first ferromagnetic body that is adjacent to the first primary length of the coil winding, the lipped edge extending in a direction that is significantly angled away from the coronal plane of the diaphragm, Preferably the lipped region is at a side of the recess most distal from the coil winding [e.g. region A134a extending beyond A137a in FIG. 1F].

In an embodiment, the first ferromagnetic body extends away from the magnetic body on an opposing side of the magnetic body to the diaphragm [e.g., pole piece regions A132a and A135a of FIG. 1F].

In an embodiment, a region of the first ferromagnetic body most distal from the magnetic body (herein: distal region) is located, relative to the magnetic body, along an axis that is substantially parallel to the radial axis of the diaphragm in the neutral position, and substantially opposes a face of the magnetic body that opposes the diaphragm. Preferably the distal region extends/connects laterally from an end or side of the ferromagnetic body along an axis that is substantially parallel to the direction of magnetism of the magnetic body [e.g., pole piece region A133a of FIG. 1F].

In an embodiment, a region of the first ferromagnetic body most distal from the magnetic body (herein: distal region), along an axis that is substantially parallel to the radial axis of the diaphragm in the neutral position, is substantially spaced from the magnetic body to avoid causing undue magnetic flux to pass directly through such parts thereby circumventing ferromagnetic parts that generate most torque, and/or to prevent undue attraction to the magnet, for example along an axis that is substantially parallel to the radial axis of the diaphragm in the neutral position.

In an embodiment, ferromagnetic surfaces of the first ferromagnetic body that are proximal to and oppose the first primary length of the coil winding are substantially symmetrical about an imaginary plane that is substantially parallel to a diaphragm axis of rotation and bisecting the magnet poles of the magnetic body (e.g., inner surfaces of abovementioned recess are symmetrical about the imaginary plane).

In an embodiment, ferromagnetic surfaces of the first ferromagnetic body that are proximal to and oppose the first primary length of the coil winding are substantially symmetrical about an imaginary plane that substantially intersects a diaphragm axis of rotation and the magnet poles of the magnetic body (e.g., inner surfaces of abovementioned recess are symmetrical about the imaginary plane).

In an embodiment, the second ferromagnetic body extends over and adjacent to a majority of a surface area of a first side of the second primary length of the coil winding that is most distal from the magnetic body. Preferably the second ferromagnetic body extends over and adjacent to substantially an entire surface area of the second side. Preferably the second ferromagnetic body opposes the surface area of the second side [e.g., pole piece region A131b of FIG. 1F].

In an embodiment, the second ferromagnetic body extends over and adjacent to a majority of a surface area of a second side of the second primary length extending laterally from the first side of the second primary length. Preferably the second ferromagnetic body extends over and directly adjacent to substantially an entire surface area of the second side. Preferably the second ferromagnetic body opposes the surface area of the second side [e.g., pole piece region A135b of FIG. 1F]

In an embodiment, the second ferromagnetic body extends over and adjacent to a majority of a surface area of a third side of the second primary length extending laterally from the first side of the second primary length. Preferably the second ferromagnetic body extends over and directly adjacent to substantially an entire surface area of the third side. The third side preferably opposes the second side. Preferably the second ferromagnetic body opposes the surface area of the third side [e.g., pole piece region A137b of FIG. 1F].

In an embodiment, the second ferromagnetic body comprises a recessed end region configured to extend over and accommodate the second primary length of the coil. Preferably the recessed region extends over at least a majority of a surface area of at least one side of the second primary length, more preferably at least a majority of a surface area of two sides of the second primary length, and most preferably at least a majority of a surface area of three sides of the second primary length. Preferably the recessed area opposes the first, second and/or third sides of the second primary length [e.g., the recess formed by regions A131b, A135b, A134b and A137b around A106b of FIG. 1F].

In an embodiment, a longitudinal edge of the second ferromagnetic body most proximal to the magnetic body is substantially rounded. Preferably opposing longitudinal edges of the second ferromagnetic body most proximal to the magnetic body are substantially rounded.

In an embodiment, the second ferromagnetic body comprises a lipped edge extending laterally from an end of the second ferromagnetic body that is adjacent to the second primary length of the coil winding, the lipped edge extending in a direction that is substantially parallel to the radial axis in a substantially neutral position of the diaphragm. Preferably the lipped region is at a side of the recess most distal from the coil winding [e.g., region A134b extending beyond A137b in FIG. 1F].

In an embodiment, the second ferromagnetic body extends away from the magnetic body on an opposing side of the magnetic body to the diaphragm [e.g., pole piece regions A132b and A135b of FIG. 1F].

In an embodiment, a region of the second ferromagnetic body most distal from the magnetic body (herein: distal region), along an axis that is substantially parallel to the radial axis of the diaphragm in the neutral position, substantially opposes a face of the magnetic body that opposes the diaphragm. Preferably the distal region extends laterally from an end or side of the ferromagnetic body along an axis that is substantially parallel to the direction of magnetism of the magnetic body [e.g., pole piece region A133b of FIG. 1F]

In an embodiment, a region of the second ferromagnetic body most distal from the magnetic body (herein: distal region), along an axis that is substantially parallel to the radial axis of the diaphragm in the neutral position, is substantially spaced from the magnetic body to avoid causing undue magnetic flux to pass directly through such parts thereby circumventing ferromagnetic parts that generate most torque, and/or to prevent undue attraction to the magnet, for example along an axis that is substantially parallel to the radial axis of the diaphragm in the neutral position.

In an embodiment, ferromagnetic surfaces of the second ferromagnetic body that are proximal to and oppose the second primary length of the coil winding are substantially symmetrical about an imaginary plane that is substantially parallel to a diaphragm axis of rotation and bisecting the magnet poles of the magnetic body (e.g., inner surfaces of abovementioned recess are symmetrical about the imaginary plane).

In an embodiment, ferromagnetic surfaces of the second ferromagnetic body that are proximal to and oppose the second primary length of the coil winding are substantially symmetrical about an imaginary plane that substantially intersects a diaphragm axis of rotation and the magnet poles of the magnetic body (e.g., inner surfaces of abovementioned recess are symmetrical about the imaginary plane).

In an embodiment, the transducer base structure comprises a cavity between a side of the magnetic body opposing the side of the diaphragm and the distal regions of the first and second ferromagnetic bodies. Preferably the cavity is free of ferromagnetic material. Preferably the cavity is an air cavity. Preferably the cavity is substantially wide along a normal axis extending between one of the distal regions of the first and second ferromagnetic bodies and the side of the magnetic body opposing the side the diaphragm [e.g., cavity A140 of FIG. 1F].

In an embodiment, the first and second ferromagnetic bodies extend toward one-another. Preferably they extend toward one another at the distal regions (e.g., at regions A132a and A132b).

In an embodiment, the distal region of the first ferromagnetic body is spaced from the distal region of the second ferromagnetic body and separated by an air gap. Preferably the air gap is substantially small to enable a magnetic field to traverse from the north pole to the south pole of the magnetic body, via the first and second ferromagnetic bodies. In alternative embodiments, the first and second ferromagnetic bodies are connected. The first and second ferromagnetic bodies may be connected at the distal regions of each body. The first and second bodies may be substantially integral.

In an embodiment, ferromagnetic material provides a substantially continuous path to traverse between the magnet north and south poles. In some embodiments the continuous ferromagnetic path may be interrupted by the primary coil windings and/or by an air gap between the driver base structure and the magnet.

In an embodiment the substantially continuous path may extend beyond one or both ends of the magnet in a direction parallel to the axis of rotation.

In an embodiment, there are ferromagnetic regions which, although they may or may not augment a magnetic field generated by the magnet, may serve to augment interaction between magnet-associated field and coil-associated field and to thereby increase an excitation effect. These regions may serve to augment the field generated by the coil.

In an embodiment, the first ferromagnetic body comprises a first arm (e.g., A132a, A131a, A135a and A134a of FIG. 1F) extending transversely from the distal region of the first ferromagnetic body toward the first primary length of the coil winding. Preferably an edge of the first arm of the first ferromagnetic body that is distal from the distal region of the first ferromagnetic body, terminates adjacent and opposing a side of the first primary length of the coil winding. Preferably the side of the first primary length is a side extending laterally from a first side of the first primary length of the coil winding? that is most distal from the magnetic body. Preferably a surface of the first arm of the first ferromagnetic body facing in a radial direction of the diaphragm extends, in a radial direction of the diaphragm, further than other parts of the distal region of the first ferromagnetic body facing in a radial direction of the diaphragm (e.g., part of A134a extending past A137a in FIG. 1F). Preferably the first arm of the first ferromagnetic body facing in a radial direction of the diaphragm extends, in a radial direction of the diaphragm, further than a majority of other parts of the distal region of the first ferromagnetic body facing in a radial direction of the diaphragm.

In an embodiment, the second ferromagnetic body comprises a first arm (e.g., A132b, A131b, A135b and A134b of FIG. 1F) extending transversely from the distal region of the second ferromagnetic body toward the second primary length of the coil winding. Preferably an edge of the first arm of the second ferromagnetic body that is distal from the distal region of the second ferromagnetic body, terminates adjacent and opposing a side of the second primary length of the coil winding. Preferably the side of the second primary length is a side extending laterally from a first side of the second primary length that is most distal from the magnetic body. Preferably a surface of the first arm of the second ferromagnetic body facing in a radial direction of the diaphragm extends, in a radial direction of the diaphragm, further than other parts of the distal region of the second ferromagnetic body facing in a radial direction of the diaphragm (e.g., part of A134a extending past A137a in FIG. 1F). Preferably the first arm of the first ferromagnetic body facing in a radial direction of the diaphragm extends, in a radial direction of the diaphragm, further than a majority of other parts of the distal region of the first ferromagnetic body facing in a radial direction of the diaphragm.

In an embodiment, ferromagnetic surfaces substantially proximal to a magnet exhibit approximate symmetry about the x-axis and/or about a plane parallel to a diaphragm axis of rotation and bisecting the magnet poles and/or about a plane bisecting the diaphragm and approximately parallel to the major faces. Preferably ferromagnetic surfaces substantially proximal to a magnet exhibit approximate symmetry about the y-axis and/or about a plane intersecting a diaphragm axis of rotation and intersecting the magnet poles.

In an embodiment, parts of ferromagnetic zones (e.g., A135a, A135b, and A137a, A137b in FIG. 1F) that are most proximal to magnet (e.g., A105) may be removed and/or saturation-prone corners may be rounded.

In an embodiment ferromagnetic material wraps around or close to one or both primary coil wind sections. Preferably the ferromagnetic material wraps around the primary coil wind(s) at a side facing the diaphragm radius direction and a side facing the opposite direction.

In an embodiment the magnetic body is rigidly attached to the diaphragm. Preferably the direction of magnetisation is substantially perpendicular to the major faces of the diaphragm. Preferably at least one primary coil wind is located proximal to each magnet pole.

In an embodiment, the magnetic body exhibits a greatest dimension along a longitudinal axis, substantially parallel to the axis of rotation.

In an embodiment, the magnetic body exhibits greater dimension in one or more directions aligned with the primary coil windings compared to in a direction perpendicular to this direction and perpendicular to an axis of rotation. Preferably a radius of the magnetic body from a diaphragm axis of rotation in one or more directions aligned with the primary coil windings is greater, on average, compared to other directions. Preferably the radius from a diaphragm axis of rotation in one or more directions aligned with the primary coil windings is greater, on average, compared to in directions facing towards the diaphragm. Preferably, a magnet radius from a diaphragm axis of rotation in one or more directions aligned with the primary coil windings is greater, on average, compared in directions facing away from a diaphragm.

In an embodiment, the magnetic body comprises a substantially convexly curved surface directly adjacent to the first primary length of the coil winding. Preferably the magnetic body comprises a substantially convexly curved surface directly adjacent to the second primary length of the coil winding.

In an embodiment, the magnetic body is substantially elongate along the direction of magnetism compared to a dimension along an axis that is substantially orthogonal to the direction of magnetism and to the axis of rotation.

In an embodiment, the magnetic body comprises a first convexly curved surface adjacent to and opposing the first primary length of the coil winding. Preferably the magnetic body comprises a second convexly curved surface adjacent to and opposing the second primary length of the coil winding.

In an embodiment, the magnetic body comprises a third convexly curved surface on a side of the magnet opposing the side of the diaphragm. In such an embodiment, the first convexly curved surface preferably comprises a substantially lower radius than the third convexly curved surface. Alternatively, or in addition, the second convexly curved surface preferably comprises a substantially lower radius than the third convexly curved surface. In an alternative embodiment, the surface on the side of the magnet opposing the side of the diaphragm may be substantially planar. In an embodiment, surfaces of the magnetic body facing coil windings are convexly curved. Preferably a centre of mass of the magnet is displaced in a direction opposite to a diaphragm radius relative to the axis of rotation. Preferably the magnetic body exhibits more mass in a region immediately proximal to the coil compared to a region located immediately adjacent, as viewed in a direction of the axis of rotation. Preferably when viewed in side profile the magnetic body profile is elongated, overall, in a direction spanning the primary coil windings. Preferably, viewed in side profile, an overall convexness of radius of a magnet surface facing primary coil windings is less compared to an overall convexness of radius of a side facing in a direction opposite to a diaphragm radius.

### Embodiments of the Diaphragm Suspension System of any of the Aforementioned Aspects

### Flexing Hinge Embodiments

In an embodiment, the diaphragm suspension system comprises a flexing hinge system having at least one hinge mount. Preferably the hinge system comprises a pair of hinge mounts on either side of a base of the diaphragm.

In an embodiment, each hinge mount comprises a first flexible hinge element and a second flexible hinge element. Preferably the first and second flexible hinge elements are angled relative to one another. Preferably the first and second flexible hinge elements are angled at at least 30 degrees relative to one another.

In an embodiment, each flexible hinge element is substantially thin. Preferably each flexible hinge element is substantially elongate.

In an embodiment, one or more flexible hinge elements comprise(s) a material exhibiting high resistance to creep deformation. This may be any one of Polyether ether ketone (PEEK) plastics material, Urethane, Nylon, or a thin-walled metals material, for example. Preferably one or more flexible hinge elements exhibit(s) a Young's modulus greater than 1 GPa, more preferably greater than 2 GPa, and most preferably greater than 8 GPa.

In an embodiment, the diaphragm suspension system comprises a restoring or biasing mechanism configured to restore or bias the diaphragm toward a neutral position.

In an embodiment, the diaphragm suspension system is configured to restore or bias an angular position of the diaphragm about the axis of rotation toward the neutral position. Preferably the restoring or biasing mechanism substantially restores or biases the angular position of the diaphragm or diaphragm angle of rotation about the axis of rotation toward the neutral position in response to unwanted or intrinsic forces imparted on the diaphragm due to magnetic interaction between ferromagnetic and magnetic bodies of the transducing mechanism. Preferably the restoring or biasing mechanism substantially restores or biases the angular position of the diaphragm toward the neutral position in response to torsional forces experienced between ferromagnetic and magnetic bodies of the transducing mechanism. The unwanted forces may be forces other than those operational forces of the transducing mechanism resulting in rotational action of the diaphragm about the axis of rotation and representing an incoming electrical excitation signal received by the transducing mechanism.

In an embodiment, the restoring or biasing mechanism comprises a torsion bar.

For instance, in the absence of diaphragm suspension torsional restoring forces, the intrinsic torsional forces arising from magnetic and/or ferromagnetic material interaction may act to move the diaphragm away from the desired equilibrium rest position. Accordingly, a restoring or biasing mechanism may assist in maintaining correct positioning of the diaphragm despite these unwanted forces resulting in improved sound quality and fidelity. Additionally, in the case of a diaphragm suspension comprising a flexing hinge system, the inclusion of a restoring or biasing mechanism may enhance the durability of the transducer by mitigating stress on the flexible hinge elements, thereby extending the device's operational lifespan.

Intrinsic torsion forces about the diaphragm's axis of rotation generated by magnetic/ferromagnetic interactions may result in at least a component of negative torsional stiffness in terms of the diaphragm's angular position. Preferably torsional restoring force from the restoring or biasing mechanism counteracts intrinsic torque forces and/or negative torsional stiffness associated with magnetic/ferromagnetic interactions.

In an embodiment the diaphragm suspension system comprises a flexing hinge system configured to facilitate rotation of the diaphragm about the axis of rotation and to substantially inhibit translational motion in directions that are substantially perpendicular to the axis of rotation, and wherein the transducer further comprises a restoring mechanism for providing a rotational restoring force that counteracts intrinsic torque forces and/or negative stiffness associated with one or more magnetic and/or ferromagnetic motor components of the transducing mechanism.

### Contact Hinge Embodiments

In an embodiment, the diaphragm is substantially rigid.

In an embodiment, the diaphragm suspension system comprises at least one contact hinge joint having at least one contact interface comprising a pair of contacting surfaces configured to move relative to one another to rotate the diaphragm about an axis of rotation. Preferably each contact interface is associated with at least one contact element distinct from the contact element(s) of other contact interface(s). A contact element may be a contact shaft, rolling element, race, or other bearing element for instance.

In an embodiment, the pair of contacting surfaces of one or more of the contact interface(s) contact at a single contact point or location. For example, an outer contact surface of a rolling or other contact element may contact a bearing contact surface at a single contact point or location. Alternatively, or in addition, the pair of contacting surfaces of one or more of the contact interface(s) contact at multiple distinct contact points or locations. For example, an outer contact surface of a rolling or other contact element may contact bearing contact surface at multiple distinct points or locations. The pair of contacting surfaces of such contact interfaces may contact at two separated locations.

In an embodiment, the diaphragm suspension system comprises at least one contact hinge joint having less than three contact interfaces. Preferably, each of the at least three contact interfaces may be associated with at least one contact element that is distinct from a contact element of the other contact interfaces.

In an embodiment, each contact surface of each contact interface of each hinge joint is substantially rigid.

In an embodiment, each connection that couples a contact surface of each hinge joint to the transducer base structure is substantially rigid, at least in translation, along an axis of a net reaction force applied to the transducer base structure at the contact interface. In an alternative embodiment, the connection may comprise a degree of compliance in translation along the axis of the net reaction force to accommodate for minor displacements. Preferably the compliant connection is substantially resistant to creep. This is to substantially minimise or mitigate deformation and change in compliance in the connection over time.

In an embodiment, each connection that couples a contact surface of each hinge joint to the diaphragm is substantially rigid, at least in translation, along an axis of a net reaction force applied to the diaphragm at the contact interface. In an alternative embodiment, the connection may comprise a degree of compliance in translation along the axis of the net reaction force to accommodate for minor displacements. Preferably the compliant connection is substantially resistant to creep. This is to substantially minimise or mitigate deformation and change in compliance in the connection over time.

In an embodiment, each compliant connection that couples a contact interface and the diaphragm or that couples a contact interface and a transducer base structure comprises a member formed from a lower-modulus material relative to the respective contact surface. Preferably each compliant connection comprises a body formed from a material having a Young's modulus less than 1.5 GPa, and more preferably less than 1 GPa.

In an embodiments each compliant connection comprises a body formed from a different material to an inner contact surface of each of the first and second contact interfaces of each hinge joint.

In an embodiment, each hinge joint comprises a contact element corresponding to each contact surface of a contact interface, and wherein a contact element corresponding to a pair of contacting surfaces of a contact interface is not rigidly connected to the diaphragm or to the transducer base structure.

In an embodiment, for each hinge joint, the contact surfaces of each contact interface are configured to roll relative to one another.

In an embodiment, the pair of contacting surfaces of each contact interface of each contact hinge joint remain in contact with one-another in-use.

In an embodiment, each hinge joint may comprise a contact element having a surface forming a common contact surface of multiple contact interfaces of the hinge joint.

In an embodiment, each hinge joint may comprise at least one pair of contact interfaces formed by a rolling element coupled between inner and outer contact surfaces. The hinge joint may comprise multiple pairs of such contact interfaces. In an embodiment, the hinge joint may comprise two pairs of such contact interfaces. The two pairs of contact interfaces may be proximal to one another along the axis of rotation. The two pairs of contact interfaces may both be located towards a common side of the diaphragm.

In an embodiment, each hinge joint further comprises limiters to substantially confine the range of motion of each rolling element to limit displacements (e.g., attributed to slippage) of the rolling element.

In an embodiment, each hinge joint comprises a first contact interface having a pair of rigid, cooperating contacting surfaces, a second contact interface having a pair of rigid, cooperating contacting surfaces, the first and second contact interfaces being positioned in close proximity to one another along the axis of rotation, and at each contact interface a respective net reaction force is applied to the diaphragm. Preferably a first net reaction force applied to the diaphragm at the first contact interface is angled relative to a second net reaction force applied to the diaphragm at the second contact interface. This may facilitate in limitation of translational motion of the diaphragm relative to the transducer base structure in use, along one or more orthogonal axes. Preferably the first and second contact interfaces comprise distinct pairs of contacting surfaces. Preferably the first and second contact interfaces each have at least one contact element distinct from the other. Preferably the first and second contact interfaces are in close proximity to another at least along the axis of rotation. Preferably a first net reaction force applied to the diaphragm at the first contact interface is angled relative to a second net reaction force applied to the diaphragm at the second contact interface including in terms of a rotation about an axis parallel to the diaphragm hinging axis.

In an embodiment, a smallest angle between the first and second net reaction forces is less than 180 degrees about the axis of rotation. Preferably the smallest angle is greater than approximately 25 degrees, more preferably greater than approximately 30 degrees. Preferably the smallest angle is less than approximately 155 degrees and more preferably less than approximately 90 degrees.

In an embodiment, the first and second net reaction forces substantially resist a biasing force applied to the contact surfaces, in-use. Preferably the biasing force is exhibited by magnetic and/or ferromagnetic bodies in the diaphragm and transducer base structure.

In an embodiment, the first and second contact interfaces serve to define limits of the translational location of a part of the diaphragm relative to the transducer base structure in all directions perpendicular to the diaphragm axis of rotation. Preferably, the first and second contact interfaces predominantly define limits of the translational location of a part of the diaphragm proximal to the transducer base structure in directions perpendicular to the axis of rotation. Preferably the first and second contact interfaces serve to substantially constrain a part of the diaphragm proximal to the transducer base structure in terms of limits of translational displacements in directions perpendicular to the axis of rotation.

In an embodiment, each hinge joint comprises a first contact interface having a first pair of contacting surfaces and a second contact interface having a second pair of contacting surfaces, and wherein an imaginary tangent line extending through the first pair of contacting surfaces is substantially angled relative to a tangent line extending through the second pair of contacting surfaces. Preferably the first and second contact interfaces comprise distinct pairs of contacting surfaces. Preferably the first and second contact interfaces each have at least one contact element distinct from the other. Preferably the first and second contact interfaces are in close proximity to another at least along the axis of rotation. Preferably a smallest angle between the imaginary tangent lines is less than approximately 180 degrees. Preferably the smallest angle is greater than approximately 25 degrees, more preferably greater than approximately 30 degrees. Preferably the smallest angle is less than approximately 155 degrees and more preferably less than approximately 90 degrees.

In an embodiment, each hinge joint comprises less than three contact interfaces. In an alternative embodiment, each hinge joint comprises more than three contact interfaces. For example, three or four contact interfaces.

In an embodiment, one or more contact interfaces may comprise common contact elements.

In an embodiment, each hinge joint comprises a first contact surface of a contact interface coupled to one of the diaphragm or the transducer base structure, and a second contact surface of a same or other contact interface coupled to the other of the transducer base structure or the diaphragm.

In an embodiment, the first contact surface may be rigidly coupled to the diaphragm or the transducer base structure. Alternatively, it may be compliantly coupled to the diaphragm or the transducer base structure. The compliant coupling is preferably substantially resistant to creep. The compliant coupling may be, alternatively or in addition, substantially flexible.

In an embodiment, the second contact surface is rigidly coupled to other of the transducer base structure or the diaphragm. Alternatively, it may be compliantly coupled to the diaphragm or the transducer base structure. The compliant coupling is preferably substantially resistant to creep. The compliant coupling may be, alternatively or in addition, substantially flexible.

In an embodiment, the first contact surface is coupled to the diaphragm and the second contact surface is coupled to the transducer base structure.

In an embodiment, the first contact surface of each hinge joint is an inner contact surface, and the second contact surface is an outer contact surface. Preferably the inner contact surface is radially inwards of the outer contact surface relative to the axis of rotation. Preferably a contact element immediately supporting the inner contact surface is located at a smaller radius, about the axis of rotation, compared to a contact element immediately supporting the outer contact surface.

In an embodiment, the first contact surface of each hinge joint is substantially rounded or annular. Preferably the first contact surface is convexly curved. In an embodiment, the second contact surface contacts against the first contact surface of each hinge joint, such that the first and second contact surfaces roll against one another. Preferably the second contact surface is substantially convex. Alternatively, the second contact surface is substantially planar.

In an alternative embodiment, the second contact surface is substantially concavely curved, and each hinge joint further comprises a rolling element retained between the first and second contact surfaces and configured to contact and roll relative to the first and second contact surfaces. The rolling element may be spherical, such as a ball. The second contact surface may comprise limiters or formations for limiting movement of the corresponding rolling element about the axis of rotation.

In an embodiment, the first contact surface of each hinge joint is located radially inwards compared to a centre of mass of the rolling element, relative to the axis of rotation.

In an embodiment, for each hinge joint, a tangent of the first contact surface at a location of contact of the hinge joint is substantially parallel with the axis of rotation of the diaphragm. Preferably the tangent is substantially coaxial with the axis of rotation of the diaphragm.

In an embodiment, for each hinge joint, an axis of a net reaction force applied to the diaphragm at the first contact interface is substantially orthogonal to the axis of rotation. In an embodiment, each hinge joint is configured to substantially constrain a part of the diaphragm proximal to the hinge joint in terms of translational displacements along an axis that is substantially perpendicular to the axis of rotation, in use.

In an embodiment, two or more hinge joints cooperatively constrain the diaphragm in terms of translational displacement along all axes that are substantially perpendicular to the axis of rotation, in use.

In an embodiment, each hinge joint is substantially compact to reside on one side of the diaphragm.

In an embodiment, the diaphragm suspension system comprises a pair of hinge joints coupled on either side of the diaphragm.

In an embodiment the diaphragm suspension system comprises two hinge joints which cooperatively constrain the diaphragm in terms of translational displacements along one or more translational axes that is(are) substantially perpendicular to the diaphragm axis of rotation, in use.

In an embodiment, the diaphragm suspension further comprises a substantially compliant biasing component configured to bias at least one pair, but preferably all pairs of contacting surfaces of each contact interface of each hinge joint toward one another to maintain engagement during operation.

In an embodiment, the diaphragm suspension system is further configured to restrain translational movement of the diaphragm along the axis of rotation. Preferably, the diaphragm suspension system comprises restoring mechanism for maintaining the axial position of the diaphragm along the axis of rotation in use. Preferably the restoring mechanism comprises a torsion bar.

In an embodiment, the audio transducer comprises a biasing mechanism comprising magnetic and/or ferromagnetic bodies and configured to bias each pair of cooperating contact surfaces of each hinge system toward one another by generating forces on the diaphragm due to magnetic interaction between the ferromagnetic and/or magnetic bodies of the biasing mechanism. Preferably the transducing mechanism comprises the ferromagnetic and/or magnetic bodies for transducing between electrical audio signals and sound pressure. The biasing forces generated by the biasing mechanism may exclude at least a component of magnetic forces generated to rotate the diaphragm about the axis of rotation. Preferably the diaphragm comprises magnetic and/or ferromagnetic material. Preferably the transducer base structure comprises magnetic and/or ferromagnetic material.

In an embodiment a magnet is fixed to the diaphragm and exhibits translational force in respect to ferromagnetic material rigidly attached to the transducer base structure. Preferably the magnet is a permanent magnet. In an embodiment, the direction of the biasing force has a significant component in a direction perpendicular to the axis of rotation of the diaphragm.

In an embodiment, each diaphragm suspension system comprises at least one hinge joint, each hinge joint comprising at least two pairs of contacting surfaces that roll against and relative to one another during operation (herein: rolling contact surface), whereby a tangent of a first pair of rolling contact surface is significantly angled relative to a tangent of a second pair of rolling contact surfaces.

In an embodiment, the angle of each tangent of the first and second rolling contact surface pairs substantially differs to an angle of primary translational biasing force exhibited by magnetic and/or ferromagnetic bodies in the diaphragm and transducer base structure when the transducer is not in use. Preferably the angle of each tangent relative to the axis of rotation significantly differs to the angle of the primary translational biasing force exhibited relative to the axis of rotation. Preferably a reaction force that may be generated at each of the rolling contacting surface in a direction tangential to the angle of the contacting surfaces, in each case, are capable of resisting the attraction force in-use.

In an embodiment, the diaphragm suspension system comprises at least one contact hinge joint having an inner contact surface attached to a first body, the first body being either the diaphragm or the transducer base structure. Preferably each contact hinge joint comprises a shaft, the shaft comprising the inner contact surface. The shaft is preferably fixed to the diaphragm. Alternatively, the shaft may be fixed to the transducer base structure. Preferably, at least one contact element of each contact hinge joint is movably mounted relative to a second body, being the other of the diaphragm or the transducer base structure. Preferably a surface of a first contact element contacts the inner contact surface thereby forming a first contact interface. Preferably the contacting surfaces of the inner contact surface and contact element are located at a smaller radius, relative to the diaphragm axis of rotation, compared to a centre of mass of the contact element.

Preferably a surface of a second contact element contacts the inner contact surface at a different angle relative to the first contact interface, forming a second contact interface. Preferably an axis extending along the first and second contact interfaces is substantially coaxial with an axis of rotation of the diaphragm. Preferably the axis of rotation is substantially coaxial with a central, longitudinal axis of the inner contact surface. Alternatively, the central longitudinal axis of the inner contact surface is non-coaxial with the axis of rotation. Preferably, a majority of translational reaction force acting in directions perpendicular to the axis of rotation is provided by or via the first and/or second contact elements, at least at the part of the diaphragm where they are located.

In an embodiment, in-use, the first and second hinge joints cooperatively restrain the diaphragm from linear displacement relative to the transducer base structure along at least one linear axis that is substantially perpendicular to the axis of rotation.

In an embodiment, in-use, the first and second contact hinge joints restrain the diaphragm from linear displacement relative to the transducer base structure along two axes substantially orthogonal to the axis of rotation. The first and second hinge joints may further restrain the diaphragm from linear displacement relative to the transducer base structure along the axis of rotation.

In an embodiment, in-use, the first and second contact hinge joints exclusively sufficiently constrain the diaphragm from linear displacement relative to the transducer base structure along two axes substantially orthogonal to the axis of rotation.

In an embodiment, in-use, the first and second contact hinge joints perfectly constrain the diaphragm from linear displacement relative to the transducer base structure along two axes substantially orthogonal to the axis of rotation.

In an embodiment a hinge joint comprises exactly two contact elements contacting a shaft.

In an embodiment, the first and/or second hinge joints may comprise a rolling element having a substantially round periphery.

The first and/or second hinge joints may comprise a rolling element having a substantially spherical periphery. The first and/or second hinge joints may each comprise a ball bearing. Preferably each ball runs in a curved outer contact surface formed in or attached to the second body. Preferably the outer contact surface is located at a larger radius, relative to the diaphragm axis of rotation, compared to a radius of a centre of mass of the corresponding rolling element.

In an embodiment, for one or both hinge joints, the curved outer contact surface contacts the corresponding rolling element in at least two separate, and more preferably also separated, locations in use. Preferably such contact is maintained substantially consistently in-use. Alternatively, or in addition, one or more rolling elements contacts a curved inner contact surface at two separate, and more preferably also separated, locations. Preferably such contact serves to constrain the rolling element in terms of displacements along the axis of rotation or along an axis that is substantially parallel to the axis of rotation.

In an embodiment, each contact hinge joint further comprises at least one compliant connection between the diaphragm and the transducer base structure that facilitates translation of the diaphragm along the axis of rotation during operation.

In an embodiment, the compliant connection(s) facilitate independent translation of each of the first and second contact interfaces of each hinge joint along the axis of rotation.

In an embodiment, the compliant connection(s) facilitate independent translation of each of the first and second contact interfaces of each hinge joint along the axis of rotation relative to the diaphragm and/or relative to the transducer base structure.

In an embodiment, the compliant connection(s) each comprise a flexible member. Alternatively, or in addition, each compliant connection comprises a member formed from a lower-modulus material relative to the pair of contacting surfaces of each of the first and second contact interfaces of each hinge joint. Preferably each compliant connection comprises a body formed from a material having a Young's modulus less than 1.5 GPa, and more preferably less than 1 GPa.

In an embodiments each compliant connection comprises a body formed from a different material to an inner contact surface of each of the first and second contact interfaces of each hinge joint.

In an embodiment each contact hinge joint comprises first and second contact elements corresponding to one or more contact interfaces, and wherein the first and second contact elements of each contact hinge joint each locate between corresponding inner and outer contact surfaces of the hinge joint. In an embodiment, each contact element contacts the corresponding inner and outer contact surface at a single location. Preferably the contacting surfaces are oriented substantially perpendicular to a radius from the axis of rotation. Preferably the inner and outer contact surfaces comprise substantially rounded contact surfaces and a radius of each rounded surface is substantially larger than a radius of each contacting surface of the corresponding contact element. Preferably the outer contact surface is substantially toroidal. Preferably the radius is sufficiently larger in order to facilitate sufficient translation of the contact element along the axis of rotation or along an axis substantially parallel to the axis of rotation. Preferably the outer contact surface is toroidal about the axis of rotation. Preferably the outer contact surface radius is sufficiently larger than a radius of the corresponding contacting surface of the corresponding contact element, as viewed in a cross-sectional plane intersecting the axis of rotation. Preferably the outer contact surface is cylindrical about the axis of rotation and the corresponding contacting surface of the corresponding contact element has a radius as viewed in a cross-sectional plane intersecting the axis of rotation. Preferably the corresponding contact element has a radius in and in a second different cross-sectional plane This may allow translational compliance in the direction of the axis of rotation and may account for manufacturing imperfections such as crooked mounting of the hinge system.

In an embodiment a subset of contact elements of each hinge joint position the diaphragm in the axis of rotation direction in-use.

In an embodiment a single element serves to locate the diaphragm in the axis of rotation direction in-use. The element may comprise a single ball that may roll in toroidal surfaces of the both inner and outer contact surfaces, contacting the inner contact surface at two (separated) points, and contacting the outer contact surface at two (separated) points which, in conjunction with a biasing force, may locate the diaphragm in the axis direction in-use. Alternatively, a torsion bar may serve to locate the diaphragm in the direction of the diaphragm axis of rotation.

In an embodiment each hinge joint comprises first and second contact elements locating between corresponding inner and outer contact surfaces of the hinge joint, and wherein the hinge joint further comprises stoppers or limiters configured to restrict the location of the contact elements to within a particular angular range, about the axis or rotation. Preferably the stoppers or limiters are configured to restrict or substantially prevent displacements (e.g., slippage) of each corresponding contact element. Preferably the stoppers or limiters are configured to restrict possible displacements of the corresponding contact elements within the hinge joint.

In an embodiment each stopper comprises a wall that may be impacted by the corresponding contact element. In an alternative embodiment each stopper comprises a reduced radius of an outer contact surface of each hinge joint, as viewed from an axis direction. Alternatively, or in addition the stopper comprises a change in profile of an inner contact surface of each hinge joint, as viewed from an axis direction.

Alternatively, or in addition the stopper comprises a change in profile of an inner contact surface of each hinge joint, as viewed in a cross-sectional plane parallel to the axis of rotation.

In an embodiment, the stopper comprises a reduced radius in the outer contact surface of the hinge joint. Preferably, the reduced radius is greater than a radius of a contact surface of the corresponding contact element, at the point of contact with the outer contact surface, as viewed in a cross-sectional plane perpendicular to the axis of rotation. Alternatively, or in addition the stopper comprises a reduced radius is greater than a radius of a contact surface of the corresponding contact element, at the point of contact with the outer contact surface, as viewed in a cross-sectional plane parallel to the axis of rotation change in profile of an inner contact surface of each hinge joint, as viewed from an axis direction.

Preferably the angular range provides sufficient diaphragm excursion without the contact elements impacting a stopper.

In an embodiment, the stopper or limiter comprises a reduced radius (about the axis of rotation), relative to a radius (about the axis of rotation) of the outer contact surface of the hinge joint at the corresponding contact interface. Preferably the reduced radius is greater than a radius (about the axis of rotation) of the other contact surface of the corresponding contact interface.

In an alternative embodiment the diaphragm suspension system comprises at least one contact hinge system having at least one substantially non-round, first contact element having a first contact surface cooperatively coupled to a second contact surface of a corresponding second contact element of the hinge. Preferably each contact hinge system comprises a pair of the first contact elements. Preferably each of the first contact elements cooperatively couples the second contact element. Preferably, each of the first contact elements comprises a contact surface radius, in a region of contact with a corresponding inner contact surface of the hinge system, that is less than half of a maximum dimension of the contact element. Preferably the maximum dimension is a length of a longitudinal region of the contact member. Preferably, each of the contact elements comprises an elongate body, spanning radially inwards toward the axis of rotation of the diaphragm. Preferably the pair of first contact elements are radially spaced.

Preferably each of the first contact elements is coupled to the second body, and moveable relative to the second body. Preferably the first contact element is moveable relative to the second body about a corresponding axis. Preferably the corresponding axis is located toward an end of the contact element that is distal from the contact surface of the contact element. Preferably the contact element is flexibly coupled to the second body in the vicinity of its axis of rotation. In some embodiments the hinge system further comprises stoppers for preventing each of the first contact elements from rotating beyond a predetermined limit relative to the second body.

In an embodiment, each hinge joint comprises contact elements corresponding to the contact surfaces of the hinge joint, and one or more connections separate to the contact elements and configured to increase compliance along one or more axes substantially perpendicular to the axis of rotation, relative to the compliance of the contact elements along the same axes. Preferably, the connection(s) comprise damping element(s) configured to predominantly maintain rigidity in the connection. The connection thereby comprises a low degree of compliance under operational loads, ensuring that the connection provides additional damping to the hinge joint, while substantially preserving the relative positioning of the hinge joint and diaphragm. A low degree of compliance may facilitate a connection or damping element that is substantially creep resistant, for instance. Preferably one or more of the dampening elements comprise a Young's modulus that is less than 1 GPa, more preferably is less than 0.5 Gpa, and most preferably is less than 0.3 Gpa.

In an embodiment each hinge joint exhibits a degree of translational compliance in one or more directions perpendicular to the axis of rotation. Preferably one or more hinge components comprises a Young's modulus 8 GPa, more preferably 2 GPa, most preferably less than 1 GPa. The degree of compliance is preferably substantially modest and/or sufficiently resistant to creep. Preferably the degree of compliance is such that the hinge joint is able to substantially rigidly define displacement of parts of the diaphragm proximal to the hinge joint in directions perpendicular to the axis of rotation.

In an embodiment one or more components connecting each hinge joint to either a first and/or second body of the audio transducer exhibits translational compliance in one or more directions perpendicular to the axis of rotation. Preferably one or more of the connecting components comprises a Young's modulus that is less than 1 GPa, more preferably is less than 0.5 Gpa, and most preferably is less than 0.3 Gpa. The first body may be the diaphragm, and the second body may be the transducer base structure.

In an embodiment each hinge joint comprises one or more hinge components that facilitate rotational motion between the diaphragm and the transducer base structure. Preferably, the audio transducer comprises magnetic materials generating translational forces between the diaphragm and the transducer base structure along at least a first linear axis at rest and comprises one or more connection components connect the hinge joint to one of the diaphragm or to the transducer base structure. Preferably the connection components are distinct from the one or more hinge components. Preferably the connection components connect between the hinge components and the diaphragm or the transducer base structure. Preferably the connection components exhibit a greater overall translational compliance, in terms of support for the diaphragm, compared to the one or more hinge components along at least a second linear axis. Preferably the connection components exhibit a comparable or modestly greater overall translational compliance, in terms of translational support for the diaphragm in the one or more directions perpendicular to the axis of rotation, compared to the combination of all parts of the hinge joint facilitating diaphragm rotation along at least a second linear axis. Preferably the connection components exhibit low creep. For example, the connection components comprise a urethane or silicon elastomer.

In an embodiment, the second linear axis is substantially perpendicular to the axis of rotation. Preferably the second linear axis is substantially perpendicular to one or more major faces of the diaphragm. Preferably the one or more hinge components are substantially rigid against translations along the second linear axis, in use. Preferably the connection components exhibit significantly higher damping of diaphragm displacements along the second linear axis compared to the hinge components.

In an embodiment, the transducing mechanism comprises magnetic elements configured to bias the diaphragm toward the transducer base structure along a first translational axis. Alternatively, the magnetic elements bias the diaphragm away from the transducer base structure along the first translational axis.

In an embodiment, the audio transducer further comprises a diaphragm stopper closely associated with the diaphragm to substantially prevent translational motion of the diaphragm beyond a limit, along a radial axis of the diaphragm, to prevent damage to the diaphragm periphery.

In an embodiment, translational compliance inherent in and/or proximal to the hinge joint is significantly higher in directions perpendicular to diaphragm major faces versus in a direction towards a terminal end of the diaphragm. Preferably translational compliance inherent in and/or proximal to the hinge joint is significantly lower in a radial direction of the diaphragm. Preferably a differential in translational compliance associated with a hinge joint is provided via geometry of a connection between a hinge element and the transducer base structure. The same technique may be applied in regard to other fairly rigid hinge systems.

In an embodiment a force transducing component fixed to the diaphragm comprises a magnet. Preferably the magnet is substantially rigidly fixed to the diaphragm. Preferably the diaphragm remains substantially rigid in-use.

In an alternative embodiment a force transducing component fixed to the diaphragm comprises a coil. Preferably the coil is substantially rigidly fixed to the diaphragm. Preferably one or more ferromagnetic elements are fixed to the diaphragm. Preferably one or more ferromagnetic elements or forms attached to the diaphragm augment a magnetic field. Preferably the magnetic field is generated by a permanent magnet rigidly fixed to the transducer base structure. Alternatively, or in addition, one or more ferromagnetic elements or forms attached to the diaphragm augment a magnetic field generated by the coil attached to the diaphragm. Preferably one or more ferromagnetic elements or forms attached to the diaphragm are proximal to a primary length of the coil. Preferably one or more ferromagnetic elements are fixed to the diaphragm proximal to each primary length of the coil. Preferably one or more ferromagnetic elements or forms attached to the diaphragm are oriented substantially parallel to an axis of the coil. Preferably the one or more ferromagnetic elements extends in a direction of the coil axis significantly beyond the extent of a proximal primary length of the coil. In an embodiment interactions between magnetic and/or ferromagnetic elements in the transducer produce a torque on the diaphragm.

In an embodiment interactions between magnetic and/or ferromagnetic elements in the diaphragm and transducer base structure produce an intrinsic torque on the diaphragm.

In an embodiment such intrinsic torque is substantially small when the diaphragm is at rest. Preferably magnetic and/or ferromagnetic elements in the transducer base structure that are in close proximity to magnetic and/or ferromagnetic elements in the diaphragm are substantially symmetrical, about a plane intersecting the axis of rotation and evenly bisecting the diaphragm. Preferably magnetic and/or ferromagnetic elements in the diaphragm that are in close proximity to magnetic and/or ferromagnetic elements in the transducer base structure are substantially symmetrical, about a plane intersecting the axis of rotation and evenly bisecting the diaphragm.

In an embodiment, diaphragm rotational displacement results in a change in torque associated with magnetic and/or ferromagnetic components. In an embodiment the intrinsic torque acts to rotate the diaphragm away from a desired equilibrium or neutral rest angle.

In an embodiment, the audio transducer further comprises a restoring mechanism configured to apply a rotational force on the diaphragm to bias the diaphragm toward a neutral rotational position in use. Preferably, the restoring mechanism is configured to counteract an intrinsic torque applied on the diaphragm and generated by magnetic and/or ferromagnetic components of the transducing mechanism. The intrinsic torque on the diaphragm is due to inherent magnetic interactions, which is present even in the absence of an electrical audio signal. This intrinsic torque may be further influenced by electrical audio signals supplied to the transducing mechanism during normal operation. The transducing mechanism is further configured to impart an operational torque on the diaphragm during operation to transduce sound. The operational torque comprises at least a component that is distinct from the intrinsic torque. The audio transducer further comprises a restoring mechanism configured to apply a rotational restoring force to counteract the intrinsic torque, thereby maintaining or returning the diaphragm to a desired equilibrium or neutral rest position.

In an embodiment the intrinsic torque may act to augment rotational displacements from a desired rest angle resulting in, in the absence of a counteracting force, an unstable equilibrium or “negative”.

In an embodiment, the audio transducer comprises a restoring mechanism configured to apply a rotational restoring force that counteracts the intrinsic torque (or negative stiffness) associated with one or more magnetic and/or ferromagnetic components of the transducing mechanism.

In an embodiment, a hinge joint and/or other components of the diaphragm suspension system may provide restoring force. Preferably the diaphragm suspension system comprises a restoring mechanism. Preferably such restoring force is provided by mechanical spring mechanism. Preferably the spring comprises a Young's modulus greater than 2 GPa, more preferably greater than 4 GPa, and most preferably greater than 8 GPa. Preferably the spring comprises a metal, such as steel or titanium for example. In an embodiment a majority of the restoring force is not associated with one or more hinge joints. Preferably a majority of the restoring force is provided by a torsion bar of the audio transducer. Alternatively, or in addition, restoring force is provided by additional magnetic and/or ferromagnetic elements that preferably do not form part of the transducing mechanism. Preferably the restoring force exceeds the intrinsic torque (or negative stiffness) associated with magnetic and/or ferromagnetic transducing mechanism components across the entire diaphragm excursion range in-use.

In an embodiment the audio transducer comprises at least one contact hinge joint having multiple contact interfaces, each having a pair of contacting surfaces, and wherein each joint comprises at least two substantially elongate contact members. Preferably, each contact member engages the respective contact interface at a different angle relative to the other contact member. Preferably, the transducing mechanism exerts magnetic forces on the diaphragm along an axis that differs to the longitudinal axes of the elongate bodies of the contact members, and wherein the audio transducer further comprises a restoring mechanism configured to provide a rotational restoring force that counteracts an intrinsic torque and/or negative stiffness associated with one or more magnetic and/or ferromagnetic components of the transducing mechanism.

In an embodiment, the restoring mechanism comprises a torsion bar. In an embodiment the diaphragm suspension system comprises a flexing hinge system configured to facilitate rotation of the diaphragm about the axis of rotation and to substantially inhibit translational motion in directions that are substantially perpendicular to the axis of rotation, and wherein the transducer further comprises a torsion bar for providing a rotational restoring force that counteracts negative stiffness associated with one or more magnetic and/or ferromagnetic motor components of the transducing mechanism.

In an alternative embodiment the intrinsic torque provided by the one or more magnetic and/or ferromagnetic motor components of the transducing mechanism acts to return the diaphragm to a desired equilibrium or neutral rest position. The audio transducer may have no additional means for providing diaphragm restoring force.

### General Hinge System Embodiment of any of the Abovementioned Aspects

In an embodiment, the diaphragm suspension system comprises a hinge system for rotatably mounting the diaphragm to the transducer base structure and enable rotation of the diaphragm about an axis of rotation, wherein the axis of rotation of the diaphragm is substantially contained in a first imaginary plane that is substantially perpendicular to a second imaginary plane of the diaphragm containing the radial axis of the diaphragm, and that contains/intersects the node axis of the diaphragm. Preferably the primary axis of rotation of the diaphragm is substantially parallel to the diaphragm node axis. Preferably the primary axis of rotation of the diaphragm and the diaphragm node axis are substantially coaxial. The node axis is a second axis of rotation about which the diaphragm would rotate relative to the transducer base structure if: the diaphragm is effectively substantially unsupported by the diaphragm suspension system, and the diaphragm is subjected to the mechanical force(s) associated with the transducing mechanism, in-use.

### Decoupling Mounting System Embodiment of any of the Aforementioned Aspects

In an embodiment the transducer base structure is substantially decoupled from a surrounding or adjacent structure of the audio transducer.

In an embodiment, the transducer base structure is compliantly mounted to a surrounding or adjacent structure of the audio transducer.

In either of the above two embodiments, the surrounding or adjacent structure may be a housing, such as an enclosure or baffle. Alternatively, it may be another audio transducer. The surrounding or adjacent structure excludes the diaphragm of the audio transducer.

### Diaphragm Structure Embodiments of any of the Aforementioned Aspects

In an embodiment, the diaphragm comprises a diaphragm body and a diaphragm base structure coupled to a base of the diaphragm body.

Preferably a substantially rigid diaphragm base structure is coupled in close proximity to and/or comprises a diaphragm-side force transferring component of the transducing mechanism.

Preferably the diaphragm body rigidly couples the diaphragm base structure via a diaphragm base reinforcing system.

Preferably the diaphragm base reinforcing system comprises at least one triangulated structure coupling the diaphragm body to the diaphragm base structure.

Preferably the base reinforcing system comprises one or more outer base reinforcing members extending between and rigidly coupled to the diaphragm body and the diaphragm base structure.

In an embodiment the diaphragm base structure comprises a magnetic body. Preferably the magnetic body is a permanent magnet.

In an embodiment the magnetic body is substantially elongate and comprises a longitudinal axis that is substantially parallel to the axis of rotation of the diaphragm.

In an embodiment the diaphragm of the audio transducer comprises:
a main diaphragm body,
a diaphragm base structure coupled to the diaphragm body, and
   a mounting mechanism for rigidly mounting the diaphragm body to the diaphragm base structure, the mounting mechanism having:
a first outer base reinforcing member extending over a first major face of the diaphragm body and coupling between the diaphragm body and the diaphragm base structure,
   a second outer base reinforcing member extending over a second major face of the diaphragm body, and coupling between the diaphragm body and the diaphragm base structure,
   the first and second base reinforcing members being spaced from one another,
   and at least one inner base reinforcing member located internally of the first and second outer base reinforcing members, the first or second outer base reinforcing member and the diaphragm base structure. Preferably the inner base reinforcing member is coupled to the diaphragm body.

Preferably, the inner base reinforcing member, the first or second outer base reinforcing member, and the diaphragm base structure collectively form a triangulated structure that mounts the diaphragm body to the diaphragm base structure.

Preferably the triangulated structure comprises a component extending along an axis that is substantially parallel to a radial axis of the diaphragm.

Preferably, a first side of the inner base reinforcing member couples to the first outer base reinforcing member away from the diaphragm base structure, and an opposing second side of the inner base reinforcing member connects to the diaphragm base structure away from the first outer base reinforcing member.

Preferably, the inner base reinforcing member is oriented at an angle that is greater than approximately 30 degrees, more preferably greater than approximately 50 degrees, and most preferably greater than approximately 70 degrees, relative to an imaginary plane that is substantially perpendicular to the axis of rotation of the diaphragm, or that is substantially perpendicular to a longitudinal axis of the diaphragm base structure, or both.

Preferably, an axis that is substantially perpendicular to the inner base reinforcing member is angled at between approximately 0 degrees and approximately 75 degrees relative to a radial axis of the diaphragm.

Preferably the diaphragm body comprises a core material connecting between at least parts of the first and the second outer base reinforcing members. Preferably the core material is a foamed material.

Preferably, the at least one inner base reinforcing member separates the diaphragm body from the diaphragm base structure. Preferably, the separated region does not comprise core material.

Preferably there is no location on the diaphragm base structure intersected by the inner base reinforcing member that is proximal to a location on the first outer base reinforcing member that is also intersected by the same inner base reinforcing member.

Preferably at least one of the inner base reinforcing member(s) comprises a substantially planar body. Alternatively, at least one of the inner base reinforcing member(s) comprises a substantially non-planar body. The inner base reinforcing member may comprise a curved or bent body, for instance.

Preferably a first inner base reinforcing member couples the first outer base reinforcing member at a first location, and a second inner base reinforcing member couples the second outer base reinforcing member at a second location, wherein the first and second locations are substantially distal from the axis of rotation, or from the longitudinal axis of the diaphragm base structure, or both.

Preferably at least one of the inner base reinforcing member(s) is substantially elongate and comprises a longitudinal axis that is substantially parallel to the axis of rotation, or to the longitudinal axis of the diaphragm base structure, or both.

Preferably, one side of the inner base reinforcing member couples over the second major face and couples between the diaphragm base structure and the second outer base reinforcing member.

Preferably at least one of the inner base reinforcing member(s) is substantially angled relative to the first outer base reinforcing member. Preferably the inner base reinforcing member intersects the first outer base reinforcing member at an angle less than approximately 60 degrees, more preferably less than approximately 50 degrees, and most preferably less than approximately 40 degrees. In an embodiment, the outer base reinforcing member and the inner base reinforcing member intersect at the diaphragm body.

Preferably the first outer base reinforcing member comprises a first outer base reinforcing plate. The base reinforcing plate is preferably substantially elongate. Preferably the first outer base reinforcing plate is substantially planar. Preferably the first outer base reinforcing plate is substantially solid. Alternatively, the first outer base reinforcing plate may comprise a network of interconnected struts.

Preferably the second outer base reinforcing member comprises a second outer base reinforcing plate. The base reinforcing plate is preferably substantially elongate. Preferably the second outer base reinforcing plate is substantially planar. Preferably the second outer base reinforcing plate is substantially solid. Alternatively, the second outer base reinforcing plate may comprise a network of interconnected struts.

Preferably each inner base reinforcing member comprises an inner base reinforcing plate. The inner base reinforcing plate is preferably substantially elongate. Preferably the inner base reinforcing plate is substantially planar. Preferably the inner base reinforcing plate is substantially solid. Alternatively, the inner base reinforcing plate may comprise a network of interconnected struts.

Preferably, each inner base reinforcing member comprises a pair of angled base reinforcing plates. Preferably the angled base reinforcing plates are connected at one end.

Preferably each inner base reinforcing plate connects to a central region of the diaphragm base structure that is oriented parallel to the axis of rotation, or to the longitudinal axis of the diaphragm base structure, or both. Preferably an opposite end of a first inner base reinforcing plate connects to the first outer base reinforcing member. Preferably an opposite end of a second inner coupling plate connects to the second outer base reinforcing member.

Preferably at least one of the inner coupling plate(s) or the inner base reinforcing member comprises a metal foil. Alternatively, at least one of the inner base reinforcing member comprises a fibre reinforced composite material. Preferably at least one outer base reinforcing member and/or inner base reinforcing member is formed from a material having a specific modulus of at least approximately 8 MPa/(Kg/m³ ), or more preferably of at least approximately 20 MPa/(Kg/m³ ).

In an embodiment the magnet is shaped to facilitate increased surface area for connection to an inner base reinforcing member. In a preferred embodiment such shaping comprises a substantially planar surface oriented at a similar angle to an associated inner base reinforcing member.

In an embodiment, the audio transducer further comprises a mounting mechanism for rigidly mounting the diaphragm body to the diaphragm base structure, comprising at least one outer base reinforcing member and at least one inner base reinforcing member, and wherein an air cavity extends parallel to the axis of rotation between the diaphragm base structure, the outer base reinforcing member and the inner base reinforcing member.

In an embodiment, the audio transducer further comprises a mounting mechanism for rigidly mounting the diaphragm body to the diaphragm base structure, comprising at least one outer base reinforcing member and at least one inner base reinforcing member, and wherein the diaphragm base structure has at least two connection surfaces, one being aligned parallel to or tangentially to and contacting the outer base reinforcing member, and one being aligned parallel to or tangentially to and contacting the inner base reinforcing member.

### Foam Cell Size

Preferably the diaphragm body comprises a foam where average cell diameter is less than 0.15 mm, more preferably is less than 0.13 mm and most preferably is less than 0.11 mm.

Preferably, a thickness of the diaphragm in at least one region is less than approximately 0.7 mm, more preferably less than approximately 0.5 mm, and most preferably less than approximately 0.3 mm. Preferably the diaphragm thickness in a region proximal to a diaphragm periphery distal from an axis of rotation of the diaphragm is more than 2.5 times greater, more preferably more than 3 times greater, and most preferably more than 4 times greater, than an average cell diameter of a core material of the diaphragm body in the same region.

In an embodiment the audio transducer further comprises a structure closely surrounding and directly adjacent an outer peripheral edge of the diaphragm and wherein the outer peripheral edge of the diaphragm is substantially free from physical connection with the surrounding structure. Preferably the outer peripheral edge comprises at least approximately 20% of an entire perimeter of the diaphragm periphery, more preferably at least approximately 50% of the entire perimeter, and most preferably at least approximately 80% of an entire perimeter. Preferably, the surrounding structure does not comprise the diaphragm base structure. Preferably a gap between the outer peripheral edge and the surrounding structure is substantially narrow. Preferably the gap is less than approximately 1 mm. Preferably the gap is an air gap. Preferably the diaphragm body comprises a foamed core material. Preferably the gap between the outer peripheral edge and the surrounding structure, in a region or side most distal from the axis of rotation, is more than 2 times greater, more preferably more than 3 times greater, and most preferably more than 4 times greater, than an average cell diameter of a core material of the diaphragm body in the same region.

### Dual Foam Densities

In an embodiment the diaphragm comprises:
a diaphragm body having a substantially rectangular cross-sectional shape that is coupled at one end or edge to the diaphragm base structure, wherein the diaphragm body comprises a varying density.

The following statements apply to the abovementioned embodiment.

Preferably a first lower-density region of the diaphragm body is located distal from the diaphragm base structure. Preferably the lower density region is distal to an axis of rotation of the diaphragm. Preferably a second higher-density region of the diaphragm body is located proximal to the diaphragm base structure, relative to the lower-density region. Preferably the second higher density region is located proximal to an axis of rotation of the diaphragm relative to the lower density region.

Preferably an inner reinforcing plate is embedded within the diaphragm body at a boundary between first and second regions of the diaphragm body. Preferably the inner reinforcing plate is substantially rigid. Preferably the inner reinforcing plate comprises a substantially high-modulus material. Preferably the inner reinforcing plate is separate to a core material of the diaphragm body. Preferably the first region is located proximal to the diaphragm base structure, and the second region is located distal from the diaphragm base structure. Preferably the first region comprises a relatively higher density than the second region. Preferably the inner reinforcing plate connects between the first and second major faces of the diaphragm body. Preferably the inner reinforcing plate connects to the first outer base reinforcing member, or to the second outer base reinforcing member, or to both. Preferably the inner reinforcing plate comprises a substantially uniform thickness.

Alternatively, the diaphragm body is devoid of inner reinforcement separate to the core material. In yet another alternative, the diaphragm body may be devoid of any inner reinforcement embedded within the diaphragm body and traversing the diaphragm body between the diaphragm base structure and an opposing end of the diaphragm distal to the diaphragm base structure.

In an embodiment, the diaphragm body comprises outer reinforcement comprising an isotropic material and coupled to at least one major face of the diaphragm body, where the orientation of a highest modulus direction is substantially parallel to an imaginary plane oriented substantially perpendicular to an axis of rotation of the diaphragm, or oriented substantially perpendicular to a longitudinal axis of the base structure, or both. Preferably the outer reinforcement is separate to the first and second outer base reinforcing members. Preferably the diaphragm is substantially devoid of isotropic outer reinforcement having an angle greater than 15 degrees, and more preferably greater than 30 degrees, relative to a direction substantially parallel to an imaginary plane oriented substantially perpendicular to an axis of rotation of the diaphragm, or oriented substantially perpendicular to a longitudinal axis of the base structure, or both, at regions of the diaphragm body which are beyond approximately 60% of a maximum radius of the diaphragm. Preferably the diaphragm is substantially devoid of isotropic outer reinforcement oriented at an angle to an imaginary plane oriented substantially perpendicular to the axis of rotation, or oriented substantially perpendicular to a longitudinal axis of the base structure, or both.

Preferably the outer reinforcement comprises a layer of isotropic material formed into struts oriented substantially parallel to: an imaginary plane that is substantially perpendicular to the axis of rotation of the diaphragm, or to a longitudinal axis of the diaphragm base structure, or both.

In an embodiment, the diaphragm comprises outer reinforcement struts oriented substantially parallel to an imaginary plane oriented substantially perpendicular to an axis of rotation of the diaphragm, or oriented substantially perpendicular to a longitudinal axis of the base structure, or both. Preferably the outer reinforcement comprises at least one anisotropic layer attached to each major face of the diaphragm body. Preferably the diaphragm is devoid of outer reinforcement oriented at an angle to an imaginary plane oriented substantially perpendicular to the axis of rotation, or oriented substantially perpendicular to a longitudinal axis of the base structure, or both, in regions of the diaphragm body which are beyond approximately 60% of a maximum radius of the diaphragm.

In another aspect, the invention may broadly be said to consist of an audio device comprising: an audio transducer as per any one of the abovementioned aspects; a housing comprising an enclosure or baffle for accommodating the audio transducer, and a decoupling mounting system compliantly mounting the audio transducer to the housing to substantially decouple the audio transducer from the housing with regards to mechanical transmission of vibration between the audio transducer and the housing.

In another aspect, the invention may broadly be said to consist of an audio device comprising: an audio transducer having a diaphragm movably coupled to a transducer base structure via a diaphragm suspension system, and a transducing mechanism operatively coupled to the diaphragm to transduce between electrical audio signals and sound pressure; an audio transducer enclosure within which the audio transducer is mounted comprising a first air cavity within the enclosure that is substantially sealed from an environment external to the enclosure, and a second air cavity that is open or fluidly connected to the environment external to the enclosure, wherein the first air cavity is substantially fluidly sealed from the second air cavity, and wherein a front face of the diaphragm faces the environment external to the enclosure, and an opposing rear face of the diaphragm faces the first air cavity.

In another aspect, the invention may broadly be said to consist of an audio device comprising: an audio transducer having a diaphragm movably coupled to a transducer base structure via a diaphragm suspension system, and a transducing mechanism operatively coupled to the diaphragm to transduce between electrical audio signals and sound pressure; an audio transducer enclosure within which the audio transducer is mounted, and a grille on a side of the enclosure separating a front face of the diaphragm from the external environment, the grille extending in close proximity along and separate from a major face or side of the base structure, and having multiple apertures or openings distributed along a plane of the grille, wherein a distribution of the apertures or openings is such that a region of the grille located directly adjacent or directly facing the base structure comprises a density of openings (surface area of openings per unit of area) that is substantially lower than a density of openings in other regions of the grille.

The audio transducer of each of the above audio device aspects, may comprise the audio transducer of any one of the aforementioned audio transducer aspects of the invention, and optionally implemented according to one or more features of any of the embodiments relating to that aspect.

The following statements relate to various embodiments or implementations applicable to any of the aforementioned audio device aspects. The features described may be implemented separately or in any suitable sub-combination with other features from the same or other embodiments.

In an embodiment, the audio transducer further comprises a base structure to which the diaphragm is moveably coupled. Preferably, the base structure comprises a magnetic structure or body for generating a magnetic field of a transducing mechanism of the audio transducer. Preferably, the base structure comprises a ferromagnetic structure or body. Preferably, the base structure comprises a permanent magnet body or structure.

In an embodiment, the diaphragm is rotatably coupled to the base structure. Preferably the diaphragm's principal motion is rotational motion.

In an embodiment, the audio device further comprises an inner dividing wall located within the enclosure, and wherein the second air cavity is bounded by the inner dividing wall and the base structure. Preferably, the audio device further comprises a fluid flow sealing element connected between the inner dividing wall and the audio transducer, more preferably between the inner dividing wall and the base structure, to fluidly seal the first air cavity from the second air cavity.

In an embodiment, the second air cavity extends along at least one side of the base structure. Preferably the second air cavity extends along at least two adjacent sides of the base structure.

In an embodiment, the second air cavity extends along a rear side of the base structure that is substantially distal from the diaphragm coupled to the base structure. Preferably the second air cavity extends along a rear side of the base structure that is most distal from the diaphragm coupled to the base structure.

In an embodiment, the base structure comprises a side or face facing the environment external to the enclosure, and the second air cavity extends along an opposing side or face of the base structure. Preferably the opposing side or face of the base structure is a major side or face of the base structure.

In an embodiment, the second air cavity is open to the external environment about a periphery of the audio transducer. Preferably the second air cavity is open to the external environment about the periphery of the base structure. Preferably the second air cavity is open to the external environment along a rear side of the base structure that is distal from the diaphragm. Preferably the second air cavity is open to the external environment along at least a first side of the base structure extending from the rear side toward the diaphragm, and more preferably also along a second opposing side of the base structure also extending from rear side toward the diaphragm. Preferably the second air cavity is open to the external environment substantially along an entire length of the first side, and optionally along an entire length of the second side.

In an embodiment the audio device further comprises a grille on a side of the enclosure separating the front face of the diaphragm from the external environment.

In an embodiment, the grille extends in close proximity along a major face or side of the base structure but is separated from the major face or side of the base structure.

In an embodiment, the grille comprises multiple apertures or openings distributed along a plane of the grille. Preferably a distribution of the apertures or openings is such that a region of the grille located directly adjacent or directly facing the base structure comprises a density of openings (surface area of openings per unit of area) that is substantially lower than a density of openings in other regions of the grille. Preferably the other regions of the grille are regions not facing the base structure.

In an embodiment, the audio device further comprises a device enclosure within which the audio transducer enclosure is coupled.

In an embodiment, the audio transducer enclosure is compliantly mounted within the audio transducer enclosure via a decoupling mounting system that substantially decouples the audio transducer from the audio device enclosure with regards to mechanical transmission of vibration between the audio transducer and the audio transducer enclosure.

In an embodiment, the audio transducer is configured to operate within a medium to high frequency range, such as above approximately 200 Hz, more preferably above approximately 1 kHz, and most preferably above approximately 2 kHz.

The first audio transducer may comprise any one, or combination of one or more, features of any of the audio transducers in the previously described aspects, or of any of the embodiments or preferred features described in relation to those aspects.

In an embodiment, the audio device further comprises a second audio transducer mounted within the enclosure.

In an embodiment, the second audio transducer is a linear action audio transducer.

In an embodiment, the second audio transducer comprise a substantially low frequency range of operation, for example below approximately 200 Hz.

The audio transducer of any of the audio device aspects may further comprise any one, or a combination of one or more, features of any of the aforementioned audio transducer aspects, or of the features of the embodiments relating to those aspects.

The audio device of any of the above aspects may further comprise any one, or combination of one or more, features of any of the other aforementioned audio device aspects, or of any of the embodiments relating to those aspects.

Unless explicitly stated, or contradictory to function, features which are described above in the context of separate aspects and embodiments of the invention may be used together and/or be interchangeable. Similarly, features described in the context of a single embodiment may also be provided separately or in any suitable sub-combination. Other aspects, embodiments, features and advantages of this invention will become apparent from the detailed description and from the accompanying drawings, which illustrate by way of example, principles of this disclosure.

### Definitions

The phrase “audio transducer” as used in this specification and claims is intended to encompass an electroacoustic transducer, such as a loudspeaker, or an acoustoelectric transducer such as a microphone. Although a passive radiator is not technically a transducer, for the purposes of this specification the term “audio transducer” is also intended to include within its definition passive radiators.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

### Number Ranges

It is intended that reference to a range of numbers disclosed herein (for example, 1 to 10) also incorporates reference to all rational or irrational numbers within that range (for example, 1, 1.1, 2, 3, 3.9, 4, 5, 6, 6.5, 7, 8, 9 and 10) and also any range of rational or irrational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

The invention consists in the foregoing and also envisages constructions of which the following gives examples only. Further aspects and advantages of the present invention will become apparent from the ensuing description.

### BRIEF DESCRIPTION OF THE DRAWINGS

Embodiments of the invention will be described by way of example only and with reference to the drawings, in which:

FIG. 1A is a perspective view of a first audio transducer embodiment in an assembled state;

FIG. 1B is an exploded perspective view of the first audio transducer embodiment;

FIG. 1C is a view of the first audio transducer embodiment from one end;

FIG. 1D is a plan view of the first audio transducer embodiment;

FIG. 1E is a side view of the first audio transducer embodiment;

FIG. 1F is a cross-sectional side view of the first audio transducer embodiment;

FIG. 2A is a plan view of a flexible hinge joint embodiment implemented in the first audio transducer embodiment and which may be implemented in any other rotational action audio transducer;

FIG. 2B is a view of the hinge joint embodiment of FIG. 2A from one side;

FIG. 2C is a perspective view of the hinge joint embodiment of FIG. 2A;

FIG. 2D is a cross-sectional side view of the hinge joint embodiment of FIG. 2A;

FIG. 2E is another perspective view of the hinge joint embodiment of FIG. 2A;

FIG. 3A is a view of an alternative contact hinge embodiment which may be implemented in any other rotational action audio transducer;

FIG. 3B is a view of the hinge joint embodiment of FIG. 3A from one side;

FIG. 3C is a first cross-section view of the hinge joint embodiment of FIG. 3A;

FIG. 3D is a detail cross-sectional view of the hinge joint embodiment of FIG. 3A;

FIG. 3E is another cross-sectional view of the hinge joint embodiment of FIG. 3A;

FIG. 3F is another detailed cross-sectional view of the hinge joint embodiment of FIG. 3A;

FIG. 3G is a perspective view of the assembled hinge joint embodiment of FIG. 3A;

FIG. 3H is an exploded perspective view of the hinge joint embodiment of FIG. 3A;

FIG. 4A is a view of an alternative second contact hinge embodiment which may be implemented in any other rotational action audio transducer;

FIG. 4B is a view of the hinge joint embodiment of FIG. 4A from one side;

FIG. 4C is a first cross-section view of the hinge joint embodiment of FIG. 4A;

FIG. 4D is a detail cross-sectional view of the hinge joint embodiment of FIG. 4A;

FIG. 4E is another cross-sectional view of the hinge joint embodiment of FIG. 4A;

FIG. 4F is another detailed cross-sectional view of the hinge joint embodiment of FIG. 4A;

FIG. 4G is a perspective view of the assembled hinge joint embodiment of FIG. 4A;

FIG. 4H is an exploded perspective view of the hinge joint embodiment of FIG. 4A;

FIG. 5A is a perspective view of a second audio transducer embodiment in an assembled state;

FIG. 5B is an exploded perspective view of the second audio transducer embodiment;

FIG. 6A-6J show various views including cross-sectional and detail views of the audio transducer embodiment of FIG. 5A implemented in a housing;

FIG. 7A shows a plan view of the audio transducer of FIG. 1A implemented in a housing of an audio device;

FIG. 7B shows a front view of the audio transducer of FIG. 1A implemented in the housing of FIG. 7A;

FIG. 7C shows a cross-sectional view of housing incorporating the audio transducer;

FIG. 7D shows an assembled perspective view of the audio transducer and housing assembly; and

FIG. 7E shows an exploded perspective view of the audio transducer and housing assembly.

### DETAILED DESCRIPTION OF EMBODIMENTS

Additional embodiments of the audio transducer are described herein with reference to the accompanying figures. These detailed implementations illustrate how various features from the previously mentioned embodiments can be integrated with one or more aspects of the disclosed invention. It is to be understood that these combinations are provided as examples and are not restrictive. Each embodiment encompasses a set of features that can be adopted independently or in conjunction with additional features from the same embodiment. For instance, features related to the diaphragm suspension system can be incorporated into an audio transducer independently from the diaphragm structure and/or transducing mechanism features described within the same embodiment. Likewise, features pertaining to the diaphragm structure and transducing mechanism can be utilized independently of other features in various audio transducer embodiments. In addition, features pertaining to a particular structure or system, such as the diaphragm structure, diaphragm suspension system, or transducing mechanism, can be utilized independently of other features of that structure or system, in various audio transducer embodiments when there is a benefit presented by such a feature or a feature combination independently of others. Moreover, features outlined across different embodiments in this document can be integrated to form new embodiments within the ambit of this disclosure. Such integrations are envisaged unless explicitly indicated otherwise or if it is apparent from the context that such integrations would be impractical or would interfere with the intended functionality of the audio transducer.

Accordingly, those skilled in the art may conceive additional embodiments based on the aspects and embodiments detailed in the summary of the invention section of this specification, without departing from the scope of this disclosure.

In each of the audio transducer embodiments herein described the audio transducer comprises a diaphragm structure that is movably coupled relative to a base (also referred to as a transducer base structure). The base may be integral with or form part of a housing, support or baffle of an audio device incorporating the transducer in some implementations. The base preferably has a relatively higher mass than the diaphragm, or a higher effective mass when rigidly connected or integrated in another structure such as a housing. Unless stated otherwise, the diaphragm is substantially rigid, and remains rigid during operation, and the base is substantially rigid and remains rigid during operation.

A transducing mechanism associated with the diaphragm structure moves the diaphragm structure in response to electrical energy, in the case of an electroacoustic transducer, or transduces movement of the diaphragm structure into electrical energy in the case of an acoustoelectric transducer. In this specification, a transducing mechanism may also be referred to as an excitation mechanism or motor. One part or side of the transducing mechanism may be coupled to the base (“base-side transducing component” or “transducer-base-structure-side transducing component”) and another side or part of the transducing mechanism may be coupled to the diaphragm structure (“diaphragm-side transducing component”).

In some embodiments, the transducer may comprise an electromagnetic transducing mechanism. An electromagnetic transducing mechanism typically comprises a magnet or magnetic structure or body configured to generate a magnetic field, and at least one conductive coil (herein referred to as “coil”) configured to locate within the magnetic field and move in response to received electrical signals (in the case of an electroacoustic transducer), or generate electrical signals in response to movement (in the case of an acoustoelectric transducer). As the electromagnetic transducing mechanism does not require physical coupling between the magnet and the coil, generally one part of the mechanism will be coupled to the base, and the other part of the mechanism will be coupled to the diaphragm structure. In some embodiments, the magnet is coupled to or forms part of the transducer base structure and the coil is coupled to or forms part of the diaphragm structure. In other embodiments, the magnet is coupled to or forms part of the diaphragm structure and the coil is coupled to or forms part of the transducer base structure. An electromagnetic transducing mechanism will typically comprise magnetic and/or ferromagnetic components coupled to the diaphragm and the transducer base structure.

In some embodiments, alternative transducing mechanisms such as piezoelectric, electrostatic, magnetostrictive or other suitable mechanisms known in the art, may be incorporated in the audio transducer embodiments described herein.

In some embodiments, the diaphragm may comprise a single diaphragm body structure. In other embodiments, the diaphragm may comprise a structure having multiple diaphragm bodies extending from a central base region. The multiple diaphragm bodies may be coupled to a common diaphragm suspension system, and/or to a common transducing mechanism, and concurrently moveable during operation.

The diaphragm is movably coupled relative to the transducer base structure via a diaphragm suspension system. Unless stated otherwise, in the embodiments described herein, the diaphragm suspension system is configured to rotatably couple the diaphragm to the transducer base structure, such that the diaphragm rotatably oscillates during operation to transduce sound. In such embodiments, the diaphragm suspension system may comprise at least one hinge joint configured to rotatably couple the diaphragm structure to the transducer base structure. In such embodiments, the audio transducer may be referred to as a “rotational-action” audio transducer. In alternative configurations, the diaphragm suspension system may be configured to couple the diaphragm to the transducer base structure, such that the diaphragm linearly oscillates relative to the transducer base structure during operation to transduce sound. In such embodiments, the audio transducer may be referred to as a “linear-action” audio transducer.

In some embodiments, the audio transducer may be accommodated with a housing or surround to form an audio transducer assembly, which may also form an audio device or part of an audio device, such as part of an earphone, headphone or loudspeaker device which may comprise a single or multiple audio transducers, for example. In some embodiments, the transducer base structure may be rigidly connected or integral with the housing or surround of an audio transducer assembly or audio device. In other embodiments the audio transducer may be mounted to the housing, surround or other adjacent structure (such as another audio transducer) via a decoupling mounting system configured to substantially decouple the audio transducer from the housing, surround or other adjacent structure on which it is mounted, to at least partially alleviate transmission of unwanted mechanical vibrations between the audio transducer and the housing, support or adjacent structure (and vice versa) during operation. Any type of mounting system that is configured to decouple the audio transducer from the housing, surround or adjacent structure to at least partially alleviate transmission of unwanted mechanical vibrations from the audio transducer to the housing (and/or vice versa) due to unwanted resonances during operation, as described in PCT/IB2016/055472 for example, may be utilised in any one of the embodiments of this invention. The decoupling mounting system preferably compliantly mounts the audio transducer to the housing, surround or other adjacent structure. The compliant mounting is configured to isolate the audio transducer (and its components including diaphragm, transducer base structure, diaphragm suspension system and transducing mechanism) from the housing, surround or adjacent structure in terms of mechanical transmission of vibration from the audio transducer to the housing, surround or adjacent structure and vice versa. Although various structures, assemblies, mechanisms, devices or systems described under these sections are described in association with some of the audio transducer embodiments of this invention, it will be appreciated that these structures, assemblies, mechanisms, devices or systems may alternatively be incorporated in any other suitable audio transducer assemblies without departing from the scope of the invention. Furthermore, the audio transducer embodiments of the invention incorporate certain combinations of one or more of various features, structures, assemblies, mechanisms, devices or systems which may be incorporated in other combinations for alternative embodiments.

Methods of construction of audio transducers, audio devices or any of the various structures, assemblies, mechanisms, devices or systems are described herein for some but not all embodiments for the sake of conciseness. The application of such methods to other embodiments are not intended to be excluded from the scope of this invention. The invention is also intended to cover methods of transducing audio signals using the principles of operation and/or audio transducer features described herein.

Embodiments or configurations of audio transducers or related structures, mechanisms, devices, assemblies or systems of the invention are described in this specification with reference to electroacoustic transducers, such as loudspeaker drivers. Unless otherwise stated, the audio transducers or related structures, mechanisms, devices, assemblies or systems herein described may otherwise be implemented as or in an acoustoelectric transducer, such as a microphone. As such, the term audio transducer as used in this specification, and unless otherwise stated, is intended to include both electroacoustic (e.g. loudspeaker) and acoustoelectric (e.g. microphone) implementations.

### 1. First Audio Transducer Embodiment

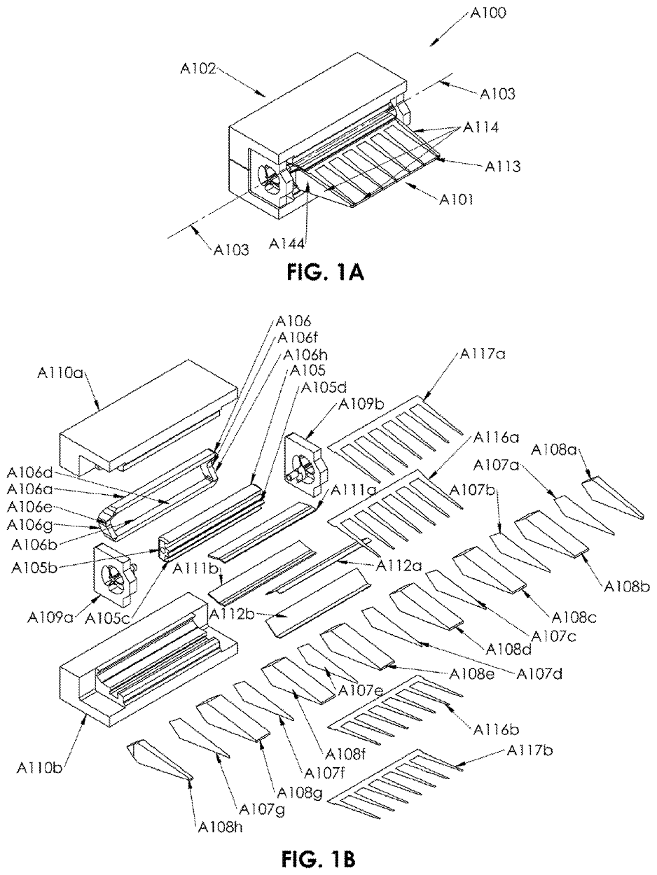

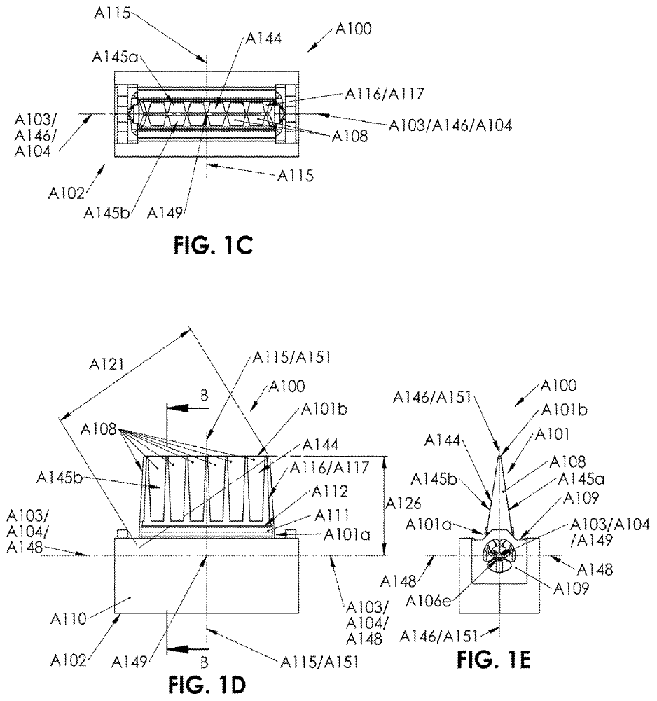

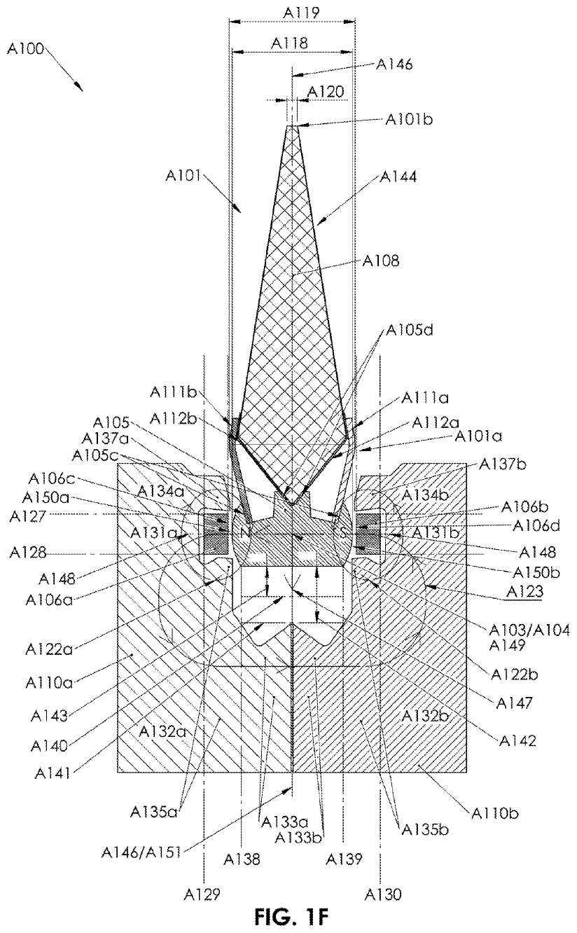

Referring to FIGS. 1A-1F, a first embodiment of a rotational action audio transducer A100 is shown comprising a diaphragm A101 that is rotatably coupled to a transducer base structure A102 via a diaphragm suspension system. The diaphragm A101 is a single body structure but may alternatively comprise a multiple diaphragm body structure in some alternative configurations. The diaphragm A101 is operatively coupled to a transducing mechanism configured to transduce electrical audio signals into rotational motion of the diaphragm A101. In this embodiment, the transducing mechanism is an electromagnetic mechanism comprising conductive coil A106, a magnet A105, and ferromagnetic pole pieces A110a-b. Unless specified, the term magnet may mean one or more permanent magnets or one or more direct current electromagnets, or any combination thereof. In this embodiment, the magnet is a permanent magnet A105. Unless specified, the term “conductive coil” or “coil” as used herein may comprise a single or multiple coil windings. In this embodiment, the conductive coil A106 is coupled to base structure A102 and the magnet A105 is coupled to the diaphragm A101. In alternative configurations this may be the other way around.

The diaphragm suspension system flexibly and rotatably mounts the diaphragm A101 relative to the transducer base structure A102. The diaphragm suspension comprises one or more flexible hinge mount(s) A109a,b that are configured to enable rotation of the diaphragm A101, via flexure of the mount, relative to the transducer base structure A102 about a primary axis of rotation A103 flexible mount(s) A109a,b are flexible in terms of rotational motion about one or more orthogonal axes and/or in terms of translational motion along one or more orthogonal axes. This results in a compliant diaphragm suspension that enables movement of the diaphragm A101 relative to the transducer base structure A012 in directions other than the primary axis of rotation A103 degree of compliance may differ depending on the direction of forces applied. It is preferred that the diaphragm suspension system is compliant in translation as well as rotation. It is preferred the diaphragm suspension system is substantially compliant in terms of translations along one or more axes that are:
substantially perpendicular to a major, radiating face A145a/A145b and/or coronal plane A146 of the diaphragm A101;
substantially parallel to a major face(s) A145a/A145b and/or coronal plane A146 of the diaphragm A101 and substantially perpendicular to the primary axis of rotation A103; and/or
substantially parallel to the primary axis of rotation A103. In this specification, the phrase “coronal plane” A146 with reference to the diaphragm A101 is intended to mean an imaginary plane bisecting the diaphragm A101 and that is substantially parallel to the axis of rotation A103 and to the radial axis A151 of the diaphragm A101.

In this embodiment, the diaphragm suspension may be compliant along any combination of one or more of the above-mentioned axes, more preferably any combination of two or more and most preferably all three. The diaphragm suspension is preferably compliant in terms of rotation about the primary axis of rotation A103, and one orthogonal axis, and more preferably two other orthogonal axes.

Note that in some embodiments translational compliance may be provided within the hinge mechanism A109a and/or A109b. In alternative embodiments translational compliance may be either provided within, or supplemented by, features outside of the hinge, such as special geometries and/or compliant connecting members between each hinge A109/or A109b and the transducer base structure A102, for example. Preferably such features or compliant connections support hinges A109a,b.

The diaphragm suspension system may also comprise stoppers or other limiters for limiting translational displacement of the diaphragm A101 relative to the transducer base structure A102 in one or more directions. It is preferred that the hinge mount(s) A109a,b provide primary compliance for rotation of the diaphragm A101 during operation. It is also preferred that the diaphragm suspension system, and/or compliant supports of the hinge mounts A109a,b, provides the primary resistances to motion/displacement of the diaphragm A101 relative to the transducer base structure A102 in the abovementioned directions in normal use (besides the abovementioned stoppers or limiters which inhibit, rather than resist further movement).

In some cases, if there are resonance modes of the diaphragm associated with translational compliance at the hinge, it is the compliance of the diaphragm suspension and/or compliant supports of the hinge mounts that primarily affects the frequency of such modes, whereas other elements such as stoppers, torsion bars and the like may not significantly affect such frequencies. In this application hinge translational compliance in directions perpendicular to a coronal plane A146 of the diaphragm is of interest in some instances, since such resonances may generate a significant amount of sound due to the fact that a large diaphragm area may move in a direction that couples air.

In this embodiment, the diaphragm suspension system comprises a pair of substantially flexible mounts A109a and A109b on either side of the diaphragm A101. The flexible mounts are preferably coupled to opposing outer sides of the diaphragm A101 along the primary axis A103 and on either side of the diaphragm's sagittal plane A115. The flexible mounts A109a and A109b are preferably formed from a substantially flexible and resilient material. In this specification, the phrase “sagittal plane” with reference to a diaphragm of a rotational action transducer is intended to mean an imaginary plane that is substantially perpendicular to the axis of rotation A103 and bisecting the diaphragm A101.

Each mount A109a, A109b is preferably formed from a substantially flexible material. Each substantially soft hinge mount A109a, A109b is preferably substantially compliant in translation such that the hinge mount may deform substantially linearly along at least one axis, preferably along at least two orthogonal axes and most preferably along three orthogonal axes. In this embodiment an elastomer or a plastics material may be used for example. In some embodiments a metal may be used, preferably in combination with geometry conducive to flexing at least in rotation. Depending on the geometry, in such an embodiment it may be particularly beneficial to employ flexible mounting of the hinge system that introduces translational compliance.

Each hinge mount A109a, A109b is preferably formed from a material that provides damping (herein referred to as “damped material” or “damped hinge mount”) in terms of translational displacement along at least one axis, more preferably along at least two orthogonal axes and most preferably along at least three orthogonal axes. In this embodiment an elastomer or a plastics material may be used for example. In an alternative embodiment compliant mounting for the compliant hinge system provides damping. Damping may help to manage resonance modes involving translation of axis-region parts of the diaphragm.

In this specification, in the context of a hinge, hinge joint, hinge mechanism, hinge system or hinge mount for an audio transducer diaphragm, the terms “soft” and “flexible” in terms of the material used is intended to mean a material or materials having an overall Young's Modulus of lower than approximately 8 Gigapascals (GPa), or less than approximately 4 Gigapascals (GPa). In the case of certain embodiments, the design approach to management of resonance involving translation of axis-region parts of the diaphragm is one of either managing such resonances within the operating bandwidth or else taking the opposite approach of shifting them down in frequency to below the operating bandwidth.

To assist with management of such resonances, each hinge mount A109a, A109b is preferably formed from a material that is sufficiently damped such that it has a material loss coefficient, at 30 degrees Celsius and 100 Hertz operating frequency that is greater than 0.005, or greater than approximately 0.01 or greater than approximately 0.02 or greater than approximately 0.05. Alternatively, or in addition, compliant features and/or attachment means for the hinges comprises a similar material loss coefficient.

In this embodiment each mount A109a, A109b may comprise a main body or bodies formed from polyether ether ketone (PEEK) plastic, which comprise a Young's modulus of between approximately 3 GPa and approximately 4 GPa, for example. In some embodiments, each mount may be formed from a TPU or CPU elastomer or a nylon plastic. Preferably each mount is primarily formed from a material having a combination of one or more of the following properties: an ability to be attached to supports such as via adhesive or over-moulding, resistance to long-term creep under loads such as gravity and/or magnetic attraction, ability to withstand sufficient deformation over sufficient cycles and temperature range in-use, and sufficient resistance to change in properties such as stiffness and damping over time or with variation in temperature. Each mount A109a, A109b preferably exhibits all abovementioned properties. Each mount A109a, A109b may be formed from a moulding process, such as injection moulding.

In some embodiments, each hinge mount A109a, A109b has a sufficiently low Young's Modulus such that a fundamental diaphragm resonance frequency is less than approximately 700 Hertz, or less than approximately 500 Hertz, or less than approximately 300 Hertz.

The diaphragm A101 is substantially rigid and remains substantially rigid during operation of the audio transducer. Examples of substantially rigid diaphragms are disclosed in WO 2017/046716, for example, and the diaphragm A101 may comprise one or more features of such diaphragm, including a substantially thick diaphragm body A144 and/or outer normal stress reinforcement A117a/b, A116a,b coupled on or adjacent the diaphragm body A101. Although other constructions for achieving a rigid diaphragm are also envisaged. Similarly, the transducer base structure A102 is substantially rigid and may comprise a relatively squat geometry. Transducer base structure arrangements having a squat geometry are described in WO 2017/046716 for example, and the transducer base structure may be implemented in accordance with such disclosure, which are hereby incorporated by reference.

The diaphragm suspension comprises a hinge system having hinge mounts A109a and A109b for enabling the diaphragm A101 to rotatably oscillate relative to the transducer base structure A102 about an axis of rotation A103. Each hinge mount A109a, A109b forms a flexible hinge joint. The location of the hinge mounts A109a and A109b is chosen, such that the axis of rotation A103 coincides with a node axis A104 of the diaphragm A101. The node axis A104 may be predetermined or may be determined during manufacture/installation of the device. The diaphragm node axis A104 is primarily dependent on the mass distribution of the diaphragm A101, and the force vector(s) experienced by the diaphragm from the transducing mechanism A106/A105/A110 during operation. As is described in detail in WO/2020/035812, the diaphragm node axis A104 is the primary axis about which the diaphragm A101 would rotate if it was effectively substantially unsupported and subject to the same operational forces as applied by the transducing mechanism A106/A105/A110.

Each hinge mount A109a, A109b, and any compliant attachment of each hinge mount, of the diaphragm suspension provides a primary hinge support to the diaphragm for rotatably coupling the diaphragm to the transducer base structure. A primary hinge support may mean a hinge that contributes significantly to rigidity of support in a direction perpendicular to the axis of rotation A103 and perpendicular to a coronal plane A146 of a diaphragm, such that if translational compliance of the diaphragm suspension is altered in this direction there is a corresponding and significant change in frequency of one or more key resonance modes involving translation of the diaphragm proximal to said hinge support.

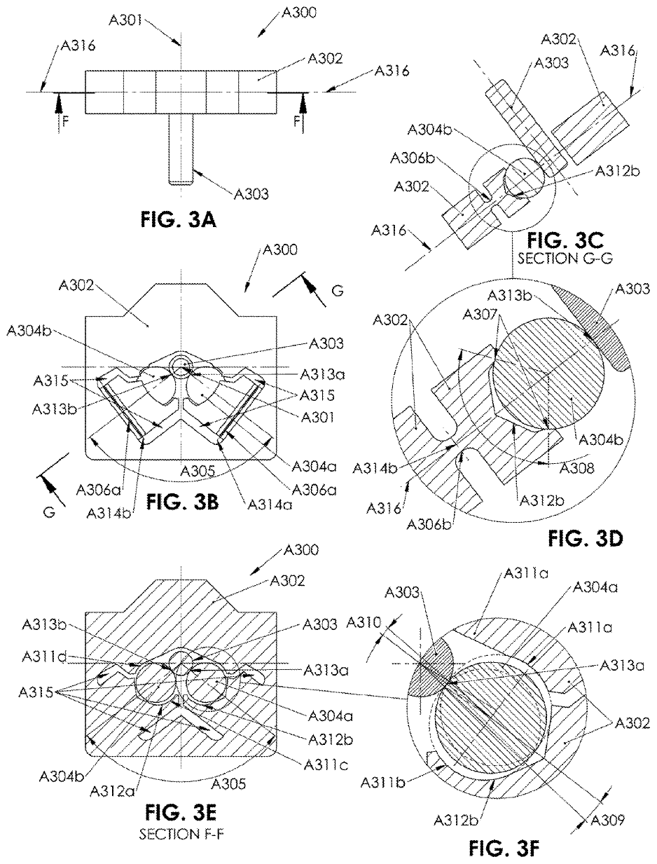

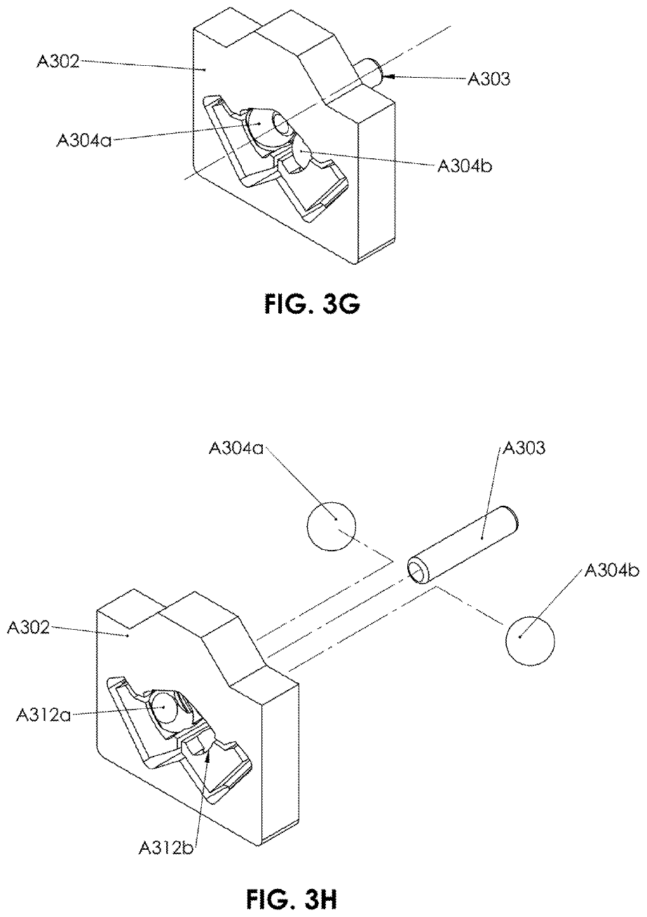

Referring to FIGS. 3A-3H, in some configurations the audio transducer A100 may be accommodated within an enclosure (not shown), such as a speaker enclosure. The audio transducer A100 may be rigidly coupled to the enclosure, or alternatively substantially decoupled from the speaker enclosure via a decoupling mounting system. The decoupling mounting system may be configured to at least partially alleviate, but preferably substantially alleviate, mechanical transmission of vibration between the audio transducer A100 and the enclosure. The decoupling mounting system may compliantly mount the audio transducer to the enclosure. Preferably the decoupling mounting system compliantly mounts the transducer base structure A102 of the audio transducer A100 to the enclosure.

Various preferred and alternative features of the audio transducer A100 and a related audio system will now be described in further detail.

### Transducer Base Structure

Referring back to FIGS. 1A-1E, the transducer base structure A102 comprises a main body, composed of body parts A110a, A110b, and a conductive coil A106 of the transducing mechanism. The conductive coil A106 is rigidly coupled to the main body A110a,b, preferably at one end of the body. The transducer base structure A102 further comprises or is coupled to a decoupling mounting system (not shown) that serves to mount the audio transducer to an enclosure or other adjacent or surrounding structure (not shown) and substantially decouple the transducer from that enclosure, surround or structure. In some embodiments the main body A110a,b may comprise cooling fins A110a to help cool the conductive coil A106 and thereby increase power handling.

The base structure A102 is relatively squat, is formed from relatively high specific modulus materials (more than approximately 30 GPa, for example), and so has internal resonance modes that are high in frequency, preferably outside listener's hearing range and/or the transducer's intended frequency range of operation.

The conductive coil A106 is rigidly coupled to the transducer base structure body and may be wound using enamel coated copper wire, in an approximate rectangular shape (for example in a clockwise direction, looking at FIG. 1C).

The coil A106 comprises recesses A106e,f for accommodating clearance to the hinge mounts A109a,b, or at least parts of the diaphragm assembly extending from/into the holes A105b in the magnet A105. Recesses A106e,f are on the inner periphery of the opposing short sides of the coil A106.

The transducer base structure of this embodiment may alternatively be replaced by the transducer base structure of any one of the other embodiments herein described.

### Diaphragm Structure

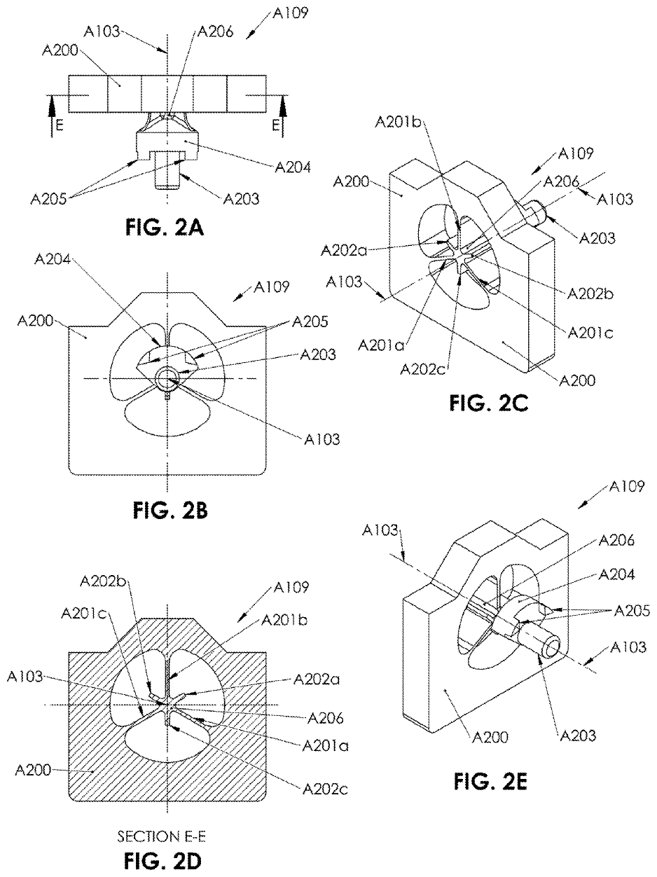

Referring to FIG. 1B, in this embodiment the diaphragm A101 comprises a structure including a main diaphragm body A144 and a magnet A105 of the transducing mechanism connected to one end of the body A144, at a base region A101a of the diaphragm A101. A pair of diaphragm mounting pins A203 (shown in FIG. 2E) of the diaphragm suspension extend laterally from either side of the magnet A105. The diaphragm is A101 a rigid diaphragm construction and comprises of: the magnet A105, the pins A203, a plurality of body parts A108a-A108h, inner reinforcement members A107a-A107g between each adjacent pair of body parts A108a-A108h, outer reinforcement A116a, A116b, A117a, A117b extending on or adjacent each major face A145a, A145b of the diaphragm body A144, outer base reinforcement members A111a, A111b, and inner base reinforcement members A112a, A112b. The diaphragm body parts A108A-h, inner reinforcement members A107a-A107G outer reinforcement members A116a, A116b, outer base reinforcement members A111a, A111b, and inner base reinforcement members A112a, A112b, are substantially rigid and formed in accordance with the rigid diaphragm construction principles described in WO 2017/046716, for example.

Preferably a bond is achieved between inner reinforcement members and A107a-A107g and outer reinforcement A116a, A116b at locations where these parts intersect proximal to the surface of diaphragm body A144.

The diaphragm body A108 may comprise an interconnected structure that varies in three-dimensions. The body A108 may comprise a substantially low density matrix, and may be formed from expanded polystyrene foam body parts A108a-A108h, for example. Alternatively body A108 may comprise polymethacrylimide (PMI) foam, for example. Preferably the diaphragm body A144 comprises relatively low density and high specific modulus.

The peripheral edges A114 of the diaphragm A101 are preferably free from connection to other parts of the transducer A100 or housing it is mounted within. Preferably there is a gap between the outer peripheral edge and the surrounding structure.

The inner reinforcement members A107a-A107g may be substantially thin. In a preferred embodiment they are formed from 0.01 mm aluminium foil, and are laminated between diaphragm body parts A108a-A108h. The outer reinforcement members A116a, A116b may comprise a plurality of struts made from carbon fibre or other suitably rigid material, most preferably of a Young's modulus of greater than approximately 300 GPa. Members A116a-b may be very thin, for example 0.03 mm thick, with a mass of 40 gsm and may be made from unidirectional fibres in pre impregnated plastic matrix, with the direction of the fibres aligned in a direction from the tip A101b of the diaphragm towards the base end of the diaphragm A101. Thin unidirectional pre-impregnated carbon fibre may suffer from defects whereby gaps between the fibres exist and this results in a lower stiffness due to forces acting on the members in directions other than the direction of the fibres. Additional outer reinforcement members A117a-b made from 0.005 mm thick aluminium foil, laminated next to members A116a-b may provide improved stiffness in these directions, and improve sound quality of the transducer. Members A116a-b are preferably of a Young's modulus of greater than approximately 20 GPa, are preferably of equal or lower mass per area than members A117a-b, and preferably are cut to shape from while attached to members A117a-b. The outer reinforcements A116a-b and A117a-b may be sandwiched onto the two outside major, radiating faces A145a, A145b of the diaphragm body A144.

In a preferred embodiment a manufacturing method comprises stamping or die cutting of outer reinforcement A116a, A116b, preferably from pre-impregnated (pre-preg) unidirectional carbon fibre composite. The composite preferably comprises a weight of less than approximately 100 gsm or more preferably less than 50 gsm. In some embodiments the pre-preg is applied to a diaphragm, with pressure, and heat is applied to set the pre-preg of outer reinforcement A116a, A116b in-situ. This procedure may reduce mass that may be associated with a separate adhesive layer to bond pre-set layer. Preferably pressure is applied via a heat-resistant compliant layer, such as silicon foam. Outer reinforcement layers A117a-b may be laminated adhered in the same procedure, using the adhesive in the carbon fibre pre preg of members A116a-b.

In a preferred embodiment inner reinforcement A107a-A107g extends beyond the extent of diaphragm body parts A108a-A108h, and may be folded onto the major faces A145a-b of the diaphragm A101. This may provide improved surface area to facilitate improved attachment to outer reinforcement A116a, A116b.

In another preferred embodiment a method of manufacturing the diaphragm may comprise forming foam body parts A108a-A108h, forming inner reinforcement members A107a-A107g larger than the corresponding mating faces of body parts A108a-A108h, and attaching all parts in a manner where the parts of each of A107a-g extend beyond the mating faces of the corresponding body parts A108a-A108h.

In yet another alternative preferred embodiment of the invention, a method of manufacturing the diaphragm A101 may comprise:
forming a multilayer laminate comprising alternating sheets of diaphragm body core material A108 and inner reinforcement core material A107;
cutting the laminate to form a wedge-shaped diaphragm comprising body parts A108a-h and inner reinforcement parts A107a-g, via a first process that forms or retains one or more regions of inner reinforcement A107 extending beyond the diaphragm body material;
cutting or forming peripheral regions of major faces of the diaphragm A101 via second process in a manner that avoids creation of excess and/or loosely attached diaphragm body material A108.

Such a manufacturing method may provide surface area to facilitate improved attachment to outer reinforcement members A116a, A116b.

Preferably the first process comprises a cutter that does not move strictly in the plane of the major face A145 of a diaphragm body A144 wedge. For example, a cutting disc that comprises a wobble out of the overall plane of the (spinning) disc may serve this purpose. A cutter may comprise a diamond-coated tool, or a saw-tooth tool, for example. In some embodiments a melting process may form a surface of diaphragm body parts A108 at a level below that of inner reinforcement A107.

Preferably the second process comprises a cutter that moves more accurately in the plane of the major face A145 being cut. This may reduce formation of loose material in the diaphragm periphery region proximal to the narrow air gap between diaphragm and a surround component. Preferably a blade-based cutter is used. Alternatively, one or more cutting teeth may be used. Preferably a cutting region of a tool or blade that may potentially cut or impinge on the diaphragm is substantially compact. In some embodiments a reciprocating cutter is used. In an alternative embodiment a rotational cutter is used where cutting occurs only within a sub-portion of a circumference. For example, in some embodiments a rotating blade cutter features a blade portion that protrudes at a single point of the circumference, so that this portion of the disc creates substantially all cutting of a face. Preferably the blade edge is formed by an angled cut on a single face of the disc, resulting in a cutting edge that is located substantially in the same plane as a face of the disc. More preferably still, a slight bend in the disc proximal to the blade means that the blade edge actually protrudes beyond said face of the disc. This design ensures that, once a cut is made by the blade, trailing parts of the disc will not contact the already-cut surface risking damage. Preferably the disc also features teeth, slightly recessed compared to the blade edge, including in terms of radius, so that the risk of a disc wobble or unbalancing event causing damage to a face post-initial-blade-cut is minimised. The teeth may serve to remove material to a thickness that may allow a blade to translate without being subjected to undue transverse deflection, as might otherwise be the case based on a cut made by an asymmetrical blade.

### Foam Cell Size

In a preferred embodiment a foamed material, comprising a relatively fine cell foam, is used for the core material of diaphragm body parts A108a-h. A fine cell foam may facilitate forming the diaphragm with more accurate edges in the diaphragm periphery region and/or manufacturing of such accurate edges, as well as facilitate forming sufficiently narrow gaps between the diaphragm's periphery and a surrounding structure for better air sealing. A suitable foam may include ROHACELL® HF, which is primarily marketed for use in applications where requirements include minimal blocking of high frequency antennas. Preferably the average cell diameter is less than 0.15 mm, more preferably is less than 0.13 mm and most preferably is less than 0.11 mm. Preferably the diaphragm body comprises a low density despite the fineness of cell structure.

In a preferred embodiment the audio transducer comprises an enclosure, baffle or other structure (not shown in the figures) that closely surrounds and is directly adjacent the outer periphery of the diaphragm A101, including the edge of the diaphragm most distal from the axis of rotation, and the sides of the diaphragm extending from the edge towards the base region of the diaphragm and the axis of rotation. A relatively narrow gap is formed between the diaphragm periphery and the surrounding structure. For instance, a width of the gap defined by the distance between the outer periphery of the diaphragm and the surrounding structure may be less than approximately 1/10th or less than approximately 1/20th or less than approximately 1/40th of a radial length of the diaphragm. In some implementations, the width may be less than approximately 1 mm, or less than approximately 0.8 mm, or less than approximately 0.5 mm.

The periphery of the diaphragm that is separated from the surrounding structure by a narrow gap is preferably not physically connected to the surrounding structure. Such peripheral regions may constitute approximately at least 20%, more preferably at least 50% and most preferably at least 80% of a perimeter of the diaphragm A101.

Preferably, all regions of the outer periphery of the diaphragm that move a significant distance (relative to other regions) during normal operation may be approximately entirely free from physical connection with the interior of the surrounding structure. All regions of the outer periphery of the diaphragm that are distal from a centre of mass A149 location of the diaphragm may be approximately entirely free from physical connection with the interior of the surrounding structure.

The surrounding structure may fit substantially tightly, but physically separated, around the periphery of the diaphragm throughout substantially an entire range of motion of the diaphragm during operation, such that the surrounding structure is effectively sealed.

Fine cell structure in diaphragm body parts A108 may also contribute to improved diaphragm body A144 rigidity in regions where diaphragm thickness reduces towards a dimension of a cell diameter. This may occur because if, for example, a diaphragm thickness comprises less than double a cell diameter then there may be cases where forming of the diaphragm's major faces opens up/removes a face of proximal cells on both sides of the diaphragm, which may leave potentially limited effective thickness that is capable of resisting deformation.

In a preferred embodiment diaphragm thickness at some point is less than 0.7 mm, more preferably is less than 0.5 mm, and most preferably is less than 0.3 mm. Preferably the diaphragm thickness in a location proximal to a diaphragm periphery distal from the axis of rotation A103 is more than 2.5 times greater than an average cell diameter of the diaphragm body parts A108 in the same region. More preferably the diaphragm thickness is more than 3 times greater than an average cell diameter of the diaphragm body parts A108 in the same region. More preferably the diaphragm thickness is more than 4 times greater than an average cell diameter of the diaphragm body parts A108 in the same region.

The diaphragm body A144 comprises a maximum thickness that is greater than 12%, or more preferably greater than 15% of a maximum diaphragm radius A126 about the axis of rotation A103 of the diaphragm body A144. The diaphragm body A144 may comprise a maximum thickness that is greater than 20% of a maximum diaphragm radius A126 about the axis of rotation A103, in some embodiments. The diaphragm radius or radial length means the length from the axis of rotation to the most distal edge/tip A101b of the diaphragm. The diaphragm body A144 may alternatively or additional comprise a maximum thickness that is greater than 9% or greater than 11% of a greatest dimension, such as a maximum diagonal length A121, of the diaphragm body A144. The diaphragm body may comprise a maximum thickness that is greater than 13% of a maximum dimension, such as a diagonal length A121, of the diaphragm body A144 in some embodiments.

The diaphragm A101 comprises a varying mass along a length of the diaphragm A101. The diaphragm A101 comprises a relatively lower mass, per unit area, in regions of the diaphragm that are distal from a centre of mass A149 of the diaphragm A101 relative to regions that are proximal to the centre of mass A149. In this embodiment, the diaphragm A101 also comprises a lower mass, per unit area, in regions of the diaphragm that are distal from an axis of rotation A103 of the diaphragm relative to regions that are proximal to the axis of rotation A103. The diaphragm also comprises a relatively lower mass, per unit area, in regions proximal to one end of the diaphragm relative to regions proximal to an opposing end.

In this embodiment, the diaphragm body A144 consists of a profile of varying thickness along the length of the diaphragm. As shown in FIG. 1E, the diaphragm body A144 consists of a relatively greater thickness in a first region at or near the base region, relative to a thickness at a second region distal from the base region. The thickness at the second region is preferably substantially tapered such that it reduces away from the base region. The overall major face profiles may be linear and/or substantially curved. In this embodiment the profiles are substantially curved. The major face profile is generally convex, along the length of the face. In other words, the major face profile is generally convex along the sagittal plane A115 cross-section of the diaphragm body A144.

### Inner Reinforcing Plates Forming Triangulations

As shown in FIG. 1E, diaphragm A101 comprises outer base reinforcement member A111a connecting between outer reinforcement A116a, A117a and outer parts of magnet A105 at the same major face A145a as outer reinforcement A116a, and outer base reinforcement member A111b connecting between outer reinforcement A116b, A117b, and outer parts of magnet A105 at the same major face A145b as outer reinforcement A116a. Additionally, inner base reinforcement members A112a, A112b connect between outer base reinforcements A111a, A111b, and magnet A105 forming a triangulated structure extending from magnet A105 towards a diaphragm periphery region. The triangulations serve to reduce shear deformation of the overall diaphragm structure that might otherwise result, for example, associated with bending deformation of outer base reinforcing members A111a, A111b.

In an alternative embodiment one or more triangulated structures are formed by a single inner reinforcing member. Further alternatively more than two inner reinforcing members may be employed.

The outer base reinforcing members A111a, A111b are preferably formed as plates, and referred to as plates herein, but it will be appreciated that members of other geometries may be substituted to achieve the same function of reinforcing the base via triangulation. The inner base reinforcing members A112a, A112b are preferably formed as plates and referred to as plates herein, but it will be appreciated that members of other geometries may be substituted to achieve the same function of reinforcing the base via triangulation.

In a preferred embodiment outer base reinforcing plates A111a, A111b, comprise carbon fibre, or a metal foil, or a Metal Matrix Composite (MMC) comprising aluminium and silicon carbide, for example. Preferably outer base reinforcing plates A111a, A111b are substantially planar. Alternatively, they may comprise a curved form, as is the case with components A111a, b. However, it is preferable that any such curve is not so great that the component's rigidity is compromised, for example via buckling deformation.

In a preferred embodiment inner base reinforcing plates A112a, A112b, comprise carbon fibre, or a metal foil, or a Metal Matrix Composite (MMC), for example. Preferably at least one inner base reinforcing plate A112a, A112b is substantially planar. Alternatively, at least one inner reinforcing plate may comprise a curved form. Preferably at least one inner reinforcing plate A112a, A112b, comprises a bend toward a termination that may serve to increase surface area at a point of attachment. Preferably such a bend facilitates strong and/or rigid connection to an outer reinforcing plate A111a, A111b and/or to outer reinforcement A116a, A116b.

Preferably at least one outer and/or inner base reinforcement plate is formed from a material having a specific modulus of at least approximately 8 MPa/(Kg/m³ ), or more preferably of at least 20 MPa/(Kg/m³ ).

Preferably a diaphragm base structure, comprising the magnet A105, is coupled in close proximity to and/or comprises a diaphragm-side force transferring component (magnet A105), and forms a substantially rigid base located proximal to an axis A103 region. Its proximity to the axis means that it can be heavy, which may assist with rigidity, without creating undue rotational inertia. The diaphragm base structure is formed from a substantially rigid material and is substantially elongate. One end of the base structure may be rigidly coupled to one of the outer base reinforcement plates A111a, A111b.

In an alternative embodiment the diaphragm-side force transferring component may comprise a coil, and the diaphragm base structure, which may comprise one or more plates, to stiffen and/or support the coil.

In a preferred embodiment the geometry of triangulation created by the inner reinforcing plate A112a-b projects stiffness towards a diaphragm region that is furthest from the axis A103. Preferably this is achieved across a substantial, or more preferably across the entire, width of the diaphragm A101 in an axis A103 direction. To this end, in preferred embodiment at least one inner reinforcing plate A112 connects to a first outer reinforcing plate A111 at one or more locations that do not intersect the magnet/diaphragm base frame A105, and an opposed side of the inner reinforcing plate A112 connects to the base frame at one or more locations that do not intersect the first outer reinforcing plate A111. Alternatively, or in addition, the inner reinforcing plate A112 forms a triangulation comprising the first outer reinforcing plate A111 and the magnet/diaphragm base frame A105. Preferably the triangulation has a component extending in a diaphragm radius direction. Alternatively, or in addition, the inner reinforcing plate is oriented at an angle that is greater than 30 degrees, more preferably is greater than 50 degrees and most preferably is greater than 70 degrees relative to a plane that is perpendicular to the axis of rotation A103. Alternatively, or in addition, a direction perpendicular to the inner reinforcing plate makes an angle of between 0 degrees (could be −75 degrees) and 75 degrees with a diaphragm radius direction.

### Use of Different Foam Densities (Instead of Inner Reinforcing Plates)

In a further alternative embodiment, or in addition, instead of inner reinforcing plates A112a, A112b, a region of diaphragm body A144 proximal to the diaphragm base frame (in this case magnet A105) comprises a higher density foam. Preferably the higher density foam substantially fills a region bounded by outer reinforcing plates A111a, A111b. In some embodiments the higher-density-foam region comprises density greater than 30 kg/m\hat{ }3, or more preferably comprises a density greater than 45 kg/m\hat{ }3, or most preferably comprises a density greater than 50 kg/m\hat{ }3. Preferably a lower-density foam region of the diaphragm body A144 is located towards a region distal from the axis of rotation A103. Preferably the lower-density-foam region comprises a density substantially lower compared to the density of the higher-density foam, preferably less than 60%, and more preferably less than 40% of a higher density foam. Preferably the denser foam is also stiffer, preferably at least proportionally stiffer. Preferably the boundary between higher density and lower density regions is between approximately 20% and 50% of a distance A126 from an axis A103 to a most-distal-from axis diaphragm periphery. More preferably the boundary between higher density and lower density regions is between approximately 25 and 40% of a distance A126 from an axis A103 to a most-distal-from axis diaphragm periphery. Preferably the boundary is substantially parallel to a most distal-from-axis periphery face of the diaphragm.

Preferably a high-modulus “inner boundary reinforcement plate” A112 is attached at a boundary between a first and second region of diaphragm body A144. Preferably the first region is located proximal to an axis A103 region, and the second region is located distal from an axis region. Preferably the first region is a higher-density region of diaphragm body A144 and the second region is a lower-density region of diaphragm body A144. Preferably the inner reinforcement plate A112 connects between the two major faces A145. Preferably the inner reinforcement connects to outer reinforcement A116 and/or to outer reinforcement plate A111a at one or preferably both major faces.

The inner boundary reinforcement plate A112 may provide advantages including: 1) facilitate rigid connection between the first and second region within diaphragm body A144 by virtue of the fact that, as a substantially continuous surface at least over certain sub regions, it may interface more rigidly with first and second regions which may comprise a cross-section of open cell walls which may not be easy to rigidly attach to a second such surface comprised of open cells; 2) act as the centre of an “I” beam construction, with outer reinforcement A116a, A116b and/or outer reinforcement plates A111a, A111b forming the outer plates of the “I.” This construction may resist certain important diaphragm bending resonance modes (for example a mode that may superficially resemble a “stingray” swimming); 3) In conjunction with a diaphragm base structure, e.g. magnet A105, and outer reinforcement A116a, A116b, A117a, A117b and/or outer reinforcement plates A111a, A111b on both major faces A145, may form a hollow beam oriented substantially parallel to the axis A103. Such a beam may help to resist torsional deformation, for example in an axis A103 direction, or parallel to a diaphragm radius A126 direction.

Inner reinforcing plates A112a, A112b, preferably forming triangulations, and/or a denser, stiffer diaphragm body region proximal to the axis A103, and/or an inner boundary reinforcement plate, may help to improve rigidity in a region of the diaphragm proximal to the axis of rotation A103. Rigidity associated with a diaphragm base structure may be projected to a greater radius, for example to a region bounded by the above-described components.

### No Inner Reinforcing

Such diaphragm features may facilitate a reduction in complexity in other diaphragm regions. For example, a reasonably high level of resonance performance may be achieved with inner reinforcement A107a-A107g that has uniform thickness, thereby simplifying various manufacturing processes. In an alternative embodiment inner reinforcement members A107A-A107g may be omitted. Preferably diaphragm body parts A108a-A108h of the diaphragm body A144 comprises a foam comprising a high specific modulus. In this case, depending on the application, density of diaphragm body parts A108 may be somewhat less critical due to mass saving achieved through omission of inner reinforcement members A107a-A107g, for example preferably a diaphragm body density in a region distal from the axis A103 is less than 50 kg/m\hat{ }3, or more preferably is less than 35 kg/m\hat{ }3. Preferably a PMI foam is used, or another foam comprising a high specific modulus.

### Diaphragm Features in the Axis Region may Facilitate Simpler Outer Reinforcing at Tip Region

In some preferred embodiments outer reinforcement A116a, A116b may comprise anisotropic material oriented in a single direction, for example, such as oriented parallel to a plane perpendicular to the axis A103. Likewise, struts may only be required in a single direction. Previous art, where the diaphragm base region is less rigid, have been more complicated and/or heavy, for example some have included diagonal elements, based on three or more different anisotropic layers oriented in three or more different directions, in order to effectively resist various diaphragm resonance modes.

Simplified outer reinforcement A116a, A116b may help to reduce rotational inertia, particularly if unnecessary diagonal reinforcement is omitted from regions distal from the axis A103, such as beyond a radius of 60% of a maximum radius of the diaphragm, for example. Preferably outer reinforcement A116a, A116b comprises anisotropic material attached to at least one major face of the diaphragm body, where the orientation of a highest modulus direction is substantially parallel to a plane oriented perpendicular to an axis of rotation A103. Preferably there is no anisotropic layer oriented in a substantially different direction. Preferably an anisotropic layer is formed into struts A116 oriented substantially parallel to a plane oriented perpendicular to an axis of rotation A103.

Preferably outer reinforcement A116a, A116b comprises struts oriented substantially parallel to a plane oriented perpendicular to an axis of rotation A103. Preferably outer reinforcement comprises at least one anisotropic layer attached to each major face of the diaphragm body.

Preferably there are no struts oriented in a substantially different direction beyond a radius of 60% of a maximum radius of the diaphragm.

In this embodiment, the normal stress reinforcement A116a, A116b comprises a relatively lower mass, per unit area, in regions of the diaphragm that are distal from a centre of mass A149 of the diaphragm A101 relative to regions that are proximal to the centre of mass A149. In some embodiments, a region of relatively lower normal stress reinforcement mass may comprise recesses or may be devoid of normal stress reinforcement. In this embodiments, regions of relatively lower normal stress reinforcement mass comprise normal stress reinforcement of reduced or reducing thickness, or reduced or reducing width, or both.

In some embodiments, a region of relatively lower normal stress reinforcement mass and/or lower diaphragm mass may be located within approximately 20% of a radial length A126 of the diaphragm from an end of the diaphragm that is distal to the centre of mass or that is distal to the axis of rotation A103, in the case of a rotating diaphragm.

In this embodiment, the diaphragm A101 is substantially symmetrical about a sagittal plane A115 of the diaphragm. The diaphragm structure, including the diaphragm body A144 and the magnet A105 of the transducing mechanism, is substantially symmetrical about the sagittal plane A115 of the diaphragm A101.

### Transducing Mechanism

The transducing mechanism A106/A105/A110 in this embodiment comprises an electromagnetic mechanism including a coil that is operatively coupled to a magnet. It is preferred that the transducing mechanism is substantially non-commutated.

In each one of the embodiments herein described, the transducing mechanism A106/A105/A110 generally comprises a diaphragm-side transducing component. In this case it is magnet A105. In this specification, the phrase “diaphragm-side transducing component” is intended to mean a part of the transducing mechanism that is coupled to a diaphragm A101 that is responsible for converting between electrical and mechanical energy, or vice versa. For example, this may be the coil or the magnet of an electromagnetic mechanism, or it may be a part, section or component of a piezoelectric mechanism.

The transducing mechanism A106/A105/A110 generally also comprises one or more base-structure-side transducing components. In this case they are the coil A106 and ferromagnetic pole pieces A110a-b. In this specification, the phrase “base-structure-side transducing component/s” is intended to mean a part (or parts) of the transducing mechanism that is coupled to a transducer base structure A102 that is configured to remain substantially stationary relative to the diaphragm during operation. For example, this may be a stationary coil or magnet of an electromagnetic mechanism, or it may be a stationary part, section or component of a piezoelectric mechanism.

In this embodiment, the diaphragm-side transducing component A105 is directly coupled to the diaphragm A101, and is preferably rigidly coupled to the diaphragm A101. The magnet A105 is integrated into the diaphragm A101 such that it is one structure. The magnet A105 comprises a surface A105c configured to couple a corresponding surface of the outer reinforcement plates A111a-b and a surface A105d configured to couple a corresponding surface of the inner reinforcement plates A112a-b. The coupling surfaces are complementary. The coupling surfaces are substantially planar however, other profiles are possible. The coupling is preferably made via an adhesive such as epoxy, and the area of adhesion should be preferably significantly large to withstand the forces acting on the coupling. The adhesive should preferably be significantly thin to help provide rigidity of the coupling.

In some embodiments, the diaphragm-side transducing component A105 may be indirectly coupled to the diaphragm via one or more intermediary components. The one or more intermediary components are preferably substantially rigid, and may comprise a Young's Modulus of at least approximately 8 GPa, or at least approximately 20 GPa, for example. In some embodiments, the diaphragm may be rigidly coupled to the transducing mechanism via one or more substantially planar parts or components. In the case where the diaphragm is coupled to the diaphragm-side transducing component via one or more intermediary components, in some embodiments the components may be sufficiently straight and/or well-supported and/or sufficiently thick such that bending deformation of the rigid component or components is minimal.

Referring to FIG. 1F, the magnet A105 is magnetised in a direction perpendicular to the coronal plane A146 of the diaphragm A101. The magnetic poles of the magnet are located on opposing sides of the axis of rotation A103 to achieve this. In some embodiments, the magnet poles may be arranged such that the primary internal magnetic field is angled relative to the axis of rotation A103 and/or angled relative to the coronal plane A146. The magnet comprises a substantially non-alternating magnetic field. The magnet is preferably a permanent magnet, such as a N52 grade Neodymium (NdFeB) magnet, or another strong permanent magnet type. Alternatively, the magnet may be an electromagnet. The electromagnet is preferably a direct current electromagnet. It is preferred that the magnet is not an armature.

The magnet A105 is located at or proximal to the axis of rotation A103 of the diaphragm A101. The magnet A105 is located at or proximal to either side of the axis of rotation A103 of the diaphragm, with respect to a sagittal plane A115 of the diaphragm A101. The magnet A105 couples along an axis that is substantially parallel to the axis of rotation A103 or the centre of mass axis A149. The magnet A105 extends along the axis of rotation A103 and in this embodiment, the axis of rotation A103 extends through the magnet A105. In some variations, the magnet A105 may be located proximal to the axis of rotation but is substantially exclusively proximal to the axis of rotation A103 such that no other part or component of the diaphragm-side transducing mechanism is non-proximal to the axis.

The magnet A105 does not extend beyond a maximum width of the diaphragm A101 or diaphragm body A144. In some embodiments, the magnet A105 may extend beyond the width but preferably by more than approximately 20%, or more than approximately 15%, or most preferably more than approximately 10% of the width dimension along the axis of rotation A103. The maximum width dimension in this case may be substantially parallel to the axis of rotation A103.

The magnet A105 is configured to cooperate with the coil A106 rigidly coupled to the transducer base structure A102 to exert or transfer a mechanical torque on or from the diaphragm A101. The coil A106 may comprise a single winding that extends about the periphery of the magnet A105. In use, an audio signal (from an amplifier) may be applied to the conductive coil, which consequently applies a positive and negative torque on the magnet, rotating the diaphragm about an axis of rotation A103. Preferably the conductive coil A106 extends substantially parallel to the axis of rotation A103 and along either side of the axis of rotation A103. Preferably the conductive coil A106 extends within a plane that is substantially transverse relative to a radial axis A151 of the diaphragm A101.

In some embodiments the coil A106 comprises two primary lengths of coil windings A106a-b that are oriented parallel to axis A103. In some embodiments one primary winding A106a is located proximal to a north pole of magnet A105, and another primary winding A106b is located proximal to a south pole of magnet A105. Preferably two non-primary sections A106g,h each connect at either end of the two primary lengths of coil windings A106a and A106b thereby forming a loop. Preferably the coil loop substantially surrounds magnet A105.

The magnet A105 and the inside surfaces A106c, d of coil A106 are separated by two fluids gap A150a,b. The fluids gaps are air gaps in this embodiment. Alternatively, ferromagnetic fluids or materials may be located between the coil and the magnet. The magnet may comprise a substantially curved surface adjacent to the fluids gap. The maximum diameter A118 of the magnet is about 6 mm. The coil A106 may also comprise a complementary curved surface A106c, d adjacent the air fluid gap A150a,b and magnet A105, although it is flat in this embodiment. The curved surfaces of the coil and magnet may be complementary. The magnet surface may be curved about the axis of rotation A103. The coil surface may also be curved about the axis of rotation.

The conductive coil A106 extends about the magnet A105, in situ. Preferably, a shortest distance between the magnet A105 and the conductive coil A106 is lower than approximately 0.3 mm, or lower than approximately 0.1 mm, or lower than approximately 0.1 mm. Preferably the conductive coil A106 is symmetric across opposing sides of the magnet A105.

The transducing mechanism of this embodiment may alternatively be replaced with the transducing mechanism of any one of the other embodiments or variations herein described.

### Ferromagnetic Parts to Augment Magnetic Interaction Between Coil and Magnet

In this embodiment transducer base structure A102 main body components A110a, A110b comprise a ferromagnetic material, such as mild steel or silicon steel, for example. Referring to FIG. 1F, it can be seen that main body components A110a and A110b form a substantially symmetrical structure about a plane intersecting the axis of rotation A103 and bisecting diaphragm A101. Main body components A110a and A110b may be divided into zones labelled A131a-b, A132a-b, A133a-b, A134a-b, A135a-b and A137a-b, in FIG. 1F. These Zones are separated by dividing lines A127, A128, A129, A130, A138 and A139. It can be seen that at least a portion of magnetic field may exit magnet A105 from the north pole, and then pass into component A110a, starting in zone A131a, then, in sequence, into zones A132a, A135a, A133a, and then into component A110b in zone A133b, then in sequence, into zones A135b, A132b, and A131b, before returning into the south pole of magnet A105. This magnetic circuit may be considered a Primary Magnetic Circuit A123 of this transducer system. In this way main body components A110a and A110b may help to complete a Primary Magnetic Circuit A123, reducing the distance that the magnetic field must travel through low-permeability materials such as air, and thereby potentially increasing the density of magnetic flux passing through coil A106. Increasing the density of magnetic flux passing through coil A106 may lead to increased torque generation, thereby reducing power requirement of the transducer.

Main body components A110a and A110b also have several geometry features that distinguish the design from prior art designs, and that may reduce the density of magnetic flux passing through the coil. For example, zones A134 and A137 are not part of the magnetic circuit described above, and their presence may tend to provide a path by which flux from the magnet can join the Primary Magnetic Circuit A123 via a route that may bypass coil A106. Similarly, the fact that zone A135 extends adjacent or at least proximal to coil A106 may lead to magnetic flux lines joining the Primary Magnetic Circuit A123 via a route that may bypass coil A106.

The fact that magnetic flux may bypass the coil leads to a reduction in torque generation, however this is more than offset by enhancement of a pair of secondary magnetic pathways A122a and A122b that enhance the field generated by coil A106. As is known in the art when current passes through primary coil winding A106a, for example in a direction into the page with respect to FIG. 1F, this generates magnetic flux flowing clockwise, as shown by direction arrows of coil generated flux pathway A122a. Likewise, when current passes through primary coil winding A106b, for example in a direction out of the page with respect to FIG. 1F 901, this generates magnetic flux flowing anti-clockwise, as shown by direction arrows of coil generated flux pathway A122b. Zones A134a, A137a, and parts of zone A135a that are proximal to primary coil winding A106a provide a ferromagnetic pathway that may enhance such coil-generated flux in regions proximal to a north pole of magnet A105. Enhancement may arise because flux may pass more easily around and/or closer to primary coil winding A106a along flux pathway A122a, facilitated by high-permeability ferromagnetic zones A135a, A132a, A131a, A134a and A137a, which may enhance the effect of flux generated by primary coil winding A106a in regions proximal to the north pole of magnet A105.

A further change compared to prior art motors is a shifting of zones A133a, A133b away from magnet A105, in order to reduce an amount of flex passing directly between magnet A105 and zones A133a, A133b and thereby bypassing coil A106.

### Managing Forces on Diaphragm

Use of magnetic and/or ferromagnetic parts on both a transducer base structure A102 and proximal parts of a diaphragm A101 may result in forces that must be resisted or managed in order to avoid placing undue strain on diaphragm suspension parts A109 to avoid potentially compromising low-frequency bandwidth.

There may be translational forces in direction A147 due to attraction between large regions of ferromagnetic material, such as zones A133a, A133b and A135a, A135b, and magnet A105. This direction A147 force may be reduced by a shifting of zone A133 away from magnet A105 to reduce attraction therebetween.

Forces in direction A147, acting on the magnet A105 may be further minimised by presence of zones A134a, A134b, and A137a, A137b, which may generate a counteracting force in the direction A147. This may lead to an at least approximate symmetry about a transverse plane A148 in terms of the ferromagnetic surfaces that are most proximal to magnet north and south poles, for example proximal surfaces of zones A134a, A134b, and A137a, A137b features may mirror proximal surfaces of Zones A132a, A132b, and A135a, A135b, at least subject to various constraints such as that zones A137a, A137b should not interfere with or unduly limit diaphragm excursion.

Symmetry about the coronal plane A146 helps to reduce forces in the direction A147 acting on the magnet A105, however this symmetry no longer applies when the diaphragm A101 rotates in use. In this case approximate symmetry about the transverse plane A148, at least in terms of ferromagnetic surfaces most proximal to a magnet and/or to magnet poles, may assist in minimising and/or reducing direction A147 forces acting on the magnet A105. In this specification, the phrase a “transverse plane” means an imaginary plane that comprises the axis of rotation and is perpendicular to the coronal and sagittal planes.

For these reasons, in some embodiments it is preferable that ferromagnetic surfaces substantially proximal to a transducing magnet A105 exhibit approximate symmetry about the transverse plane A148 and/or about a plane parallel to a diaphragm axis of rotation A103 and bisecting the magnet poles and/or about a plane bisecting the diaphragm and approximately parallel to the major faces A145. Preferably ferromagnetic surfaces substantially proximal to a transducing magnet exhibit approximate symmetry about the coronal plane A146 and/or about a plane intersecting a diaphragm axis of rotation A103 and intersecting the magnet poles.

In some embodiments features that maximise torque, such as wrapping of ferromagnetic material around primary coil winds for example, may in some cases result in potentially unwanted forces and torques. Such designs may lead to higher translational forces such as in the case of inaccurate/non-central diaphragm positioning between coil windings during manufacture, for example. To address such forces various hinge designs are proposed, as part of the present invention, that may resist such translational forces, including over long time periods, while still facilitating transducer operation.

In some cases, such features that maximise torque lead to magnetic/ferromagnetic torsional forces that may act to rotate the diaphragm away from a desired rest angle, perhaps forming an unstable equilibrium situation. To address such “negative stiffness” torques, various hinge designs are proposed, as part of the present invention, that may resist such torques, including over long time periods, while still facilitating transducer operation. Furthermore, in some embodiments hinge and motor features are combined with specialised components to provide torsional restoring force, including torsion bars and separate magnetic ferromagnetic components, for example, which may work well including over long time periods.

Preferably torsion forces about the diaphragm's axis of rotation generated by magnetic/ferromagnetic interactions result in at least a component of negative torsional stiffness in terms of the diaphragm's angle of rotation, since this behaviour may be associated with improved motor strength and higher efficiency. Preferably torsional restoring force from a restoring mechanism and/or originating from a biasing force of a hinge mechanism counteracts negative torsional stiffness associated with magnetic/ferromagnetic interactions to achieve a stable equilibrium that acts to return a diaphragm to its rest position.

In some embodiments it may be advantageous to achieve a degree of symmetry in magnetic and/or ferromagnetic elements in the transducer base structure that are in close proximity to magnetic and/or ferromagnetic elements in the diaphragm. For example, there may be symmetry about a plane intersecting the axis of rotation and evenly bisecting the diaphragm, and/or symmetry about a plane intersecting the axis of rotation and evenly bisecting the diaphragm. Such symmetry, or alternative balancing schemes may be employed, may serve to balance attraction of the diaphragm in various directions so that there is a degree of cancellation resulting in smaller net force on the diaphragm. This approach may also substantially balance torques acting on the diaphragm. This may reduce design pressure on elements such as hinges and torsional restoring elements, which must resist such forces and torques over time with low susceptibility to deformation and failure via creep, for example.

Preferably one or more regions A135a, A135 of ferromagnetic material are located substantially adjacent to, or offset from, a side of primary coil winding A106a, A106b that faces in a direction opposite to a diaphragm radius. Preferably a part of region(s) A135a, A135b that is in close proximity to, or at least has a termination that is in close proximity to, associated primary coil winding, extends from another region A132a, A133b in a direction aligned with magnet poles substantially towards the axis of rotation and/or towards the magnet pole. Preferably said termination of fifth region A135a, A135b that is proximal to primary coil windings is displaced from region A132a, A132b (proximal to windings) in a direction aligned with magnet poles a distance of at least 50%, more preferably at least 75%, most preferably at least 100% of a height of the proximal side of the associated primary coil winding, said winding side being oriented in a substantially opposite direction to a diaphragm radius. Preferably a termination of said region A135a, A135b is proximal to a magnet pole. Preferably there is such a region A135a, A135b associated with both primary windings.

Preferably one or more other regions A133a, A133b of ferromagnetic material, having extent substantially similar to or perhaps less than a side of magnet facing in a direction substantially opposite to a diaphragm radius, contributes towards at least partially completing, and more preferably substantially completing, a magnetic circuit, for example connecting between two second regions A132a, A132b, in some embodiments via regions A135a, A135b, thereby connecting the magnetic north pole to the magnetic south pole. Preferably the region(s) A133a, A133b are substantially spaced from the diaphragm magnet.

Preferably there is a rectangular region (A140) occupying a space oriented substantially parallel to magnet poles, that is offset from a side of magnet and is a similar dimension to said side that faces opposite to a diaphragm radius, and occupies a space between approximately b/2 and b/4 of a distance from a side of the magnet opposite the side of the diaphragm, whereby a cross-sectional area of the region A140 preferably typically contains at least 20%, more preferably at least 40%, most preferably at least 60% non-ferromagnetic material. Preferably region A140 does not provide substantially continuous ferromagnetic connection in a direction parallel to the direction of magnet magnetisation across a dimension of the region A140. Keeping region A140 substantially free of ferromagnetic material contributes toward avoiding undue long-term attraction force on the diaphragm, resisted via hinges, that may result in long term failure, for example via creep deformation in hinge parts.

Preferably some part, or at least a significant part, of region(s) A135a, A135b extends further in a direction of diaphragm radius compared to every part, or at least of most parts, of region(s) A133a, A133b. Preferably some part of a side of region A133a, A133b, or at least a significant part of said side, that faces substantially in a direction of diaphragm radius, extends less far in a diaphragm radius direction versus all parts of a side of region A135a, A135b facing the same direction.

Preferably a region A134a, A134b of ferromagnetic material is substantially adjacent to region A131a, A131b in a direction of a diaphragm radius, and extends significantly beyond the extent of an associated primary coil winding in a direction of a diaphragm radius. Preferably a region A134a, A134b extends beyond the extent of the primary winding in a direction of a diaphragm radius by a distance greater than 50%, and more preferably at least 70% of a dimension of the primary coil windings in the same direction. Preferably there is such a region A134a, A134b associated with both primary windings.

Preferably one or more regions A137a, A137b of the ferromagnetic material are each located substantially adjacent to a region A134a, A134b and extending in a direction parallel to an axis of magnetisation. Preferably seventh region A137a, A137b extends from region A134a, A134b in this direction at least 50%, more preferably at least 75%, most preferably at least 90% of a height of the proximal side of the associated primary coil winding, said face being oriented in a substantially opposite direction to a diaphragm radius. Preferably the region A137a, A137b extends from region A134a, A134b towards the axis of rotation and/or towards the magnet. Preferably a termination of said region A137a, A137b is proximal to a magnet pole. Preferably there is such a region A137a, A137b associated with both primary windings.

### Saturation

Depending on geometry and magnet strength, parts of ferromagnetic zones A135a, A135b, and A137a, A137b that are most proximal to magnet A105 may approach saturation even in a zero-current scenario through coil windings A106. This may potentially lead to a nonlinear motor characteristic whereby low coil current, which may superimpose additional flux on the same ferromagnetic regions, may result in proportionally greater effects, including flux change and overall motor torque, compared to what may be achieved by higher coil current. To address this potential disadvantage, it may be desirable to design magnetic and ferromagnetic elements in such a way that ferromagnetic parts do not approach saturation in-use. For example, in some embodiment's parts of ferromagnetic zones A135a, A135b, and A137a, A137b that are most proximal to magnet A105 may be removed and/or saturation-prone corners may be rounded (not shown.) Preferably convex ferromagnetic edges most proximal to a magnet pole are radiused.

### Magnet Geometry

Since magnetic material located in close proximity to a primary coil winding A106a-b may tend to generate stronger flux through such windings, in some embodiments a magnet A105 exhibits greater dimension in a direction aligned with the primary coil windings A106a-b compared to in a direction perpendicular to this direction and perpendicular to an axis of rotation A103. For the same reason, there may be magnet material proximal to substantially all of a surface A106c-d of a coil primary winding A106a-b that faces and/or is proximal to a magnet pole. There may be less material at a similar radius in directions facing away from a primary coil winding. In terms of directions perpendicular to an axis of rotation A103, a magnet radius in directions that are not oriented towards a primary coil winding A106a-b may be reduced compared to directions that are oriented towards a primary coil winding A106a-b.

Preferably magnet A105 exhibits more mass in a region immediately proximal to the primary coil windings A106a-b compared to a region located immediately adjacent, as viewed in a direction of the axis of rotation, for example as per FIG. 1F. Preferably the magnet profile is elongated, overall, in a direction spanning the primary coil windings A105. Preferably, viewed in side profile, an overall convexness of radius of a magnet surface facing primary coil windings A106a-b is less compared to an overall convexness of radius of a side facing in a direction opposite to a diaphragm radius.

Magnet surfaces facing the primary coil windings A106a-b are convexly curved, in order to achieve close proximity without interfering when the diaphragm A101 rotates. Preferably a corresponding surface A106c-d of the primary coil windings A106a-b exhibits a matching curve. Preferably a centre of mass of the magnet A105 is displaced in a direction opposite to a diaphragm tip A101b direction relative to the axis of rotation A103.

### Diaphragm Suspension System

The diaphragm suspension enables rotation of the diaphragm A101 about an axis of rotation A103 to enable a range of angular motion of approximately 6 degrees on either side of the axis, or approximately 15 degrees on either side of the axis, or approximately 20 degrees on either side of the axis. In this embodiment, the diaphragm suspension comprises a plurality of hinge mounts A109a, A109b. In some embodiments, a single hinge mount may be used.

In some embodiments, excitation of one or more diaphragm resonance modes having a significant translational component, at least at parts of the diaphragm, in a direction substantially perpendicular to the coronal plane A146 of the diaphragm A101, may be minimised or substantially mitigated by location of diaphragm suspension mounts A109a, A109b A107b so that axis A103 is located at or near the diaphragm node axis A104. In some embodiments, excitation of the one or more such resonance modes may be minimised by locating the primary axis of rotation A103 of the diaphragm in a plane A148 that is substantially perpendicular to a coronal plane A146 of the diaphragm A101 and that contains/intersects with the node axis A104 of the diaphragm A101. Preferably axis A103 is substantially parallel to diaphragm node axis A104. In some embodiments, the primary axis of rotation A103 and the diaphragm node axis A104 may be substantially coaxial. Further detail around the location of axis A103 at node axis A104 can be found in WO/2020/035812.

In this embodiment the hinge assembly A109, comprises three flexible hinge elements A201a-c, all of which are rigidly coupled to the transducer base structure A102 at one end and to the diaphragm assembly A101 at an opposing end A206 in close proximity to the axis of rotation A103. The flexure hinge assembly A109 facilitates rotational/pivotal movement/oscillation of the diaphragm assembly A101 about an approximate axis of rotation A103 with respect to the transducer base structure A102 in response to an electrical audio signal played through coil windings A106 attached to the diaphragm assembly. Mounting block A200 is at the transducer base structure A102 side of the hinge assembly, that flexible hinge elements A201a-c, are all rigidly coupled to.

In addition to hinge elements A201a-c, the hinge assembly comprises a pin A203 for insertion/attachment into holes A105b in each end of magnet/diaphragm base frame A105. The pin A203 is connected to a block A204 with protrusions A205. Parts of the block A204, pin A203 and protrusions A205 that are touching the magnet A105 may be connected, for example by using an adhesive such as epoxy. The block is connected to ribs A202a-c. These ribs may provide additional stiffness to regions of the hinge A109 in close proximity to the axis of rotation A103, and these regions are connected to both ribs A202a-c and block allowing forces to be transferred from the hinge elements A201a-c to the magnet A105. The hinge assembly A109 t is attached to transducer base structure A102, stiffening the hinge assembly A109, and in particular each hinge element A201a-c, are configured to be substantially capable of resisting forces of tension and or compression and or shear experienced within the planes of the hinge elements A201a-c. Because the hinge elements are angled relative to one-another this means that the diaphragm assembly A101 overall is restrained against all translational and rotational displacements, except for rotational motion about the required axis of rotation A103 of the hinge assembly. In particular, the strength and or stiffness of the hinge elements in compression, tension and shear, and the relative angles between the pair of hinge elements in each joint, means the diaphragm assembly is sufficiently and substantially restrained in respect to translational motion/displacement at each hinge joint along at least two, but preferably all three substantially orthogonal axes during operation. Such restraint may assist with resisting at least a subset of forces that may result from interactions between magnetic and/or ferromagnetic components in the diaphragm assembly A101 and transducer base structure A102.

In this embodiment, the hinge assembly A109 may comprise a single piece of material. In other embodiments different materials may be employed, for example a central shaft may comprise metal. The hinge assembly may be manufactured by injection moulding, for example. The material may comprise a relatively rigid urethane, a metal, or PEEK or nylon, plastic, for example.

FIG. 2A-E shows various views of the hinge A109 component used on either side of the audio transducer A100. This component is similar to the flexing hinge shown in FIG. C4 of WO 2017/04671.

FIG. 3A-H shows various views of a diaphragm suspension assembly contact hinge joint A300 that may be used to replace hinge A109 in one or both sides of the driver. It has a diaphragm pin (which may also be referred to and/or may comprise a shaft or inner race) A303 mounted to the magnet A105 via the hole A105bA105b, so that the pin rotates, with the diaphragm, about an axis of rotation A301 aligned with the axis of rotation A103 of the driver. An angle A309 of rotational excursion of the diaphragm pin A303 with respect to the transducer base structure A102 (and main body A302), in one direction, is about 6 degrees for the audio transducer A100, but may be configured larger or smaller depending on the transducer requirements. The hinge mechanism, contact hinge joint A300 has two ball bearings A304a-b that roll against the diaphragm pin A303, each contacting at one region of contact A313a and A313b respectively. One contact interface is where the surface of the diaphragm pin and the surface of the ball A304a touch, and another contact interface is where the surface of the diaphragm pin and the surface of the ball A304a touch. In this embodiment the ball bearings A304a-b are made from ceramic, but they may alternatively be made from a non-magnetic metal, or from a plastic that has low creep, such as PEEK. It may also be configured to operate being made from an elastomeric material such as CPU. A biasing force holds the diaphragm pin A303 against the balls A304a-b, and also the balls against the main body of the hinge A302. In the audio transducer A100, the biasing force is due to the magnetic attraction of the magnet A105 to the ferromagnetic pole pieces A110a-b, and the direction of the force acting on the magnet A105 is predominantly in the direction away from the diaphragm tip A101b (i.e. downwards with respect to both FIG. 1F and FIG. 3B). In in alternate configuration the position of the magnet within the ferromagnetic components may be altered (for example moved up or down or sideways, for example) and/or the geometry of the components may be configured to provide a force acting on the magnet A105 in a predominantly different direction, such as towards the tip A101b of the diaphragm, for example (i.e. upwards with respect to both FIG. 1F and FIG. 3E). In this latter configuration, a hinge may be required to be mounted rotated 180 degrees about the axis A103 to the transducer base structure A102, to operate.

A biasing mechanism (which could be a magnetic force acting on the diaphragm A101, acting through the contact hinge joints, with a reaction force acting on the base structure) exerts a force biasing the hinge joint, wherein each hinge joint comprises a first contact interface having a pair of rigid contacting surfaces, a second contact interface having a pair of rigid contacting surfaces, the first and second contact interfaces being positioned in close proximity to one another along the axis of rotation, and wherein an axis of a first net reaction force applied to the diaphragm at the first contact interface is angled relative to an axis of a second net reaction force applied to the diaphragm at the second contact interface, as shown by angle A305 in FIG. 3B.

In an alternate configuration, the diaphragm pin A303 has a channel that the bearing rolls within and restricts the movement of the balls A304a-b in the direction of the axis A301. The ball may connect to one or two regions of contact within said channel.

The two balls roll within two respective outer race channels A312a-b within a main body A302 of the hinge. The outer race A312 is located at a larger radius, about the diaphragm axis of rotation A103, compared to the inner race. The main body A302 may be made out of a plastic with low susceptibility to creep, such as PEEK, or a metal or ceramic. The main body A302 may also be configured to work with a hard elastomeric material, for example CPU of hardness 70 D. In this embodiment each channel has two regions of contact A307 of the main body A302 to a ball A304. This contact interface is located over two regions where the surface of the main body A302 and the surface of the ball A304a touch. The contact interface has two surfaces, one being on the ball A304 and one being on the main body A302. There is an angle A308 of about 105 degrees between the two planes, both intersecting both the axis of rotation A103 and each intersecting one of the two regions of contact A307, as shown in FIG. 3D. As a ball A304 rolls, the geometry of the channels A312a-b defines a path that the moves along, and that path may be in an arc that is concentric to the hinge axis A301, and balls may be free to roll along the path with an approximate angle A310 of rotational excursion of the balls. The angle A310 is about 4 degrees, or may be larger or smaller depending on the transducer requirements. In an alternate configuration, the path may be non-concentric, which may result in a very small translational displacement of the shaft as it rotates about an approximate axis of rotation A301. This may provide an advantage of providing a restoring force that centres the diaphragm. Alternatively, or in addition, torsional centring about the diaphragm's axis of rotation may be provided by magnetic forces exerted by magnetic and/or ferromagnetic elements attached to the diaphragm and transducer base structure. Further alternatively, or in addition, an additional centring component may be used. For example, the contact hinge joint A300 may also be used in conjunction with a torsion bar component, similar to the torsion bar A106, shown in Fig. A of WO 2017/04671 connected between the diaphragm pin A303 and the transducer base structure A102. In some embodiments the diaphragm pin component may comprise an inner race for the hinge and a flexing torsion bar. For example, in some embodiments the pin may extend from the magnet, through the hinge where it serves as an inner race component, and then extends beyond to where it serves as a torsion bar. In some embodiments it may narrow, to provide improved torsional compliance. Further beyond the torsion bar section it may perhaps thicken again to provide a point of attachment to the transducer base structure. In some embodiments attachment of the distal end of the torsion bar to the transducer base structure is via a compliant and/or damped material, in order to help manage various resonance modes of the torsion bar. In an alternative embodiment, or in addition, the torsion bar exhibits a rigid profile, such as a C-section for example, that may help push resonance modes to higher frequency and preferably out of the operating bandwidth. Preferably the torsion bar section is substantially coaxial with the diaphragm axis of rotation. Each channel A312a,b is configured to allow the ball to roll along each channel defined path, until a ball reaches a stopper surface A311a-d as part of the main body A302. For example, with reference to FIG. 3F, ball bearing A304a may roll until it hits stopper surface A311a, or in the opposite direction, stopper surface A311b. This preferably does not occur often during normal operation, as it may create audio distortion. It may happen infrequently during normal operation, for example during a loud percussive event, and may cause a ball A304 to stop suddenly and for the diaphragm pin A303 to slip at region A313 of contact between the pin and a ball. As the ball bearings A304 roll in the channels, or during transportation or rough handling, for example, occasional micro slippage may occur at the regions A307 and A313 of predominantly rolling contact against the balls A304. This may cause the balls to become de-centred within their respective channels, and it may mean that they are more likely to hit a stopper surface A311. The large slipping action that may occur as the stopper hits may correct this, so that the position of the balls A304 are more well centred within their respective channels, when the diaphragm is in its “at rest” position.

In an alternative embodiment, rather than a hard stop, the balls meet an increasing ramp, at least relative to the radius of the rest of the outer (and/or inner) race. This configuration may provide an advantage that ball position corrections are less frequent and/or less audible. In some embodiments such profiling of the outer and/or inner race may help to provide mechanical limitation to avoid excessive diaphragm excursion, which may be equivalent to a rubber surround “maxing out” in a conventional cone-type transducer under large diaphragm excursions.

The main body A302 has two flexing regions A306a and A306b. The thickness of regions A306a-b are relatively thin compared to the main body thickness, in the direction of the axis of rotation A301. Slots A315 are either side of channels A312. The geometry of the slots and the thin flexing regions A306 allows the channels A312a and A312b to flex independently of one-another. Hinge channel A312a may flex about an approximate axis of rotation A314a and region A306b. Hinge channel A312b may flex approximately about an axis of rotation A314b. If the plane A316 of the main body A302 is not assembled perfectly perpendicular to the driver axis of rotation A103, or other inaccuracies occur, for example due to manufacturing tolerances, then hinge channels A312a and A312b may translate in an axis direction to accommodate the misalignment. This may reduce the chance of slippage of the ball bearings A304 at contact regions A307, A313 to the pin A303 and channel A312. Preferably, the diaphragm axis of hinge rotation A301 is oriented perpendicular to a plane extending through the axis of rotation A314. Preferably, the axis of hinge rotation A301 is approximately perpendicular to a plane extending through regions of contact A307, A313a and A313b. Preferably, the axis of hinge rotation A301 is approximately perpendicular to a plane extending through a region of contact A307. Preferably, the approximate axis of rotation A314a is parallel to the average direction that the ball bearing A304a travels within the channel A312a. Preferably, the approximate axis of rotation A314b is parallel to the average direction that the ball bearing A304b travels within the channel A312b.

In an alternate configuration, the main body A302 does not have the flexing regions A3a-b.

In an alternative configuration, the flexing regions A3a-b flex due to flexibility and/or geometry of material(s) being used, for example a TPU or another elastomer may be used to connect the hinge to the driver base. In some embodiments the TPU is connected in a manner that permits a range of different deformations, thereby permitting a degree of independent translational motion at each contact surface, in a direction parallel to diaphragm axis of rotation A103.

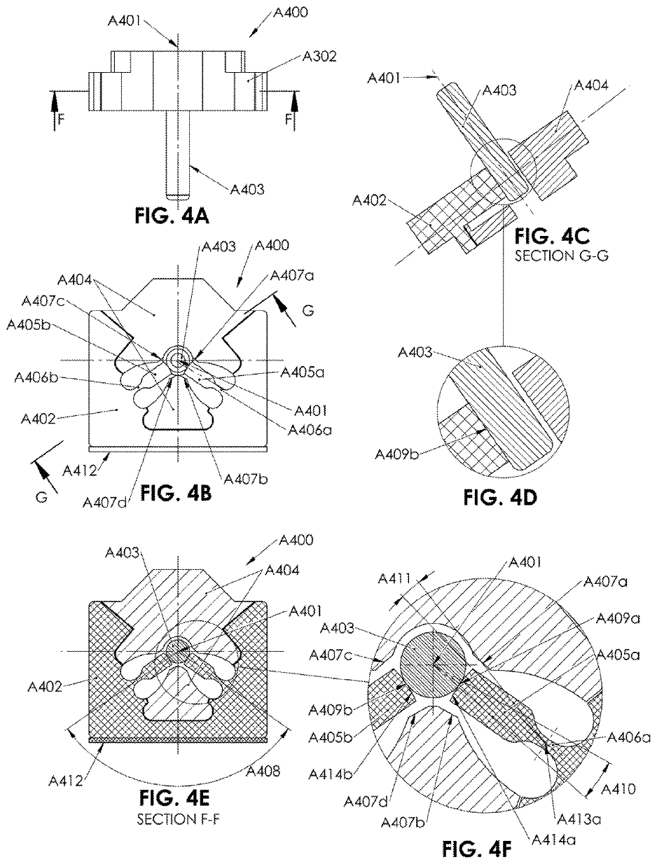

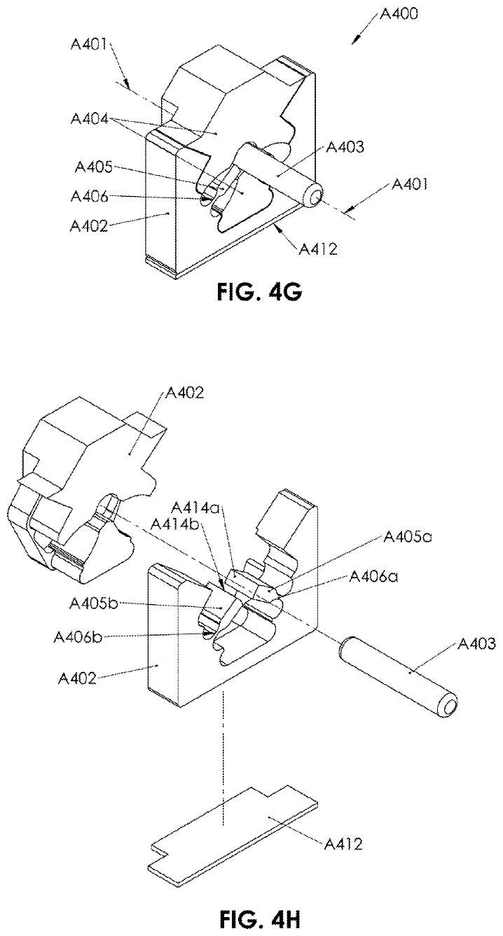

FIG. 4A-H shows various views of a diaphragm suspension assembly A400 that may be used to replace hinge A109 in one or both sides of the driver.

It has a diaphragm pin A403 mounted to the magnet A105 via the hole A105b and allows the pin to rotate about an axis of rotation A401 aligned with the axis of rotation A103 of the driver. A peak-to-peak angle A410 of rotational excursion of the diaphragm pin A403 with respect to the transducer base structure A102 (and main body A302) is about 12 degrees for the audio transducer A100, but may be configured larger or smaller depending on the transducer requirements. The hinge mechanism A400 has two flexing arms A405a-b with corresponding flexing regions A406a,b that allow each arm to flex about flexing arm axes A413a,b. Each flexing arm A405a-b also has regions A409a-b of predominantly rolling contact between diaphragm pin A403 and flexing arms A405a-b at surfaces A414a,b. The main body of the hinge A402 and flexing arms A405 are preferably made from a plastic that has low creep, such as PEEK. Alternatively, a metal may be used, for example titanium or liquid metal™. Alternatively, an elastomer may be used such as TPU or CPU. Alternatively, a composite material may be used, for example a PEEK flexing region A406 combined with a hard ceramic contact region A409, or a thin titanium flexing region A405 in-moulded into an arm made from PEEK plastic.

Similar to contact hinge joint A300, a force holds the diaphragm pin A403 against the flexor arms A405. The directions of the force acting on the magnet A105 is predominantly in the direction away from the diaphragm tip A101b (i.e. downwards with respect to both FIG. 1F and FIG. 4E). Similar as described with respect to contact hinge joint A300, the force may be configured to act in a different direction. Preferably the force acts to hold the pin A403 and arms A405 in contact during normal operation.

In an alternate configuration, the diaphragm pin A403 has a channel that the flexing arm A405 rolls within and restricts the movement of pin A403 with respect to the direction of the axis A301. The flexing arm may connect at preferably one or two regions of contact within said channel.

As the hinge A400 operates, flexing arms A405a or A405b rotate about an approximate angle A411 of rotational excursion, in one direction, about the respective flexing arm axis A413a and A413b. The angle A411 is about 6 degrees or may be larger or smaller depending on the transducer requirements. Preferably the contacting regions A409a,b are respectively curved in a concave arc that is approximately concentric to the respective flexing arm axis A413a and A413b.

Each flexing arm A405 is configured to rotate about the respective flexing arm axis A413a and A413b until they contact a stopper region A407a-d. For example, in FIG. 4F, flexing arm A405a may rotate clockwise about axis A413a by an angle A411 until the arm hits stopper surface A407a, or anticlockwise about axis A413a until the arm hits stopper surface A407b. Stopper surfaces A407a-d are all connected to block A404. Block A404 may alternatively be made as part of the main body A402. The main body is attached to damping mount A412, which is a thin sheet of material that is more compliant than the main body A402. The damping mount A412 may be made from an elastomer, such as TPU of hardness 70 D. The damping mount A412, is connected to the transducer base structure A102 and there are no other components of the hinge that connect to the transducer base structure A102. This means that damping mount A412 may provide damping of vibrations that pass between the diaphragm A101 and transducer base structure A102, and so improve sound quality. The geometry being thin means that compliance is small enough that the hinges are located accurately with respect to the driver base structure and diaphragm and may not be unduly susceptible to creep associated with long-term forces exerted by magnetic and/or ferromagnetic transduction/motor components.

The use of a damping mount between a hinge and a transducer base structure may provide improved sound quality in other hinges as well, especially if the materials used in the path from diaphragm to the transducer base structure do not otherwise have a material that provides sufficient vibrational damping.

A flexing arm A405 preferably does not touch a stopper surface A407 often during normal operation, as it may create audio distortion. It may happen infrequently during normal operation, for example during an exceptionally loud bass drum hit, and may cause an arm A405 to stop suddenly and the diaphragm pin A403 may slip at region of contact A409. As the arm A405 rolls against the pin A403 this may cause an arm A405 to become un-centred within their respective stopper surfaces A407, and it may mean that they are more likely to hit a stopper surface A407. The large slipping action that may occur as the stopper hits may correct this, so that the position of the arms A405 are more well centred within their respective stopper surfaces, when the diaphragm is in its “at rest” position.

Additionally, to the use of two hinge assemblies A400 installed on either side of the transducer assembly, a diaphragm centring component may be used. For example, the hinge A400 may also be used in conjunction with a torsion bar component, similar to the torsion bar A106, shown in FIG. A of WO 2017/04671 connected between the diaphragm pin A403 and the transducer base structure A102. The diaphragm pin component may include a flexing torsion bar. There are other suitable diaphragm centring mechanisms that may be used, for example magnetic centring, or a flexing element/spring of some kind, made from elastomer or metal and connected between the diaphragm A101 and the transducer base structure A102.

In an alternate configuration the main body A402 has two flexing regions similar to regions A306a and A306b of the hinge assembly, contact hinge joint A300. These may flex to accommodate misalignment similarly to as described in hinge A300. This may reduce the chance of slippage of the pin A403 relative to the arms A403 at contact regions A409.

The pair of diaphragm suspension mounts A109a, A109b, is shown in FIGS. 2A-E, in some embodiments, each mount A109a, A109b may be formed from a urethane foam or elastomer. In such configurations, a maximum excursion may be increased and/or a fundamental diaphragm resonance frequency may be reduced, without undue reduction in translational rigidity. A geometry of each hinge mount A109a, A109b may be able to be made relatively thicker and/or shorter. This may be utilised in very small, delicate speaker drivers, for example, where the hinge component is very small, and/or less delicate hinge features may be less prone to internal resonance modes.

In some embodiments, the hinge mounts A109a and A109b may be replaced by any other diaphragm suspension herein described in relation to other embodiments. Furthermore, any of the hinge mounts described in relation to the transducer A100 may be used in relation to any other audio transducer embodiment herein described.

The compliance of the diaphragm suspension system may be customised to the requirements of a particular driver application. For example a treble driver in a two way home audio speaker may not require a low Primary Mode frequency, and so a relatively less compliant diaphragm suspension system may be used, which might provide an advantage, for example, that the diaphragm structure would be more rigid against displacements of the diaphragm relative to the base due to creep of diaphragm suspension system materials, thereby improving transducer robustness in such an application.

In some embodiments each hinge mount of the diaphragm suspension has sufficiently low Young's modulus such that fundamental diaphragm resonance frequency occurs at frequency less than approximately 100 Hz. In some embodiments each hinge mount of the diaphragm suspension has sufficiently low Young's modulus such that a fundamental diaphragm resonance frequency occurs at frequency less than approximately 70 Hz. In some embodiments each hinge mount of the diaphragm suspension has a sufficiently low Young's modulus such that a fundamental diaphragm resonance frequency occurs at frequency of less than approximately 50 Hz. Such a device may be useful as a bass driver or in personal audio applications as described in further detail below.

In some embodiments, the audio transducer may comprise a translational resonance frequency of more than approximately 200 Hz, or more than approximately 300 Hz, or more than approximately 400 Hz. This may make the device suitable as a mid-range/high frequency driver or also as a personal audio device.

In some embodiments one or more diaphragm suspension components, such as each hinge mount, is sufficiently rigid in order that a diaphragm resonance frequency associated with translational compliance occurs at a frequency greater than approximately 200 Hz, more preferably greater than approximately 300 Hz, and most preferably greater than approximately 400 Hz. The diaphragm resonance frequency associated with translational compliance may involve significant displacement of the diaphragm in a direction perpendicular to a coronal plane.

The materials and/or construction of the diaphragm suspension may provide substantially high damping, particularly in tension/compression, in order to help manage translational and other unwanted resonance modes.

In some embodiments, the diaphragm suspension may consist of a substantially rigid hinge construction, for example as described in section 3.2 of WO 2017/046716, but with the axis of rotation of the hinge being located in a plane that is substantially perpendicular to a coronal plane A146 of the diaphragm and that contains the node axis A104 of the diaphragm. More preferably the axis of rotation is substantially coaxial with the node axis A104. In some embodiments the axis of rotation is substantially coaxial with the centre of mass. Such a suspension may comprise at least one hinge mount, having a pair of substantially rigid and opposing contact surfaces that are configured to move relative to one another during operation. One contact surface may be rigidly coupled to or form part of the diaphragm A101, while the other may be rigidly coupled to or form part of the transducer base structure. A biasing mechanism may bias the contact surfaces toward one another.

In some embodiments, the diaphragm suspension may comprise one or more hinge joints, each hinge joint having a pair of cooperating contact surfaces configured to move relative to one another to rotate the supported diaphragm during operation. One of the contact surfaces may form part of the diaphragm and the other contact surface may form part of the transducer base structure.

In some embodiments, the diaphragm suspension may comprise at least one hinge joint, each hinge joint having a pair of cooperating, substantially rigid contact surfaces configured to move relative to one another during operation to rotate the supported diaphragm. The diaphragm suspension may comprise a biasing mechanism configured to compliantly bias the pair of cooperating contact surfaces towards one another to maintain substantially consistent physical contact between the contact surfaces during normal operation. One of the contact surfaces may form part of the diaphragm and the other contact surface may form part of the transducer base structure.

### Decoupling Mounting System

To minimise the transmission of unwanted vibration between the speaker housing (not shown) and the transducer A100, the transducer A100 is preferably coupled to the housing via a flexible, decoupling mounting system (not shown). In some embodiments this system may be similar to the decoupling mounting systems described in section 4 of WO 2017/046716 in relation to embodiment A, for example.

As described above, various design features that improve transducer efficiency, such as inclusion of and geometry of magnetic and ferromagnetic elements, for example, may lead to long-term forces and/or torques on the diaphragm that must be resisted by diaphragm suspension components. Various diaphragm suspension designs outlined in the present invention are optimised for resisting of such forces and torques, however in the process the translational rigidity of diaphragm support may increase in some cases. As described in WO 2017/046716 such translational rigidity may result in transfer of mechanical vibration energy from a diaphragm, to a transducer base structure-especially via a more rigid diaphragm suspension, and to an enclosure, as well as vice versa. Downsides may include that the lightweight diaphragm may be more prone to behaving as a mechanical amplification system for unwanted enclosure resonances. For these reasons and others, a transducer/enclosure decoupling system may be useful in combination with motor and/or hinge designs described herein, since it may break above-described the vibration transmission chain.

### 2. Second Audio Transducer Embodiment

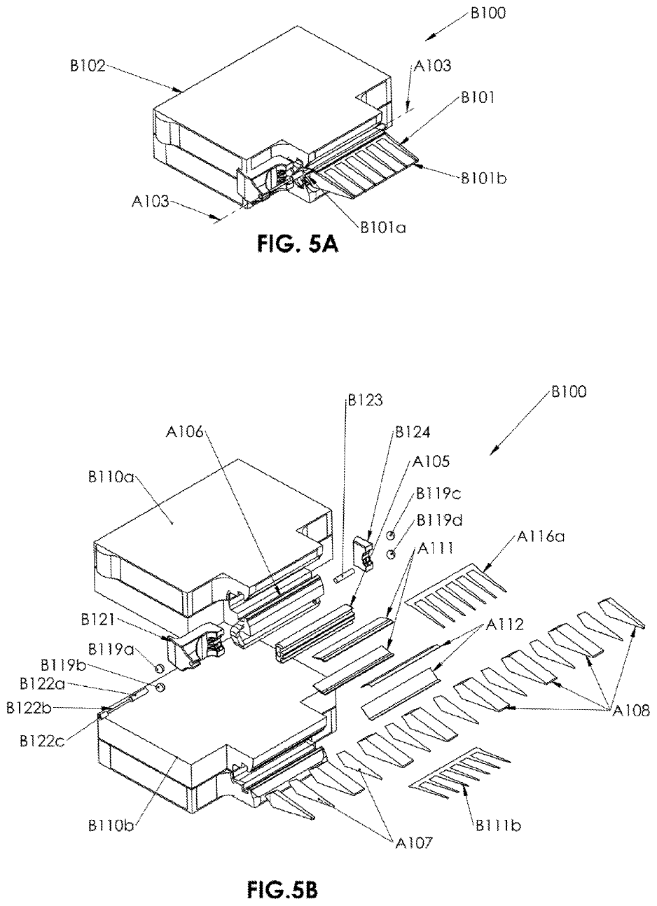

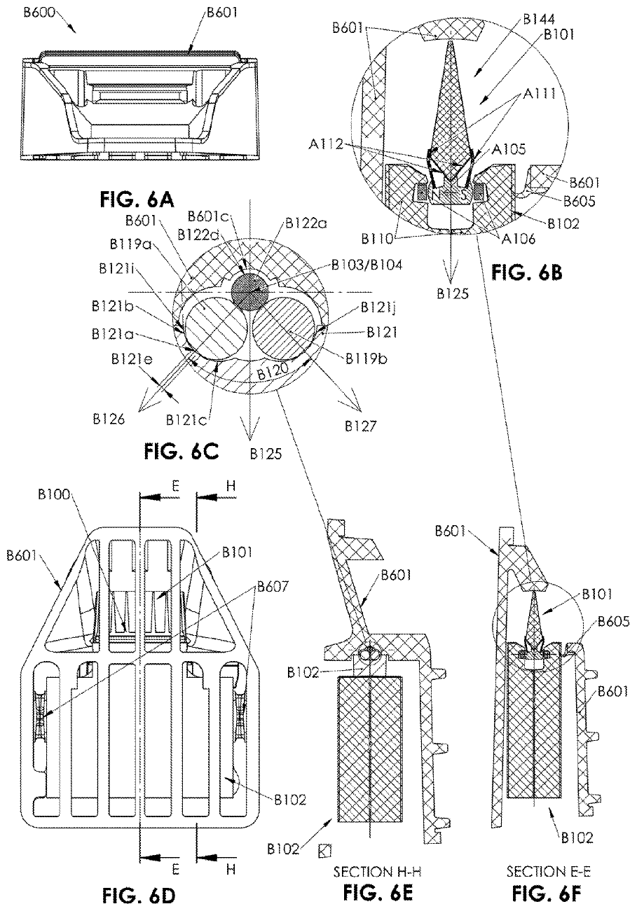

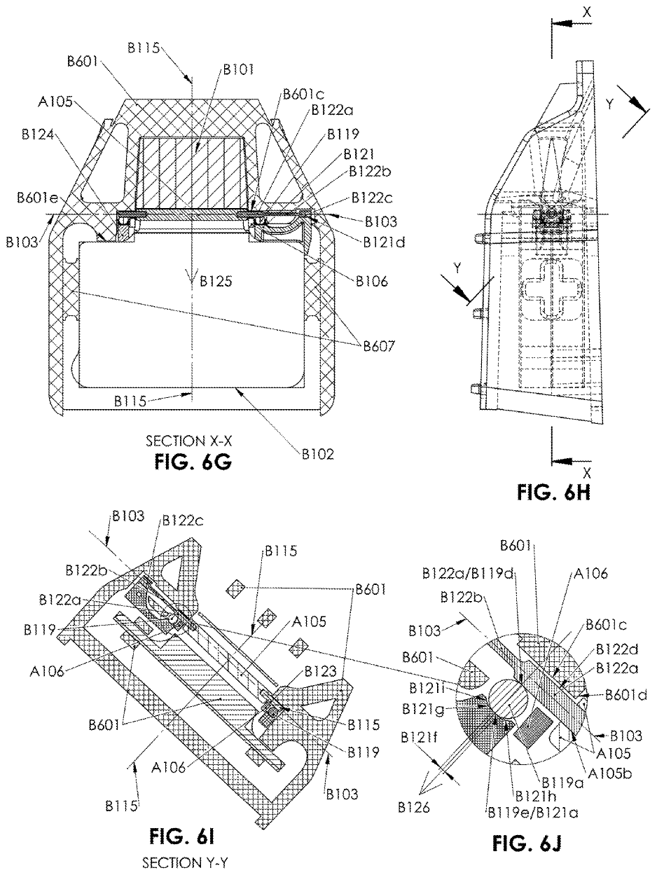

Referring to FIGS. 5A-5K, and 6A-6J a second audio transducer embodiment is shown herein comprising the same or similar features as described under the first audio transducer embodiment section above. The embodiment is provided herein to exemplify other audio transducer embodiments which may be constructed based on the preferred features and their variations as described for audio transducer A100. Accordingly, the features and variations described herein in relation to audio transducer A100 under section 1 of this specification are also incorporated in audio transducer A500. Other features of the audio transducer A500 are also described in FIGS. 5A-5K.

Referring to FIGS. 5A-B of this embodiment, the audio transducer assembly B100 differs from the assembly A100 in the following aspects:
1. diaphragm B101 does not use the aluminium outer reinforcement components A117a-b of the diaphragm A101,
2. the transducer base structure B102 includes two components B110a,b that replace A110a,b of base structure A102, and
3. the hinge mechanism that interfaces between diaphragm magnet A105 of diaphragm B101 and transducer base structure B102 has been replaced with an alternative hinge mechanism.

### Diaphragm Suspension System

The diaphragm suspension enables rotation of the diaphragm B101 about an axis of rotation B103 to enable a range of angular motion of approximately 6 degrees on either side of the axis, or approximately 15 degrees on either side of the axis, or approximately 20 degrees on either side of the axis. In this embodiment, the diaphragm suspension comprises a pair of hinge mechanisms, contact hinge joints B109a,b on either side and torsion bar B122. FIGS. 6a-j also show these mechanisms, which have similarities to the hinge mechanism, contact hinge joint A300 of FIG. 3. Contact hinge joints B109 may be used to replace both hinge mechanisms A109 and A300 in one or both sides of the driver. Each contact hinge joint B109a,b comprises two ball bearings B119, a bearing block B121/B124 and a diaphragm pin B123/B122a. The location of the hinge mounts B109a and B109b is chosen, such that the axis of rotation B103 coincides with a node axis B104 of the diaphragm B101. The torsion bar has a region B122a that is a diaphragm pin and acts similarly to diaphragm pin B123 in that it is adhered to the diaphragm magnet A105 via magnet holes A105b on either side. The pins also have surface regions, coated with a ceramic PVD coating such as Chromium Nitride, that each roll against a pair of ball bearings B119 made from a ceramic such as Silicon Nitride. The balls B119 are preferably non-magnetic to avoid unwanted interactions with the magnetic flux of the transducing mechanism. The pair of balls B119 also roll against a bearing block B121/B124 which is injection moulded from PEEK plastic. Preferably made plastic that has low creep and high strength, such as PEEK. Alternatively, a metal may be used, for example titanium or liquidmetal™, or a ceramic such as Alumina. Preferably the bearing blocks B121/B124 are non-magnetic. The bearing blocks are symmetrical about the sagittal plane B115, and each have two hinge channels B121i,j each containing one bearing B119a,b. Preferably, a compliant biasing force is applied pushing the diaphragm assembly B101 against the transducer base structure, in a similar way to as described with respect to the Audio transducer A100. Each hinge channel has a primary rolling region B121a that the ball B119 may settle down in rolling contact with, in normal operation.

Each hinge mechanism, contact hinge joint B109a,b, one of the left side and one on the right side, of audio transducer B100 differs from the hinge mechanism, contact hinge joint A300 of FIG. 3 in that each ball A119a,b,c,d has a single point or region of rolling contact with a hinge channel B121i,j (instead of two regions of contact per ball A304 touching hinge channel A312). Having a single point or region of contact may be advantageous in that friction during operation may be reduced, and the fundamental resonant frequency of the driver may be lowered.

Primary rolling region B121a is preferably a cylindrical surface, with an axis of curvature that is co-axial to the axis of rotation B103. Primary rolling region B121a is tangentially connected to secondary rolling regions B121b,c,g,h that preferably have a smaller radius of curvature than the primary rolling region B121a. Preferably, secondary rolling regions B121b,c,g,h have a radius slightly larger than the radius of the ball bearings B119 so that the balls may start to roll up these regions on occasions due to unusual shifting/slipping of the balls (for example, during unusually large excursions of the diaphragm, during a drop or knock of the device or vibration, or a combination of these things). When viewed from a cross-section plane perpendicular to the axis of rotation B103, such as shown in FIG. 6C, primary rolling contact region B121a has a length dimension B122e. This indicates the limits of cylindrical surface region B121a that is concentric to the axis of rotation B103. If ball B119a rolls up region B121b or B121c, this displaces the diaphragm pin B122a in a direction significantly opposing the biasing force B125, which in turn displaces the diaphragm B101 with respect to base structure B102, in the direction of tip region B101b of the diaphragm, and so will want restore back to the original position closer to or contacting the primary rolling region B121a, by balls B119 rolling/slipping during operation. If ball B119a rolls up region B121g or B121h, this displaces the diaphragm pin B122a in a direction significantly opposing the biasing force B125, which in turn displaces the diaphragm B101 with respect to base structure B102, in the direction of tip region B101b of the diaphragm, and so will want restore back to the original position closer to or contacting the primary rolling region B121a, by balls B119 rolling/slipping during operation.

If a ball rolls up the slope of the secondary rolling region surfaces B121b,c,g,h, the ball may slip back down due to the angle of the slope, the co-efficient of friction and friction force between the ball B119 and the bearing block B121/B124. Balls B119 have a radius of 1.25 mm and secondary rolling regions B121b,c,g,h have a radius of 1.35 mm. The use of the radiused secondary rolling regions B121b,c,g,h as described, is advantageous in that as there are no “hard stopper” surfaces that the balls are likely to roll up against and suddenly hit, opportunity for a ball to vibrate up against such a surface may be eliminated, avoiding undesirable noise creation.

Preferably the magnitude of the biasing force B125 is 8 Newtons, which is directed through the left and right hinge mechanisms, contact hinge joint B109a,b, evenly (4 Newtons each). Preferably the force through each hinge mechanism, contact hinge joint B109a,b, is directed evenly through each of the four balls B119a,b,c,d as this may improves the reliability of the hinge system by making no ball B119 significantly more susceptible to lifting off and buzzing. When a single hinge joint B109a is viewed from a cross-section plane perpendicular to the axis of rotation B103, such as shown in FIG. 6C force vectors B126 and B127 can be seen, both extending radially from the axis of rotation, and separated by an angle B120 of 86 degrees. Angle B120 may vary a little during operation as the balls may roll and slip away from each Other or closer to each other within their hinge channels B121i,j. Preferably force vectors B126 and B127 are even in magnitude. Preferably each component of the force vectors B126 and B127 that acts in the same direction as the biasing force B125 is equal to approximately one quarter of the magnitude of the biasing force B125 (i.e. 2 Newtons). Preferably the magnitude of force vectors B126 and B127 are about 2.8 Newtons each, when separated by an angle B120 of 86 degrees. Preferably the minimum static magnitude of any of the four force vectors acting through balls B119a,b,c,d (for example B126 and B127) is higher than a dynamic force acting in an opposite direction that may lift off the balls B119 from their contact with either a diaphragm pin B123/B122a or a bearing block B121/B124 that may occur during normal operation, due to excitation via that transducing mechanism, or movement (for example, the movement caused by running while wearing a headphone using the audio transducer B100 transducer), for example higher than 1 Newton.

The torsion bar B122 has a compliant region B122b, which flexes in torsion during normal operation, allowing rotation back and forth about the axis of rotation A103. Region B122b that has smaller diameter (of 0.6 mm) than the regions either side of it, tip region B122c (distal from the magnet A105) and base region B122a (proximal to the magnet base) both having diameters of 1.5 mm. The tip region B122c is adhered, using for example epoxy resin, to the region B121d of the bearing block B121, and this limits the position of the diaphragm A101 with respect to the base structure B102 in the direction of the axis of rotation A103.

When viewed from a cross-section plane coincident to both the axis of rotation B103, and the point of contact between the ball B119a and rolling surface region, such as shown in FIG. 6I and J, primary rolling region B121a can be seen to have a flat region (parallel to the axis of rotation) with a length dimension B121f of 0.4 mm, indicating the limits of cylindrical surface region B121a that is concentric to the axis of rotation B103. This means that the balls are able to roll in the direction of the axis of rotation B103 when they are contacting region B121a. This configuration allows a small degree of ball displacement in a direction of diaphragm axis A103, which may mean that any imperfection in manufacture of the hinge, for example in the mounting angle of the outer race, may not result in ball slippage in use. This may mean that there is no requirement to introduce compliance, such as via flexing regions A306a and A306b of hinge A300 in FIGS. 3A-H. This advantage means that it may avoid over-constraining the hinge system—the torsion bar B122 being attached to both diaphragm B101 and base B102 is the only constraint in this direction. This may lead to a driver with improved distortion performance and lower fundamental resonance and wider operating bandwidth. If ball B119a rolls up region B121G or B121h, this displaces the diaphragm pin B122A in a direction significantly opposing the biasing force B125, which in turn displaces the diaphragm B101 with respect to base structure B102, in the direction of tip region B101b of the diaphragm, and so will want restore back to the original position closer to or contacting the primary rolling region B121a, by balls B119 rolling/slipping during operation.

It may also be configured to operate being made from an elastomeric material such as CPU. A biasing force holds the diaphragm pin A303 against the balls A304a-b, and also the balls against the main body of the hinge A302. In the audio transducer A100, the biasing force is due to the magnetic attraction of the magnet A105 to the ferromagnetic pole pieces A110a-b, and the direction of the force acting on the magnet A105 is predominantly in the direction away from the diaphragm tip A101b (i.e. downwards with respect to both FIG. 1F and FIG. 3E). In in alternate configuration the position of the magnet within the ferromagnetic components may be altered (for example moved up or down or sideways, for example) and/or the geometry of the components may be configured to provide a force acting on the magnet A105 in a predominantly different direction, such as towards the tip A101b of the diaphragm, for example (i.e. upwards with respect to both FIG. 1F and FIG. 3E). In this latter configuration, a hinge may be required to be mounted rotated 180 degrees about the axis A103 to the transducer base structure A102, to operate.

In an alternate configuration, the diaphragm pin A303 has a channel that the bearing rolls within and restricts the movement of the balls A304a-b in the direction of the axis A301. The ball may connect to one or two regions of contact within said channel.

The two balls roll within two respective outer race channels A312a-b within a main body A302 of the hinge. The outer race A312 is located at a larger radius, about the diaphragm axis of rotation A103, compared to the inner race. The main body A302 may be made out of a plastic with low susceptibility to creep, such as PEEK, or a metal or ceramic. The main body A302 may also be configured to work with a hard elastomeric material, for example CPU of hardness 70 D. In this embodiment each channel has two regions of contact A307 of the main body A302 to a ball A304. As a ball A304 rolls, the geometry of the channels A312a-b defines a path that the moves along, and that path may be in an arc that is concentric to the hinge axis A301, and balls may be free to roll along the path with an approximate angle A310 of rotational excursion of the balls. The angle A310 is about 4 degrees or may be larger or smaller depending on the transducer requirements. In an alternate configuration, the path may be non-concentric, which may result in a very small translational displacement of the shaft as it rotates about an approximate axis of rotation A301. This may provide an advantage of providing a restoring force that centres the diaphragm. Alternatively, or in addition, torsional centring about the diaphragm's axis of rotation may be provided by magnetic forces exerted by magnetic and/or ferromagnetic elements attached to the diaphragm and transducer base structure. Further alternatively, or in addition, an additional centring component may be used. For example, the contact hinge joint A300 may also be used in conjunction with a torsion bar component, similar to the torsion bar A106, shown in FIG. A of WO 2017/04671 connected between the diaphragm pin A303 and the transducer base structure A102. In some embodiments the diaphragm pin component may comprise an inner race for the hinge and a flexing torsion bar. For example, in some embodiments the pin may extend from the magnet, through the hinge where it serves as an inner race component, and then extends beyond to where it serves as a torsion bar. In some embodiments it may narrow, to provide improved torsional compliance. Further beyond the torsion bar section it may perhaps thicken again to provide a point of attachment to the transducer base structure. In some embodiments attachment of the distal end of the torsion bar to the transducer base structure is via a compliant and/or damped material, in order to help manage various resonance modes of the torsion bar. In an alternative embodiment, or in addition, the torsion bar exhibits a rigid profile, such as a C-section for example, that may help push resonance modes to higher frequency and preferably out of the operating bandwidth.

Preferably the torsion bar section is substantially coaxial with the diaphragm axis of rotation. Each channel A312a,b is configured to allow the ball to roll along each channel defined path, until a ball reaches a stopper surface A311a-d as part of the main body A302. For example, with reference to FIG. 3F, ball bearing A304a may roll until it hits stopper surface A311a, or in the opposite direction, stopper surface A311b. This preferably does not occur often during normal operation, as it may create audio distortion. It may happen infrequently during normal operation, for example during a loud percussive event, and may cause a ball A304 to stop suddenly and for the diaphragm pin A303 to slip at region A313 of contact between the pin and a ball. As the ball bearings A304 roll in the channels, or during transportation or rough handling, for example, occasional micro slippage may occur at the regions A307 and A313 of predominantly rolling contact against the balls A304. This may cause the balls to become de-centred within their respective channels, and it may mean that they are more likely to hit a stopper surface A311. The large slipping action that may occur as the stopper hits may correct this, so that the position of the balls A304 are more well centred within their respective channels, when the diaphragm is in its “at rest” position.

This configuration allows a small degree of ball displacement in a direction of diaphragm axis A103, which may mean that any imperfection in manufacture of the hinge, for example in the mounting angle of the outer race, may not result in ball slippage in use. This may mean that there is no requirement to introduce compliance, such as via flexing regions A306a and A306b.

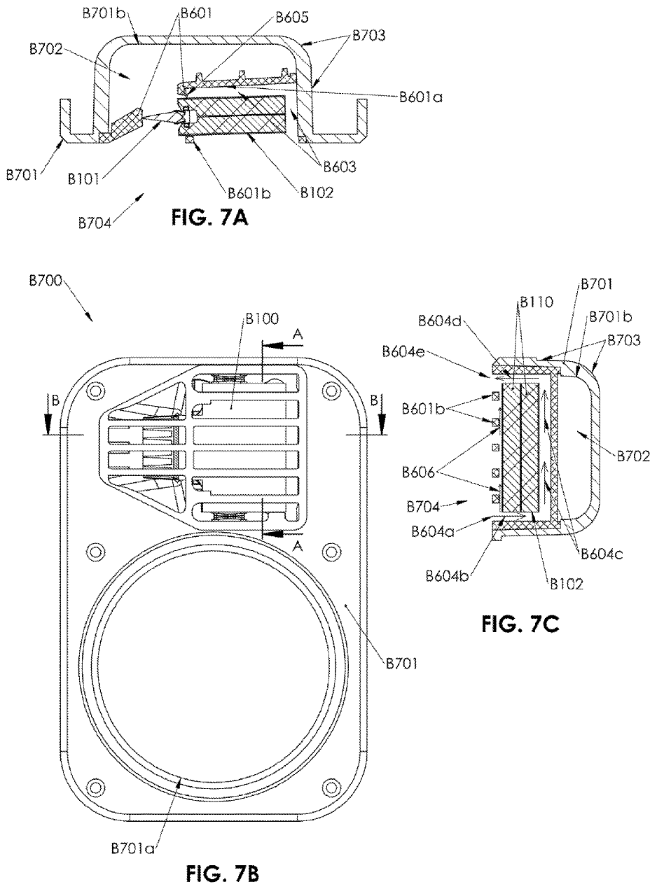

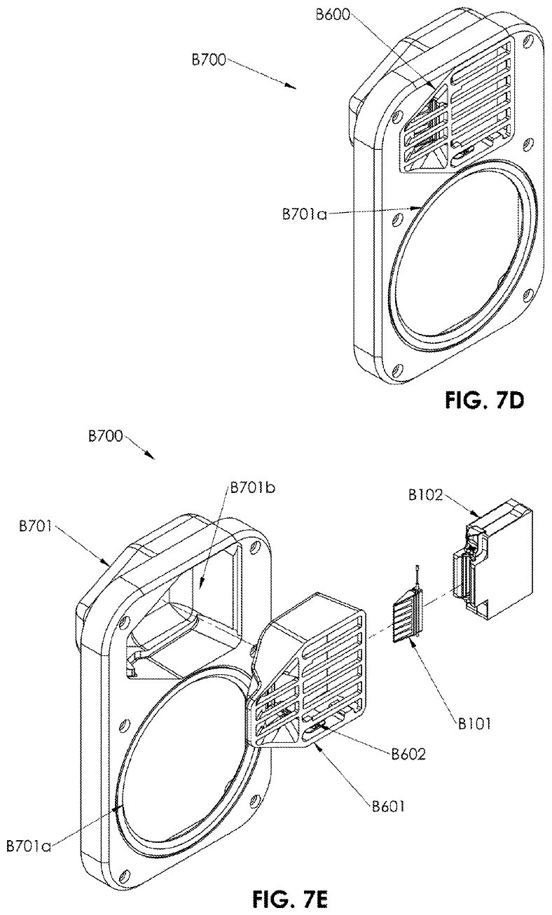

As shown in FIGS. 6A-6J, the audio transducer B100 may be incorporated in an audio transducer housing as will be described in relation to FIGS. 7A-7E below.

### 3. Audio Device Embodiment

Referring to FIGS. 7A-7E, an embodiment of an audio device (or partial assembly of an audio device) B700 incorporating the audio transducer A100 or the audio transducer B100 is shown. The features of either one of these embodiments as described herein may also be incorporated in the audio transducer of this audio device embodiment. The audio device may be a part of loudspeaker, such as a standalone bookshelf loudspeaker. The device may further comprise one or more other audio transducers, such as a conventional linear action transducer.

As shown in FIG. 7A, the partial assembly B700 of speaker device comprises an audio transducer housing B601 within which the audio transducer B100 is mounted. The audio device B700 comprises an enclosure B703 with a first air cavity B702 that is substantially sealed from an external environment B704 to the enclosure, and a second air cavity B603 that is open or fluidly connected to the external environment B704 to the enclosure B703. The first air cavity B702 is substantially fluidly sealed from the second air cavity B603. A front face of the diaphragm B101 of the audio transducer B100 faces the external environment B704 to the enclosure, and an opposing rear face of the diaphragm A101 faces the first air cavity B702.

The audio device comprises an inner dividing wall B601a located within the enclosure B703. The second air cavity B603 is bounded by the inner dividing wall B601a and the base structure B102 of the audio transducer B100. The audio device further comprises a fluid flow sealing element B605 connected between the inner dividing wall B601a and the audio transducer B100. The sealing element B605 (made from TPU elastomer) is connected between the inner dividing wall B601a and the base structure, to fluidly seal the first air cavity B702 from the second air cavity B603.

The second air cavity B603 extends along at least one side of the base structure B102. Preferably the second air cavity B603 extends along at least two adjacent sides of the base structure B102.

The second air cavity B603 extends along a rear side of the base structure B102 that is substantially distal from the diaphragm B101 coupled to the base structure. The second air cavity B603 may extend along a rear side of the base structure B102 that is most distal from the diaphragm B101 coupled to the base structure. The base structure B102 comprises a side or face facing the external environment B704 to the enclosure, and the second air cavity B603 extends along an opposing side or face of the base structure. The opposing side or face of the base structure B102 may be a major side or face of the base structure.

The second air cavity B603 is open to the external environment B704 about a periphery of the audio transducer B100, and preferably about the periphery of the base structure B102. The second air cavity B603 is open to the external environment B704 along a rear side of the base structure B102 that is distal from the diaphragm B101. The second air cavity B603 is open to the external environment B704 along at least a first side of the base structure B102 extending from the rear side toward the diaphragm, and more preferably also along a second opposing side of the base structure also extending from rear side toward the diaphragm. The second air cavity B603 is open to the external environment B704 substantially along an entire length of the first side, and preferably along an entire length of the second side as well.

A problem that may exist with a common configuration audio device whereby the entire audio transducer is housed within a sealed enclosure (e.g., an enclosure only containing the first cavity) is that, because air flow is limited (e.g., within the first cavity to prevent negative sound pressure cancelling positive sound pressure), the air within the enclosure can heat up reducing cooling capacity to the audio transducer and reducing power handling capabilities.

The audio device shown in FIGS. 7A-7E on the other hand, comprises a second air cavity B603 around the base structure B102 and is fluidly connected to the outside air volume. This second air cavity B603 is fluidly separated from the first air cavity B702 behind the diaphragm and within the audio transducer enclosure B703 (so that it does not affect the first air cavity B702 from limiting air flow behind the diaphragm to prevent negative sound pressure cancelling positive sound pressure). This configuration enables air flow around the driver base B102 to be increased and cooling of the audio transducer B100 and audio device using (cooler) outside air to more effective. This improves power handling performance of the audio transducer.

As shown in FIG. 7C, the second air cavity B603 around the back of the driver B100 promotes the drawing in of air from entry location B604a lower down on the front of the driver, the air then travels in direction B604b under the base structure B102 within air space B603 then it travels in direction B604c upwards behind driver base structure B102 within air space B603, then it travels in along in direction B604d above driver base structure B102 within air space B603 and the air expels out near the top exit location B604e, via convection. This chimney-like-effect improves convection flow provides preferable cooling to the audio transducer B100 as mentioned.

As shown in FIGS. 7A and 7B, the audio device further comprises a grille B601b on a side of the enclosure B703 separating the front face of the diaphragm from the external environment B704. The grille B601b extends in close proximity along a major face or side of the base structure B102, but is separated from the major face or side of the base structure.

The grille B601b comprises multiple apertures or openings distributed along a plane of the grille. One or more openings around a periphery of the grille B601b are preferably fluidly connected to the from the second air cavity B603 to the external environment B704.

In some embodiments, a distribution of the apertures or openings is such that a region of the grille B601b located directly adjacent or directly facing the base structure B102 comprises a density of openings (surface area of openings per unit of area) that is substantially lower than a density of openings in other regions of the grille. Preferably the other regions of the grille B601b are regions not facing the base structure B102. In other words, the front grille B601b may have openings removed or at least made smaller near the middle of the driver base B102. As shown in FIG. 7C, this may also provide a preferable convection effect by allowing air flow in direction B606 across the front side of the driver base B102 to draw in cold outside air in and across the driver base, and expel hot air from near the top of the driver base. This may also provide a preferable acoustic benefit by reducing Helmholtz type air resonances caused by cavities around the driver and driver surround.

The audio device may further comprise a device enclosure (not shown) within which the audio transducer enclosure B703 is coupled. FIGS. 7A-D show the audio transducer B100 and associated enclosure B703 within a front face of an enclosure of such a device.

The audio transducer B100 is substantially decoupled from a driver surround B600, and other parts of the audio device assembly B700, such as the device enclosure (not shown), via a decoupling mounting system comprising two cross shaped decoupling mounts B607 made from an TPU elastomer in-moulded to both the transducer base structure B102 and the B601. The decoupling mounting system may be configured to at least partially alleviate, but preferably substantially alleviate, mechanical transmission of vibration between the audio transducer B100 and the audio device front panel assembly B700 and the enclosure B703.

The audio transducer B100 is mounted within the audio transducer enclosure B703 via a decoupling mounting system that substantially acoustically decouples the audio transducer from the audio device enclosure B703 as described herein with reference to the first audio transducer embodiment. The audio transducer B100 is also mounted within the device front panel assembly B700 via a decoupling mounting system that substantially acoustically decouples the audio transducer from the audio device front panel assembly.

In an embodiment, the audio transducer is configured to operate within a medium to high frequency range, such as above approximately 200 Hz, more preferably above approximately 1 kHz, and most preferably above approximately 2 kHz. In this embodiment, the audio device further comprises a second audio transducer (not shown in the drawings) mounted within the enclosure in hole B701a in front face B701. This second transducer is a linear action audio transducer and may comprise a substantially lower frequency range of operation, for example below approximately 200 Hz.

In some embodiments, the first audio transducer B100 may be substituted for any one of the audio transducers as described in PCT/IB2016/055472 without departing from the scope of the invention.

The foregoing description includes some preferred embodiments of audio transducers, audio devices, hinge systems and electronic devices. The description also includes various embodiments, examples and principles of design and construction of other systems, assemblies, structures, devices, methods and mechanisms relating to the abovementioned embodiments. Modifications to the embodiments and to the other related systems, assemblies, structures, devices, methods and mechanisms disclosed herein may be made, as would be apparent to those skilled in the relevant art, without departing from the spirit and scope of the disclosure, as defined by the accompanying claims.

1. (canceled)

2-180. (canceled)

181. An audio transducer comprising: a transducer base structure; a diaphragm having a diaphragm body and a diaphragm base structure coupled to a base of the diaphragm body; a diaphragm suspension system coupling the diaphragm to the transducer base structure to enable rotational motion of the diaphragm about an axis of rotation; and a transducing mechanism operatively coupled to the diaphragm to transduce between electrical audio signals and sound pressure, the transducing mechanism having a diaphragm-side force transferring component, and wherein:
the diaphragm base structure is coupled in close proximity to or comprises the diaphragm-side force transferring component;
the diaphragm body rigidly couples the diaphragm base structure via a diaphragm base reinforcing system; and
the diaphragm base reinforcing system comprises at least one triangulated structure coupling the diaphragm body to the diaphragm base structure.

182. The audio transducer of claim 181, wherein the diaphragm base structure comprises a magnetic body, and the magnetic body is a permanent magnet.

183. The audio transducer of claim 181, wherein the at least one triangulated structure comprises a component extending along an axis that is substantially parallel to a radial axis of the diaphragm.

184. The audio transducer of claim 181, wherein the diaphragm base reinforcing system comprises at least one outer base reinforcing member and at least one inner base reinforcing member.

185. The audio transducer of claim 184, wherein an air cavity extends parallel to the axis of rotation between the diaphragm base structure, at least one of the outer base reinforcing member(s) and at least one of the inner base reinforcing member(s).

186. The audio transducer of claim 184, wherein the diaphragm base structure has at least two connection surfaces, one being aligned parallel to or tangentially to and contacting at least one of the outer base reinforcing member(s), and one being aligned parallel to or tangentially to and contacting at least one of the inner base reinforcing member(s).

187. The audio transducer of claim 184, wherein each inner base reinforcing member is coupled to the diaphragm body.

188. The audio transducer of claim 184, wherein the diaphragm base reinforcing system comprises:
a first outer base reinforcing member of the at least one outer base reinforcing member, extending over a first major face of the diaphragm body and coupling between the diaphragm body and the diaphragm base structure,
a second outer base reinforcing member of the at least one outer base reinforcing member, extending over a second major face of the diaphragm body, and coupling between the diaphragm body and the diaphragm base structure,
the first and second outer base reinforcing members being spaced from one another, and
an inner base reinforcing member of the at least one inner base reinforcing member located internally of the first and second outer base reinforcing members and the diaphragm base structure.

189. The audio transducer of claim 188, wherein the inner base reinforcing member, the first or second outer base reinforcing member, and the diaphragm base structure collectively form the at least one triangulated structure.

190. The audio transducer of claim 188, wherein a first side of the inner base reinforcing member couples to the first outer base reinforcing member away from the diaphragm base structure, and an opposing second side of the inner base reinforcing member connects to the diaphragm base structure away from the first outer base reinforcing member.

191. The audio transducer of claim 188, wherein the diaphragm body comprises a core material connecting between at least parts of the first and the second outer base reinforcing members, the core material is a foamed material, and the at least one inner base reinforcing member separates the diaphragm body from the diaphragm base structure, and the separated region does not comprise the core material.

192. The audio transducer of claim 188, wherein there is no location on the diaphragm base structure intersected by the inner base reinforcing member that is proximal to a location on the first outer base reinforcing member that is also intersected by the same inner base reinforcing member.

193. The audio transducer of claim 188, wherein the inner base reinforcing member couples the first outer base reinforcing member at a first location, and a second inner base reinforcing member of the at least one inner base reinforcing member couples the second outer base reinforcing member at a second location, wherein the first and second locations are spaced apart from the axis of rotation, or from a longitudinal axis of the diaphragm base structure, or both.

194. The audio transducer of claim 188, wherein at least one of the inner base reinforcing member(s) is substantially angled relative to the first outer base reinforcing member, and the inner base reinforcing member intersects the first outer base reinforcing member at an angle less than approximately 60 degrees.

195. The audio transducer of claim 184, wherein each inner base reinforcing member comprises a pair of angled base reinforcing plates, and each inner base reinforcing plate connects to a central region of the diaphragm base structure that is oriented parallel to the axis of rotation, or to a longitudinal axis of the diaphragm base structure, or both.

196. The audio transducer of claim 195, wherein an opposite end of a first inner base reinforcing plate connects to a first outer base reinforcing member of the at least one outer reinforcing member.

197. The audio transducer of claim 196, wherein an opposite end of a second inner base reinforcing plate connects to a second outer base reinforcing member of the at least one outer reinforcing member.

198. The audio transducer of claim 184, wherein the at least one outer base reinforcing member and/or the at least one inner base reinforcing member is(are) formed from a material having a specific modulus of at least approximately 8 MPa/(Kg/m³ ).

199. The audio transducer of claim 184, wherein the diaphragm-side force transferring component comprises a magnet and the magnet has at least two connection surfaces, one being aligned parallel to or tangentially to and contacting at least one of the outer base reinforcing member(s), and one being aligned parallel to or tangentially to and contacting at least one of the inner base reinforcing member(s).

200. The audio transducer of claim 199, wherein normal stress reinforcement is separate to the at least one outer base reinforcing member.

201. The audio transducer of claim 199, wherein the diaphragm is substantially devoid of normal stress reinforcement having an angle greater than 15 degrees relative to a direction substantially parallel to an imaginary plane oriented substantially perpendicular to an axis of rotation of the diaphragm, or oriented substantially perpendicular to a longitudinal axis of the diaphragm base structure, or both, at regions of the diaphragm body which are beyond approximately 60% of a maximum radius of the diaphragm.
